(19) United States
(12) Patent Application Publication
(10) Pub. No.: US 2017/0318057 A1
(43) Pub. Date: Nov. 2, 2017

(54) Modulation of the VPS10P-Domain Receptors for the Treatment of Cardiovascular Disease

(71) Applicant: H. Lundbeck A/S, Valby-Copenhagen (DK)

(72) Inventors: Anders Nykjær, Risskov (DK); Mads Fuglsang Kjølby, Århus N (DK)

(73) Assignee: H. Lundbeck A/S, Valby-Copenhagen (DK)

(21) Appl. No.: 15/646,779

(22) Filed: Jul. 11, 2017

Related U.S. Application Data
(63) Continuation of application No. 14/728,584, filed on Jun. 2, 2015.
Application No. 14/728,584 is a continuation of application No. 12/993,919, filed on Mar. 7, 2011, now Pat. No. 9,084,745.
(60) Provisional application No. 61/055,385, filed on May 22, 2008.

(30) Foreign Application Priority Data
May 22, 2008 (DK) PA200800711

(51) Int. Cl. H04L 29/06

(52) U.S. Cl. CPC H04L 63/20; H04L 63/1433

(57) ABSTRACT

The present invention relates to methods for modulating the activity of one or more Vps10p-domain receptors selected from the group consisting of Sortilin, SorLA, SorCS1, SorCS2 and SorCS3, in an animal and methods for preparation of a medicament for the treatment of abnormal plasma lipid concentrations and associated diseases and/or disorders. The modulation is carried out by inhibiting or promoting the binding of ligands to the Vps10p-domain receptor. In vitro and in vivo methods for screening for agents capable of modulation of said Vps10p-domain receptor activity are also provided. The invention furthermore relates to methods of altering expression of said receptors in vivo.

### CROSS-REFERENCE TO RELATED APPLICATIONS

The present application is a continuation of U.S. Ser. No. 14/738,584 (filed Jun. 12, 2015), which application is a continuation of U.S. Ser. No. 12/993,919 (filed Mar. 7, 2011, pending), which is a §371 U.S. National Stage application of International Application No. PCT/DK2009/050115 (filed May 20, 2009, expired), which claims priority to U.S. Provisional Application No. 61/055,385 (filed May 22, 2008, expired) and Danish Patent Application No. PA200800592 (filed May 22, 2008). Each of these applications is hereby incorporated by reference in its entirety.

### REFERENCE TO SEQUENCE LISTING

This application contains a Sequence Listing, submitted in electronic form as filename Sequence_Listing.txt, of size 79,139 bytes, created on Jul. 10, 2017. The sequence listing is hereby incorporated by reference in its entirety.

### FIELD OF INVENTION

The present invention relates to the modulation of the Vps10p-domain receptors for the modulation of abnormal plasma lipid concentrations for the treatment of specific cardiovascular diseases. The invention further relates to identification of ligands capable of acting as antagonists/inhibitors of the Vps10p-domain receptors. The present invention also relates to the preparation and use of such ligands for treating cardiovascular disease or disorders. All patent and non-patent references cited in the application, or in the present application, are hereby incorporated by reference in their entirety.

### BACKGROUND OF INVENTION

Plasma concentration of low-density lipoproteins (LDL) that transport cholesterol in the human circulation is one of the most important risk factors of cardiovascular morbidity and mortality (1). Excessive amounts of circulating cholesterol are deposited in the walls of coronary vessels causing closure of the vessel lumen and obstruction of blood flow to the heart (and other organs). This disease process is known as atherosclerosis. As a consequence of atherosclerotic events, coronary artery disease and myocardial infarction occur. Given the importance of management of LDL levels in patients, LDL cholesterol remains the primary target of cardiovascular therapy today (2, 3).

Risk for development of diseases and conditions like atherosclerosis, coronary artery disease, and coronary heart disease has been demonstrated to be strongly correlated with high levels of LDL-cholesterol and triglycerides. Elevated levels of low density lipoprotein-cholesterol (LDL-cholesterol) is a significant lipid associated contributor to e.g. coronary heart disease. Atherosclerosis and its associated coronary artery disease is the leading cause of mortality in the industrialized world. Despite attempts to modify secondary risk factors (smoking, obesity, lack of exercise) and treatment of dyslipidemia with dietary modification and drug therapy, coronary heart disease remains the most common cause of death in the U.S., where cardiovascular disease accounts for 44% of all deaths, with 53% of these associated with atherosclerotic coronary heart disease.

A number of biochemical pathways that affect plasma levels of cholesterol are known and have been considered as targets in therapeutic intervention. These steps include the rate with which cholesterol is produced in the organism and introduced into very low-density lipoproteins (VLDL), the extent of conversion of VLDL into LDL, as well as the efficiency of LDL clearance into hepatic tissues. Furthermore, the conversion of cholesterol into bile acids that are secreted into the gut affect circulating lipid levels.

The Vps10p-Domain Receptor Family

The present inventors have studied the effect of modulation of activity of Vps10p domain receptors on plasma levels of LDL-cholesterol and triglycerides. The members of this family of receptors are Sortilin, SorLA, SorCS1, SorCS2 and SorCS3.

Sortilin

Sortilin, the archetypal member of the Vps10p-domain receptor family is occasionally also referred to as Neurotensin receptor 3 (NTR3), Glycoprotein 95 (Gp95) or 100 kDa NT receptor. Human Sortilin is accessed in Swiss Prot under ID No. 099523.

Sortilin, (SEQ ID NO. 1) is a type I membrane receptor expressed in a number of tissues, including the brain, spinal cord, testis, liver and skeletal muscle (6-7). Sortilin belongs to a family of receptors comprising Sortilin, SorLA (8), SorCS1, SorCS2 and SorCS3.

All the receptors in this family share the structural feature of an approximately 600-amino acid N-terminal domain with a strong resemblance to each of the two domains which constitute the luminal portion of the yeast sorting receptor Vps10p (9). The Vps10p-domain (Vps10p-D) that among other ligands binds neurotrophic factors and neuropeptides (10-14), constitutes the entire luminal part of Sortilin (sSortilin) and is activated for ligand binding by enzymatic propeptide cleavage (10, 11). Sortilin is a multifunctional type-1 receptor capable of endocytosis as well as 35 intracellular sorting (9-11), and as shown recently, it also engages in signaling by triggering proneurotrophin-induction of p75^{NTR}-mediated neuronal apoptosis (12, 13, 18, 19). Sortilin is synthesized as a proprotein, which is converted to mature Sortilin by enzymatic cleavage and removal of a short N-terminal propeptide. Only the mature receptor binds ligands and interestingly, all its known ligands, e.g. Neurotensin (NT), lipoprotein lipase, the proforms of nerve growth factor-β (proNGF) and brain derived neurotrophic factor (proBDNF), receptor associated protein (RAP), and its own propeptide, compete for binding (11-13, 16), indicating that the diverse ligands target a shared or partially shared binding site. NT is a tridecapeptide, which binds to Sortilin, SorLA and the two G-protein coupled receptors NTR1 and NTR2 (10, 20-22). The physiological role of NT in relation to Sortilin has not been fully elucidated (23), still NT is an important tool, as it inhibits all other ligands from binding to the Sortilin Vps10p-D.

SorLA

Sorting protein-related receptor abbreviated SorLA (Swiss prot ID no Q92673), also known as LR11, is a 250-kDa type-1 membrane protein and the second member identified in the Vps10p-domain receptor family SorLA, like sortilin, whose lumenal domain consists of a Vps10p domain only, is synthesized as a proreceptor that is cleaved by furin in late Golgi compartments. It has been demonstrated that the truncation conditions the Vps10p domain for propeptide inhibitable binding of neuropeptides and the receptor-associated protein. It has been demonstrated (21) that avid binding of the receptor-associated protein, apolipoprotein E, and lipoprotein lipase not inhibited by propeptide occurs to sites located in other lumenal domains. In transfected cells, about 10% of fullength SorLA is expressed on the cell surface capable mediating endocytosis. The major pool of receptors is found in late Golgi compartments, and interaction with newly synthesized ligands has been suggested.

SorCS1-3

SorCS 1 (Swiss prot ID no Q8WY21), SorCS2 (Swiss prot ID no Q96PQ0) and SorCS3 (Swiss prot ID no Q9UPU3) constitute a subgroup of mutually highly similar proteins containing both a Vps10p-D and a leucine-rich domain bordering the transmembrane domain (14, 26). SorCS1 may play an important role outside the nervous system as its region on the gene was identified as a type 2 diabetes quantitative trait locus in mice (27), and variations in the human SorCS1 gene are associated with diabetes-related traits (28). Further indications in this direction are presented in another study (29) wherein SorCS1 is associated with the major glucose-controlling 16-Mb Niddm1i region in the diabetic GK rat, a region which causes defective insulin secretion and which j also corresponds to loci in humans and mice associated with type 2 diabetes.

### STATE OF THE ART

The current state of the art for therapy of high plasma LDL is the application of statins, inhibitors that interfere with endogenous cholesterol production and thereby reduce the output of cholesterol-rich LDL particles. However, the use of statins is associated with a substantial risk of side affects such as adverse effects on muscle and liver functions, as well as on cognitive abilities (4, 5). Thus, extensive research efforts are directed towards identification of novel factors contributing to the regulation of plasma cholesterol metabolism. These factors may represent safer alternatives to therapeutic intervention with high plasma LDL levels.

Recently, a number of groups have used genome-wide association studies to identify chromosomal regions in the human genome that may be associated with control of plasma lipid values. Notably, these studies merely suggest certain regions on particular chromosomes that may have some predictive value for lipid concentrations and cardiovascular risk. None of these studies provides experimental evidence to confirm a causal role of candidate genes in said chromosomal region in control of lipid homeostasis.

For example, Willer et al. (6) as well as Kathiresan et al. (7) both have mapped a chromosomal locus associated with LDL cholesterol to 1p13. This locus contains several candidate genes among which are CELSR2, PSRC1 and SORT1. Whether any of the three genes, or others ones in this region may be relevant for determination of LDL cholesterol is unclear as stated by Kathiresan et al on page 191: “It is not yet clear what causal variants or even the causal genes are at the new locus”. Even more confusing, Kathiresan et al. identify an increase in mRNA levels for SORT1 with the C-allele that predisposes its carrier to low plasma LDL. The authors conclude “ . . . these observations suggest a mechanism by which increased sortilin expression seen with the C allele (at SNP rs646776) could lead to lower circulating LDL cholesterol concentrations”. In the authors' argumentation, sortilin acts as a protective factor reducing circulating LDL levels. The higher the mRNA levels for sortilin (SORT1), the lower the plasma LDL concentration.

This assumption, however, is incorrect as demonstrated by the present inventors by functional studies using sortilin-deficient mouse models wherein loss of sortilin expression in fact is associated with low plasma LDL. Thus, normal sortilin activity increases rather than decreases LDL concentrations. The increase seen in the C allele in the study by Kathiresan et al. is likely to reflects a compensatory upregulation of a dysfunctional sortilin allele.

The patent application WO 2004/056385 discloses a method of treating a disease or disorder selected from inflammatory pain, diseases or disorders of pancreas, kidney disorders, lung disorders, cardiovascular disorders, various types of tumours, psychiatric disorders or neuronal disorders by use of agents capable of inhibiting Vps10p-domain receptors, in particular Sortilin. However, WO 2004/056385 do not disclose that Sortilin is involved in the regulation of plasma lipid levels.

Other patent applications such as WO 2006/138343 and WO 2007/035716 discloses compositions comprising receptor-associated protein (RAP) binding CR containing receptors/proteins for treating a large number of diseases including cardiovascular disease. The listing in this document of Sortilin as a protein comprising CR repeats is incorrect however as is the referral to SwissProt access number Q92673 along with Sortilin. Q92673 is the SwissProt access number for the Vps10p-domain receptor SorLA which do indeed comprise CR repeats to which RAP may bind.

A further patent application WO 2007/141346 discloses genes regulating intracellular cholesterol trafficking as targets for treatment of cholesterol-related diseases. The Vps10p-domain receptor member SorCS1 is disclosed as one out of several potential targets without further disclosure of a mechanism or association to other Vps10p-domain receptors.

### SUMMARY OF THE INVENTION

In a main aspect the present invention relate to the use of at least one antagonist capable of binding to a receptor of the Vps10p-domain family thus inhibiting the activity of said Vps10p-domain receptor, in the manufacture of a medicament, for the treatment and/or prevention of abnormal plasma lipid concentrations in an animal.

In another aspect, the invention relate to the use of at least one antagonist capable of binding to at least one amino acid residue of a Vps10p-domain receptor agonist selected from the group consisting of SEQ ID NOs. 6, 7, 8, 9, 10, 14 or 15 or a fragment or variant thereof, in the manufacture of a medicament, for the treatment and/or prevention of abnormal plasma lipid concentrations in an animal.

In a further aspect, the invention concerns an in vitro method for screening for an antagonist capable of binding to a Vps10p-domain receptor, comprising the steps of:

a) providing a Vps10p-domain receptor, and

b) providing an agonist,

c) providing a library of potential antagonists, and

d) providing an assay for measuring the binding of an agonist to a Vps10p-domain receptor, and

e) adding the library of potential antagonists to be tested to the assay, and

f) determining the amount of agonist bound to the Vps10p-domain receptor, and

g) comparing the amount determined in step f) with an amount measured in the absence of the antagonist to be tested,

h) wherein the difference in the two amounts identifies an antagonist which alters the binding of the agonist to the Vps10p-domain receptor.

In yet another aspect the present invention relates to a method for determining the degree of inhibition of an antagonist on activity of a Vps10p-domain receptor in a cell culture expressing said receptor, wherein said Vps10p-domain receptor comprises an amino acid sequence having at least 60% sequence identity to SEQ ID NO. 1, SEQ ID NO. 2, SEQ ID NO. 3, SEQ ID NO. 4 or SEQ ID NO. 5, said method comprising the steps of:

a) providing a cell culture expressing a Vps10p-domain receptor, and

b) providing an agonist of the Vps10p-domain receptor, and

c) providing a library of potential antagonists, and

d) providing an assay for determination of binding to, internalisation of and signalling through, a Vps10p-domain receptor, said assay comprising

e) adding the library of potential antagonists to be tested c) to the cell culture a), in the presence of the agonist b), and

f) determining
i) the amount of antagonist bound to the Vps10p-domain receptor, and/or
ii) the amount of antagonist internalised by the Vps10p-domain receptor, and/or
iii) the degree of signalling through the Vps10p-domain receptor, and

g) comparing the amount determined in step f) with an amount measured in the absence of the antagonist to be tested,

h) wherein the difference in the two amounts identifies an antagonist
i) capable of binding to a Vps10p-domain receptor, and/or
ii) capable of inhibiting signalling through a Vps10p-domain receptor, and/or
iii) capable of inhibiting internalisation of an agonist of said Vps10p-domain receptor.

In a further aspect the present invention relates to a method for determining the degree of inhibition of an antagonist on activity of a Vps10p-domain receptor in a cell culture expressing said receptor and with the a cell culture lacking expression of said receptor, said method comprising the steps of:

a) providing a cell culture expressing a Vps10p-domain receptor, and

b) providing a cell culture not expressing a Vps10p-domain receptor, and

c) optionally providing a cell culture overexpressing a Vps10p-domain receptor

d) providing an agonist of the Vps10p-domain receptor, and

e) providing a library of potential antagonists, and

f) providing a first assay comprising a) and a second assay comprising b) and optionally a third assay comprising c), and

g) adding the library of potential antagonists to be tested to the three assays, and

h) determining
i) the amount of antagonist bound to the Vps10p-domain receptor, and/or
ii) the amount of antagonist internalised by the Vps10p-domain receptor, and/or
iii) the degree of signalling through the Vps10p-domain receptor, and

i) comparing the amount of antagonist determined in step g) using a) with the amount determined in g) using b) and the amount determined in g) using c),

j) wherein the difference in the amounts identifies an antagonist
i) capable of binding to a Vps10p-domain receptor, and/or
ii) capable of inhibiting signalling through a Vps10p-domain receptor, and/or
iii) capable of inhibiting internalisation of an agonist of said Vps10p-domain receptor.

In a further aspect the present invention relates to a method for determining the degree of inhibition of an antagonist on activity of a Vps10p-domain receptor in a mammal expressing said receptor, said method comprising the steps of:

a) administering said antagonist to a mammal naturally expressing the receptor,

b) determining
i) the amount of antagonist bound to the Vps10p-domain receptor, and/or
ii) the amount of antagonist internalised by the Vps10p-domain receptor, and/or
iii) the degree of signalling through the Vps10p-domain receptor, and

c) comparing the measurement of step b) with a measurement obtained in the absence of the compound to be tested,

d) wherein the difference in the two measurements identifies the effect of said antagonist on said mammal naturally expressing the receptor.

In yet another aspect the present invention relate to a method for determining the degree of inhibition of an antagonist on activity of a Vps10p-domain receptor in a mammal expressing said receptor with a second mammal, lacking expression of said receptor and a third mammal overexpressing said receptor, said method comprising the steps of:

a) providing a mammal expressing a Vps10p-domain receptor, and

b) providing a mammal not expressing a Vps10p-domain receptor, and

c) providing a mammal overexpressing a Vps10p-domain receptor, and

d) providing an agonist of the Vps10p-domain receptor, and

e) providing a library of potential antagonists, and

f) administering said library of antagonists to said mammal of a), b) and c) respectively, and

g) determining
i) the amount of antagonist bound to the Vps10p-domain receptor, and/or
ii) the amount of antagonist internalised by the Vps10p-domain receptor, and/or
iii) the degree of signalling through the Vps10p-domain receptor, in each of the mammals defined in a), b) and c), and

h) comparing the amount of antagonist determined in step g) using a) with the amount determined in g) using b) with the amount determined in g) using c),

i) wherein the difference in the amounts identifies an antagonist
i) capable of binding to a Vps10p-domain receptor, and/or
ii) capable of inhibiting signalling through a Vps10p-domain receptor, and/or
iii) capable of inhibiting internalisation of an agonist of said Vps10p-domain receptor.

In a further aspect the present invention relates to a pharmaceutical composition comprising the antagonist of claim 1, said antagonist selected from the group consisting of small organic compounds, oligo-peptides, proteins and monoclonal or polyclonal antibodies.

In an important aspect the present invention relate to the use of the pharmaceutical composition described herein above for the preparation of a medicament for the treatment or prevention of a disease or disorder associated with abnormal plasma lipid concentrations.

In a further aspect the present invention relates to a method of treatment of a pathological condition of the cardiovascular system associated with abnormal plasma lipid concentrations in a subject comprising administering to an individual in need thereof a therapeutically effective amount of the pharmaceutical composition defined herein above.

In a further aspect the present invention relates to a kit in parts comprising:
a pharmaceutical composition as defined herein above,
a medical instrument or other means for administering the medicament,
instructions on how to use the kit in parts.

In a further aspect the present invention relates to the use at least one antagonist wherein said antagonist is capable of inhibiting expression of a Vps10p-domain receptor in an animal.

### OVERVIEW OF THE DRAWINGS

FIG. 1: Receptor overview

FIG. 2A: Cholesterol and triglyceride metabolism

FIG. 2B: Cholesterol and triglyceride metabolism

FIG. 3: Plasma cholesterol diagram

FIG. 4: Plasma triglyceride diagram

FIG. 5A (Panels A-D): Lipoprotein profile—cholesterol and triglyceride

FIG. 5B (Panels A-C): Surface plasmon resonance analysis of ApoB binding to sortilin.

FIG. 6A-6C: Time-course for increase in cholesterol levels and FPLC profile in mice that over-express Sortilin.

FIG. 7: WB of plasma from mice that over-express sortilin

FIG. 8A-8B: Cholesterol and triglyceride

FIG. 9 (Panels A-C): Apoproteins and lipid profile

FIG. 10A-10L: Competition binding to immobilized sortilin using peptides

### DETAILED DESCRIPTION ON THE INVENTION

### Definitions

Abnormal plasma lipid concentrations: The expression abnormal plasma lipid concentrations as used herein refer to the level of one or more of the following plasma lipid levels: total cholesterol, LDL-cholesterol, HDL cholesterol and triglyceride. Abnormal levels as such are levels (i.e. concentrations) falling outside one or more of the following intervals of Table 1:

TABLE 1
Normal plasma lipid levels

| | |
|---|---|
| Patient group | Concentration |

A: Total cholesterol

| | | |
|---|---|---|
| Men and women aged 19-29 years | 3.5-6.2 | mM |
| Men and womed aged 30-59 years | 4.4-7.8 | mM |
| Women over 59 years of age | 4.8-8.0 | mM |
| Men over 59 years of age | 4.3-7.3 | mM |
| Children under 1 year of age | 1.5-4.5 | mM |
| Children aged 1-18 years | 2.7-6.0 | mM |
| Recommended limit for treatment in | 5 | mM |
| patients suffering from cardiovascular | | |
| disorders, when total cholesterol is | | |
| higher than: | | |
| Recommended limit for treatment in | 4.5 | mM |
| patients suffering from diabetes, when | | |
| total cholesterol is higher than: | | |

B: LDL-cholesterol

| | | |
|---|---|---|
| Women aged 20-29 years | 1.5-4.3 | mM |
| Women aged 30-45 years | 1.9-4.5 | mM |
| Women over 45 years of age | 2.4-5.5 | mM |
| Men aged 20-29 years | 1.7-4.3 | mM |
| Men aged 30-45 years | 2.1-5.0 | mM |
| Men aged 46-69 years | 2.3-5.3 | mM |
| Men over 69 years of age | 2.3-4.8 | mM |
| Children aged 10-19 years | 1.8-3.5 | mM |
| Adults with increased risk of | 3 | mM |
| cardiovascular disorder when | | |
| LDL-cholesterol is higher than: | | |

C: HDL-cholesterol

| Women aged 20-40 years | 1.0-2.0 | mM |
|---|---|---|
| Women over 4o years of age | 1.0-2.3 | |
| Men aged 20-60 years | 0.7-1.7 | mM |
| Men over 60 years of age | 0.8-1.9 | mM |
| Adults with increased risk of | 1 | mM |
| cardiovascular disorder when | | |
| HDL-cholesterol is higher than: | | |

D: Triglycerides

| | | |
|---|---|---|
| Men and women aged 20-40 years | 0.4-1.6 | mM |
| Men and women over 40 years of age | 0.5-2.5 | mM |
| Children 0-9 years | 0.3-1.2 | mM |
| Adults with increased risk of | 2 | mM |
| cardiovascular disorder when | | |
| triglyceride level is higher than: | | |

Table 1 Sources:
“Dansk Laboratorie medicin, En Håndbog” Jørgen Lyngbye, 2001 Konsensus, www.cardio.dk on 18 May 2009 (Dansk Kardiologisk Selskab).

Adjuvant: Any substance whose admixture with an administered immunogenic determinant/antigen increases or otherwise modifies the immune response to said determinant.

Affinity: The interaction of most ligands with their binding sites can be characterized in terms of a binding affinity. In general, high affinity ligand binding results from greater intermolecular force between the ligand and its receptor while low affinity ligand binding involves less intermolecular force between the ligand and its receptor. In general, high affinity binding involves a longer residence time for the ligand at its receptor binding site than is the case for low affinity binding. High affinity binding of ligands to receptors is often physiologically important when some of the binding energy can be used to cause a conformational change in the receptor, resulting in altered behavior of an associated ion channel or enzyme.

A ligand that can bind to a receptor, alter the function of the receptor and trigger a physiological response is called an agonist for that receptor. Agonist binding to a receptor can be characterized both in terms of how much physiological response can be triggered and the concentration of the agonist that is required to produce the physiological response. High affinity ligand binding implies that a relatively low concentration of a ligand is adequate to maximally occupy a ligand binding site and trigger a physiological response. Low affinity binding implies that a relatively high concentration of a ligand is required before the binding site is maximally occupied and the maximum physiological response to the ligand is achieved. Ligand binding is often characterized in terms of the concentration of ligand at which half of the receptor binding sites are occupied, known as the dissociation constant (k_{d}). Accordingly, an antagonist capable of binding to a receptor of the Vps10p-domain family thus inhibiting the activity of said Vps10p-domain receptor may be an antagonist having higher affinity to the binding site of a Vps10p-domain agonist than said agonist itself.

Alcohol: A class of organic compounds containing one or more hydroxyl groups (OH). In this context a saturated or unsaturated, branched or unbranched hydrocarbon group sitting as a substituent on a larger molecule.

Alicyclic group: the term “alicyclic group” means a cyclic hydrocarbon group having properties resembling those of aliphatic groups.

Aliphatic group: in the context of the present invention, the term “aliphatic group” means a saturated or unsaturated linear or branched hydrocarbon group. This term is used to encompass alkyl, alkenyl, and alkynyl groups, for example.

Alkyl group: the term “alkyl group” means a saturated linear or branched hydrocarbon group including, for example, methyl, ethyl, isopropyl, t-butyl, heptyl, dodecyl, octadecyl, amyl, 2-ethylhexyl, and the like.

Alkenyl group: the term “alkenyl group” means an unsaturated, linear or branched hydrocarbon group with one or more carbon-carbon double bonds, such as a vinyl group.

Alkynyl group: the term “alkynyl group” means an unsaturated, linear or branched hydrocarbon group with one or more carbon-carbon triple bonds.

Amphiphil: substance containing both polar, water-soluble and nonpolar, water-insoluble groups.

Agonist: An agonist is a compound capable of increasing or effecting the activity of a receptor. Specifically, a Vps10p-domain receptor agonist is a compound capable of binding to one or more of binding sites of a Vps10p-domain receptor thereby inducing the same physiological response as a given endogenous agonist ligand compound.

Antagonist: An antagonist is in this case synonymous with an inhibitor. An antagonist is a compound capable of decreasing the activity of an effector such as a receptor. Specifically, a Vps10p-domain receptor antagonist is a compound capable of binding to one or more of binding sites of Vps10p-domain receptor thereby inhibiting binding of another ligand thus inhibiting a physiological resonse.

antisense-RNA: an RNA molecule capable of causing gene silencing by specifically binding to an mRNA molecule of interest.

antisense-DNA: a DNA molecule capable of causing gene silencing by specifically binding to an mRNA molecule of interest.

Apoptosis: Apoptosis is a process of suicide by a cell in a multi-cellular organism. It is one of the main types of programmed cell death (POD), and involves an orchestrated series of biochemical events leading to a characteristic cell morphology and death.

Apoptosis inhibitor: Any compound capable of decreasing the process of apoptosis.

Aromatic group: the term “aromatic group” or “aryl group” means a mono- or polycyclic aromatic hydrocarbon group.

Binding: The term “binding” or “associated with” refers to a condition of proximity between chemical entities or compounds, or portions thereof. The association may be non-covalent—wherein the juxtaposition is energetically favoured by hydrogen bonding or van der Waals or electrostatic interactions—or it may be covalent.

Binding site: The term “binding site” or “binding pocket”, as used herein, refers to a region of a molecule or molecular complex that, as a result of its shape, favourably associates with another molecule, molecular complex, chemical entity or compound. As used herein, the pocket comprises at least a deep cavity and, optionally a shallow cavity.

Binding site 1 of Sortilin: A high affinity binding site of neurotensin or synonymously binding site 1 is a binding site of sortilin (SEQ ID NO. 1) having high affinity for neurotensin or a fragment or variant of neurotensin, and having affinity for the sortilin propeptide or a fragment thereof (Amino acid residues 34-77 of SEQ ID NO. 1) said binding site comprising amino acid residues R325, S316, Y351, I353, K260, I327, F314, F350 to M363, S305, F306, T398 to G400, I303-G309, Q349-A356, Y395 and T402 of SEQ ID NO. 1. More preferably, binding site 1 comprises amino acids R325, S316, Y351, I353, K260, I327, F314, F350 to M363, S305, F306 and T398 to G400 of SEQ ID NO. 1. Most preferably binding site 1 of sortilin comprises amino acids R325, S316, Y351, I353, K260, I327, F314 and F350 to M363 of SEQ ID NO. 1. Binding site 1 is a promiscuous binding site.

Binding site 2 of Sortilin: A binding site of sortilin having low affinity for neurotensin or a fragment or variant of neurotensin, said binding site comprising amino acid residues L572, L114, V112, R109 to S111, S115 to G118, T570, G571, W586, W597, T168-I174, L572, A573 and S584 to F588 of SEQ ID NO. 1. More preferably the sortilin low affinity binding site of neurotensin comprises amino acids L572, L114, V112, R109 to S111, S115 to G118, T570, G571, W586 and W597 of SEQ ID NO. 1. Most preferably the sortilin low affinity binding site of neurotensin comprises amino acids L572, L114 and V112. Binding site 2 is promiscuous and may bind the propeptide of Sortilin (amino acid residues 34-77 of SEQ ID NO. 1).

Binding site 3 of Sortilin: A promiscuous binding site of sortilin comprising amino acid residues D403, S420, D422, N423, S424, I425, Q426, E444, T451, Y466, E470, I498, S499 and V500 of SEQ ID NO. 1, more preferably comprising amino acid residues D403, N423, S424, I425, T451, Y466, I498 and V500 of SEQ ID NO. 1, most preferably comprising amino acid residues T451, Y466, I498 and V500 of SEQ ID NO. 1.

Bioreactive agent: The term “bioactive agent” as used herein refers to any a substance which may be used in connection with an application that is therapeutic or diagnostic, such as, for example, in methods for diagnosing the presence or absence of a disease in a patient and/or methods for the treatment of a disease in a patient. “Bioactive agent” refers to substances, which are capable of exerting a biological effect in vitro and/or in vivo. The bioactive agents may be neutral, positively or negatively charged. Suitable bioactive agents include, for example, prodrugs, diagnostic agents, therapeutic agents, pharmaceutical agents, drugs, oxygen delivery agents, blood substitutes, synthetic organic molecules, polypeptides, peptides, vitamins, steroids, steroid analogues and genetic determinants, including nucleosides, nucleotides and polynucleotides.

Cerebral ischemia: Global cerebral ischemia is an ischemic condition where the brain does not receive enough blood flow to maintain normal neurological function.

Coma: A prolonged period of unconsciousness following brain injury or metabolic disorders. The person in coma may have a simple reflex in response to touch or pain, but essentially there is no meaningful response to external stimuli.

Cationic group: A chemical group capable of functioning as a proton donor when a compound comprising the chemical group is dissolved in a solvent, preferably when dissolved in water.

Complex: As used herein the term “complex” refers to the combination of a molecule or a protein, conservative analogues or truncations thereof associated with a chemical entity.

Coordinate: The term “coordinate” as use herein, refers to the information of the three dimen-sional organization of the atoms contributing to a protein structure. The final map containing the atomic coordinates of the constituents of the crystal may be stored on a data carrier; typically the data is stored in PDB format or in mmCIF format, both of which are known to the person skilled in the art. However, crystal coordinates may as well be stored in simple tables or text formats. The PDB format is organized according to the instructions and guidelines given by the Research Collaboratory for Structural Biology.

Cyclic group: the term “cyclic group” means a closed ring hydrocarbon group that is classified as an alicyclic group, aromatic group, or heterocyclic group.

Cycloalkenyl: means a monovalent unsaturated carbocyclic radical consisting of one, two or three rings, of three to eight carbons per ring, which can optionally be substituted with one or two substituents selected from the group consisting of hydroxy, cyano, lower alkenyl, lower alkoxy, lower haloalkoxy, alkenylthio, halo, haloalkenyl, hydroxyalkenyl, nitro, alkoxycarbonenyl, amino, alkenylamino, alkenylsulfonyl, arylsulfonyl, alkenylaminosulfonyl, arylaminosulfonyl, alkylsulfonylamino, arylsulfonylamino, alkenylaminocarbonyl, arylaminocarbonyl, alkenylcarbonylamino and arylcarbonylamino.

Cycloalkyl: means a monovalent saturated carbocyclic radical consisting of one, two or three rings, of three to eight carbons per ring, which can optionally be substituted with one or two substituents selected from the group consisting of hydroxy, cyano, lower alkyl, lower alkoxy, lower haloalkoxy, alkylthio, halo, haloalkyl, hydroxyalkyl, nitro, alkoxycarbonyl, amino, alkylamino, alkylsulfonyl, arylsulfonyl, alkylaminosulfonyl, arylaminosulfonyl, alkylsulfonylamino, arylsulfonylamino, alkylaminocarbonyl, arylaminocarbonyl, alkylcarbonylamino and arylcarbonylamino.

Dipole-dipole interaction: The term “dipole-dipole interaction” as used herein refers to the attraction which can occur among two or more polar molecules. Thus, “dipole-dipole interaction” refers to the attraction of the uncharged, partial positive end of a first polar molecule to the uncharged, partial negative end of a second polar molecule. “Dipole-dipole interaction” also refers to intermolecular hydrogen bonding.

Electrostatic interaction: The term “electrostatic interaction” as used herein refers to any interaction occurring between charged components, molecules or ions, due to attractive forces when components of opposite electric charge are attracted to each other. Examples include, but are not limited to: ionic interactions, covalent interactions, interactions between a ion and a dipole (ion and polar molecule), interactions between two dipoles (partial charges of polar molecules), hydrogen bonds and London dispersion bonds (induced dipoles of polarizable molecules). Thus, for example, “ionic interaction” or “electrostatic interaction” refers to the attraction between a first, positively charged molecule and a second, negatively charged molecule. Ionic or electrostatic interactions include, for example, the attraction between a negatively charged bioactive agent.

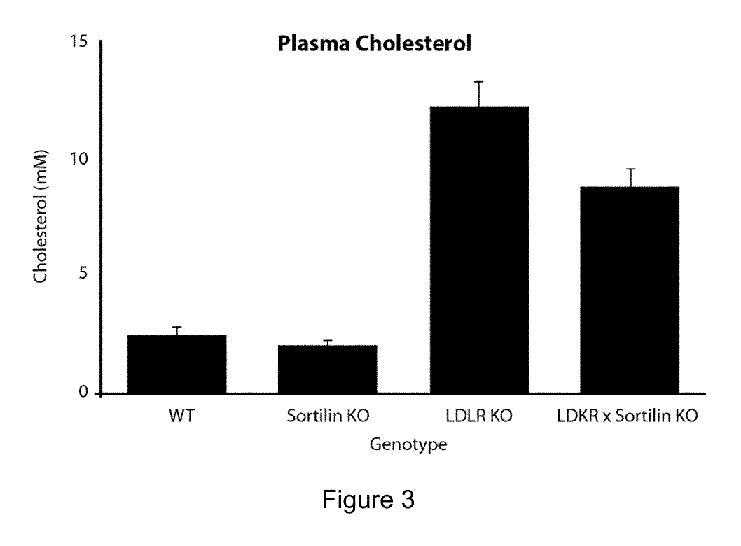

Familial hypercholesterolemia: (Familial hypercholesterolemia (abbreviated FH and also spelled familial hypercholesterolaemia) is a genetic disorder characterized by high cholesterol levels, specifically very high low-density lipoprotein (LDL, “bad cholesterol”) levels, in the blood and early cardiovascular disease. Many patients have mutations in the LDLR gene that encodes the LDL receptor protein (c.f. FIG. 3) which removes LDL from the circulation, or apolipoprotein B (ApoB), which is the part of LDL that binds to the LDL receptor. Mutations in other genes are rare. Patients who have one abnormal copy (are heterozygous) of the LDLR gene may have premature cardiovascular disease at the age of 30 to 40. Having two abnormal copies (being homozygous) may cause severe cardiovascular disease in childhood. Heterozygous FH is a common genetic disorder, occurring in 1:500 people in most countries; homozygous FH is much rarer, occurring in 1 in a million births. Treatment of heterozygous FH is normally with statins, bile acid sequestrants or other drugs that lower cholesterol levels (hypolipidemic agents). New cases are generally offered genetic counseling. Homozygous FH often does not respond to medical therapy and may require other treatments, including LDL apheresis (removal of LDL in a method similar to dialysis) and occasionally liver transplantation. The present invention provides novel means for the preparation of a medicament for the treatment of FH and provides a method of treatment of FH. The invention does so by providing antagonists of Vps10p-domain receptors, in particular antagonists binding specifically to binding sites of Sortilin and/or SorLA.

Form a ring: means that the atoms mentioned are connected through a bond when the ring structure is formed.

Fragments: The polypeptide fragments according to the present invention, including any functional equivalents thereof, may in one embodiment comprise less than 500 amino acid residues, such as less than 450 amino acid residues, for example less than 400 amino acid residues, such as less than 350 amino acid residues, for example less than 300 amino acid residues, for example less than 250 amino acid residues, such as less than 240 amino acid residues, for example less than 225 amino acid residues, such as less than 200 amino acid residues, for example less than 180 amino acid residues, such as less than 160 amino acid residues, for example less than 150 amino acid residues, such as less than 140 amino acid residues, for example less than 130 amino acid residues, such as less than 120 amino acid residues, for example less than 110 amino acid residues, such as less than 100 amino acid residues, for example less than 90 amino acid residues, such as less than 85 amino acid residues, for example less than 80 amino acid residues, such as less than 75 amino acid residues, for example less than 70 amino acid residues, such as less than 65 amino acid residues, for example less than 60 amino acid residues, such as less than 55 amino acid residues, for example less than 50 amino acid residues. Fragments of neurotensin include, but are not limited to the C-terminal amino acids of neurotensin PYIL (SEQ ID NO:11) and YIL. In one aspect, the fragment is selected from the group consisting of LYENKPRRPYIL (SEQ ID NO:20), YENKPRRPYIL (SEQ ID NO:21), ENKPRRPYIL (SEQ ID NO:22), NKPRRPYIL (SEQ ID NO:23), KPRRPYIL (SEQ ID NO:24), PRRPYIL (SEQ ID NO:25), RRPYIL (SEQ ID NO:17), RPYIL (SEQ ID NO:26), PYIL (SEQ ID NO:11), YIL and IL and natural or artificial variants thereof. In one embodiment of the present invention, the antagonist is not neurotensin or a fragment thereof.

Functional equivalency: “Functional equivalency” as used in the present invention is, according to one preferred embodiment, established by means of reference to the corresponding functionality of a predetermined fragment of the sequence.

Functional equivalents or variants of a Vps10p-domain receptor antagonist will be understood to exhibit amino acid sequences gradually differing from the preferred predetermined peptide or polypeptide based Vps10p domain antagonist sequence, as the number and scope of insertions, deletions and substitutions including conservative substitutions increase. This difference is measured as a reduction in homology between the preferred predetermined sequence and the fragment or functional equivalent.

A functional variant obtained by substitution may well exhibit some form or degree of native Vps10p domain antagonist activity, and yet be less homologous, if residues containing functionally similar amino acid side chains are substituted. Functionally similar in this respect refers to dominant characteristics of the side chains such as hydrophobic, basic, neutral or acidic, or the presence or absence of steric bulk. Accordingly, in one embodiment of the invention, the degree of identity is not a principal measure of a fragment being a variant or functional equivalent of a preferred predetermined fragment according to the present invention.

Gene “silencing”: a process leading to reduced expression of endogenous genes. Gene silencing is preferably the result of post-transcriptional reduction of gene expression.

Global ischemia: Anoxia resultant from ceased blood supply to the entire body resulting in tissue damage through a variety of mechanisms including apoptosis.

Group: (Moiety/substitution) as is well understood in this technical area, a large degree of substitution is not only tolerated, but is often advisable. Substitution is anticipated on the materials of the present invention. As a means of simplifying the discussion and recitation of certain terminology used throughout this application, the terms “group” and “moiety” are used to differentiate between chemical species that allow for substitution or that may be substituted and those that do not allow or may not be so substituted. Thus, when the term “group” is used to describe a chemical substituent, the described chemical material includes the unsubstituted group and that group with O, N, or S atoms, for example, in the chain as well as carbonyl groups or other conventional substitution. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, propyl, t-butyl, and the like. The same definitions apply to “alkenyl group” and “alkenyl moiety”; to “alkynyl group” and “alkynyl moiety”; to “cyclic group” and “cyclic moiety; to “alicyclic group” and “alicyclic moiety”; to “aromatic group” or “aryl group” and to “aromatic moiety” or “aryl moiety”; as well as to “heterocyclic group” and “heterocyclic moiety”.

Heterocyclic croup: the term “heterocyclic group” means a closed ring hydrocarbon in which one or more of the atoms in the ring is an element other than carbon (e.g., nitrogen, oxygen, sulphur, etc.).

Heterocyclyl means a monovalent saturated cyclic radical, consisting of one to two rings, of three to eight atoms per ring, incorporating one or two ring heteroatoms (chosen from N, O or S(O)₀₋₂, and which can optionally be substituted with one or two substituents selected from the group consisting of hydroxyl, oxo, cyano, lower alkyl, lower alkoxy, lower haloalkoxy, alkylthio, halo, haloalkyl, hydroxyalkyl, nitro, alkoxycarbonyl, amino, alkylamino, alkylsulfonyl, arylsulfonyl, alkylaminosulfonyl, arylaminosulfonyl, alkylsulfonylamino, arylsulfonylamino, alkylaminofarbonyl, arylaminocarbonyl, alkylcarbonylamino, or arylcarbonylamino.

Heteroaryl means a monovalent aromatic cyclic radical having one to three rings, of four to eight atoms per ring, incorporating one or two heteroatoms (chosen from nitrogen, oxygen, or sulphur) within the ring which can optionally be substituted with one or two substituents selected from the group consisting of hydroxy, cyano, lower alkyl, lower alkoxy, lower haloalkoxy, alkylthio, halo, haloalkyl, hydroxyalkyl, nitro, alkoxycarbonyl, amino, alkylamino, alkylsulfonyl, arylsulfonyl, alkylaminosulfonyl, arylaminosulfonyl, alkylsulfonylamino, arylsulfonylamino, alkylaminocarbonyl, arylaminocarbonyl, alkylcarbonlamino and arylcarbonylamino.

Homology: as used herein should be understood as being synonymous to the expression sequence identity. Thus “homologous with” is synonymous to “identical to”. The homology between amino acid sequences may be calculated using well known scoring matrices such as any one of BLOSUM 30, BLOSUM 40, BLOSUM 45, BLOSUM 50, BLOSUM 55, BLOSUM 60, BLOSUM 62, BLOSUM 65, BLOSUM 70, BLOSUM 75, BLOSUM 80, BLOSUM 85, and BLOSUM 90.

Fragments sharing homology with fragments of SEQ ID NO:1 to 13, respectively, are to be considered as falling within the scope of the present invention when they are preferably at least about 60 percent homologous, for example at least 65 percent homologous, for example at least 70 percent homologous, for example at least 75 percent homologous, for example at least 80 percent homologous, for example at least 85 percent homologous, for example at least 90 percent homologous, for example at least 92 percent homologous, such as at least 94 percent homologous, for example at least 95 percent homologous, such as at least 96 percent homologous, for example at least 97 percent homologous, such as at least 98 percent homologous, for example at least 99 percent homologous with said predetermined fragment sequences, respectively. According to one embodiment of the invention, the homology percentages refer to identity percentages.

A further suitably adaptable method for determining structure and function relationships of peptide fragments is described in U.S. Pat. No. 6,013,478, which is herein incorporated by reference. Also, methods of assaying the binding of an amino acid sequence to a receptor moiety are known to the skilled artisan.

In addition to conservative substitutions introduced into any position of a preferred predetermined peptide or polypeptide based Vps10p domain antagonist, or a fragment thereof, it may also be desirable to introduce non-conservative substitutions in any one or more positions of such an antagonist.

A non-conservative substitution leading to the formation of a functionally equivalent fragment of a peptide or polypeptide based Vps10p domain antagonist would for example i) differ substantially in polarity, for example a residue with a non-polar side chain (Ala, Leu, Pro, Trp, Val, Ile, Leu, Phe or Met) substituted for a residue with a polar side chain such as Gly, Ser, Thr, Cys, Tyr, Asn, or Gin or a charged amino acid such as Asp, Glu, Arg, or Lys, or substituting a charged or a polar residue for a non-polar one; and/or ii) differ substantially in its effect on polypeptide backbone orientation such as substitution of or for Pro or Gly by another residue; and/or iii) differ substantially in electric charge, for example substitution of a negatively charged residue such as Glu or Asp for a positively charged residue such as Lys, His or Arg (and vice versa); and/or iv) differ substantially in steric bulk, for example substitution of a bulky residue such as His, Trp, Phe or Tyr for one having a minor side chain, e.g. Ala, Gly or Ser (and vice versa).

Variants obtained by substitution of amino acids may in one preferred embodiment be made based upon the hydrophobicity and hydrophilicity values and the relative similarity of the amino acid side-chain substituents, including charge, size, and the like. Exemplary amino acid substitutions which take various of the foregoing characteristics into consideration are well known to those of skill in the art and include: arginine and lysine; glutamate and aspartate; serine and threonine; glutamine and asparagine; and valine, leucine and isoleucine.

In addition to the variants described herein, sterically similar variants may be formulated to mimic the key portions of the variant structure and that such compounds may also be used in the same manner as the variants of the invention. This may be achieved by techniques of modelling and chemical designing known to those of skill in the art. It will be understood that all such sterically similar constructs fall within the scope of the present invention.

In a further embodiment the present invention relates to functional variants comprising substituted amino acids having hydrophilic values or hydropathic indices that are within +/−4.9, for example within +/−4.7, such as within +/−4.5, for example within +/−4.3, such as within +/−4.1, for example within +/−3.9, such as within +/−3.7, for example within +/−3.5, such as within +/−3.3, for example within +/−3.1, such as within +/−2.9, for example within +/−2.7, such as within +/−2.5, for example within +/−2.3, such as within +/−2.1, for example within +/−2.0, such as within +/−1.8, for example within +/−1.6, such as within +/−1.5, for example within +/−1.4, such as within +/−1.3 for example within +/−1.2, such as within +/−1.1, for example within +/−1.0, such as within +/−0.9, for example within +/−0.8, such as within +/−0.7, for example within +/−0.6, such as within +/−0.5, for example within +/−0.4, such as within +/−0.3, for example within +/−0.25, such as within +/−0.2 of the value of the amino acid it has substituted.

The importance of the hydrophilic and hydropathic amino acid indices in conferring interactive biologic function on a protein is well understood in the art (Kyte & Doolittle, 1982 and Hopp, U.S. Pat. No. 4,554,101, each incorporated herein by reference).

The amino acid hydropathic index values as used herein are: isoleucine (+4.5); valine (+4.2); leucine (+3.8); phenylalanine (+2.8); cysteine/cystine (+2.5); methionine (+1.9); alanine (+1.8); glycine (−0.4); threonine (−0.7); serine (−0.8); tryptophan (0.9); tyrosine (−1.3); proline (−1.6); histidine (−3.2); glutamate (−3.5); glutamine (−3.5); aspartate (−3.5); asparagine (−3.5); lysine (−3.9); and arginine (−4.5) (Kyte & Doolittle, 1982).

The amino acid hydrophilicity values are: arginine (+3.0); lysine (+3.0); aspartate (+3.0.+−0.1); glutamate (+3.0.+−0.1); serine (+0.3); asparagine (+0.2); glutamine (+0.2); glycine (0); threonine (−0.4); proline (−0.5.+−0.1); alanine (−0.5); histidine (−0.5); cysteine (−1.0); methionine (−1.3); valine (−1.5); leucine (−1.8); isoleucine (−1.8); tyrosine (−2.3); phenylalanine (−2.5); tryptophan (−3.4) (U.S. Pat. No. 4,554,101).

In addition to the peptidyl compounds described herein, sterically similar compounds may be formulated to mimic the key portions of the peptide structure and that such compounds may also be used in the same manner as the peptides of the invention. This may be achieved by techniques of modelling and chemical designing known to those of skill in the art. For example, esterification and other alkylations may be employed to modify the amino terminus of, e.g., a di-arginine peptide backbone, to mimic a tetra peptide structure. It will be understood that all such sterically similar constructs fall within the scope of the present invention.

Peptides with N-terminal alkylations and C-terminal esterifications are also encompassed within the present invention. Functional equivalents also comprise glycosylated and covalent or aggregative conjugates formed with the same or other Vps10-p domain antagonists, including dimers or unrelated chemical moieties. Such functional equivalents are prepared by linkage of functionalities to groups which are found in fragment including at any one or both of the N- and C-termini, by means known in the art.

Functional equivalents may thus comprise fragments conjugated to aliphatic or acyl esters or amides of the carboxyl terminus, alkylamines or residues containing carboxyl side chains, e.g., conjugates to alkylamines at aspartic acid residues; O-acyl derivatives of hydroxyl group-containing residues and N-acyl derivatives of the amino terminal amino acid or amino-group containing residues, e.g. conjugates with fMet-Leu-Phe or immunogenic proteins. Derivatives of the acyl groups are selected from the group of alkyl-moieties (including C3 to C10 normal alkyl), thereby forming alkanoyl species, and carbocyclic or heterocyclic compounds, thereby forming aroyl species. The reactive groups preferably are difunctional compounds known per se for use in cross-linking proteins to insoluble matrices through reactive side groups.

Covalent or aggregative functional equivalents and derivatives thereof are useful as reagents in immunoassays or for affinity purification procedures. For example, a fragment of a peptide Vps10p domain antagonist according to the present invention may be insolubilized by covalent bonding to cyanogen bromide-activated Sepharose by methods known per se or adsorbed to polyolefin surfaces, either with or without glutaraldehyde cross-linking, for use in an assay or purification of anti-Vps10p-domain antibodies or cell surface receptors. Fragments may also be labelled with a detectable group, e.g., radioiodinated by the chloramine T procedure, covalently bound to rare earth chelates or conjugated to another fluorescent moiety for use in e.g. diagnostic assays.

Mutagenesis of a preferred predetermined fragment of a peptide based Vps10p domain antagonist can be conducted by making amino acid insertions, usually on the order of about from 1 to 10 amino acid residues, preferably from about 1 to 5 amino acid residues, or deletions of from about from 1 to 10 residues, such as from about 2 to 5 residues.

In one embodiment the ligand of binding site 1, 2 or 3 is an oligopeptide synthesised by automated synthesis. Any of the commercially available solid-phase techniques may be employed, such as the Merrifield solid phase synthesis method, in which amino acids are sequentially added to a growing amino acid chain (see Merrifield, J. Am. Chem. Soc. 85:2149-2146, 1963).

Equipment for automated synthesis of polypeptides is commercially available from suppliers such as Applied Biosystems, Inc. of Foster City, Calif., and may generally be operated according to the manufacturer's instructions. Solid phase synthesis will enable the incorporation of desirable amino acid substitutions into any fragment of a peptide based Vps10p domain antagonist according to the present invention. It will be understood that substitutions, deletions, insertions or any subcombination thereof may be combined to arrive at a final sequence of a functional equivalent. Insertions shall be understood to include amino-terminal and/or carboxyl-terminal fusions, e.g. with a hydrophobic or immunogenic protein or a carrier such as any polypeptide or scaffold structure capable as serving as a carrier.

Oligomers including dimers including homodimers and heterodimers of fragments of sortilin inhibitors according to the invention are also provided and fall under the scope of the invention. Functional equivalents and variants of Vps10p domain peptide or polypeptide antagonist can be produced as homodimers or heterodimers with other amino acid sequences or with native sortilin inhibitor sequences. Heterodimers include dimers containing immunoreactive sortilin inhibiting fragments as well as sortilin inhibiting fragments that need not have or exert any biological activity.

Vps10p-domain receptor antagonists including but not limited to Sortilin inhibiting peptide fragments may be synthesised both in vitro and in vivo. Method for in vitro synthesis are well known, and methods being suitable or suitably adaptable to the synthesis in vivo of sortilin inhibitors are also described in the prior art. When synthesized in vivo, a host cell is transformed with vectors containing DNA encoding a sortilin peptide inhibitor or a fragment thereof. A vector is defined as a replicable nucleic acid construct. Vectors are used to mediate expression of a peptide based Vps10p domain antagonist. An expression vector is a replicable DNA construct in which a nucleic acid sequence encoding the predetermined sortilin inhibitting fragment, or any functional equivalent thereof that can be expressed in vivo, is operably linked to suitable control sequences capable of effecting the expression of the fragment or equivalent in a suitable host. Such control sequences are well known in the art. Both prokaryotic and eukaryotic cells may be used for synthesising ligands. Cultures of cells derived from multicellular organisms however represent preferred host cells. In principle, any higher eukaryotic cell culture is workable, whether from vertebrate or invertebrate culture. Examples of useful host cell lines are VERO and HeLa cells, Chinese hamster ovary (CHO) cell lines, and WI38, BHK, COS-7, 293 and MDCK cell lines. Preferred host cells are eukaryotic cells known to synthesize endogenous sortilin inhibitors. Cultures of such host cells may be isolated and used as a source of the fragment, or used in therapeutic methods of treatment, including therapeutic methods aimed at promoting or inhibiting a growth state, or diagnostic methods carried out on the human or animal body.

Hydrophobic bond: The term “hydrogen bond” as used herein refers to an attractive force, or bridge, which may occur between a hydrogen atom which is bonded covalently to an electronegative atom, for example, oxygen, sulphur, or nitrogen, and another electronegative atom. The hydrogen bond may occur between a hydrogen atom in a first molecule and an electronegative atom in a second molecule (intermolecular hydrogen bonding). Also, the hydrogen bond may occur between a hydrogen atom and an electronegative atom which are both contained in a single molecule (intramolecular hydrogen bonding).

Hydrophobic interaction: The term “hydrophobic interaction” as used herein refers to any interaction occurring between essentially non-polar (hydrophobic) components located within attraction range of one another in a polar environment (e.g. water). As used herein, attraction range is on the scale of from 0.1 up to 2 nm. A particular type of hydrophobic interaction is exerted by “Van der Waal's forces”, i.e. the attractive forces between non-polar molecules that are accounted for by quantum mechanics. Van der Waal's forces are generally associated with momentary dipole moments which are induced by neighbouring molecules and which involve changes in electron distribution.

Hyperlipidemia: which is also known as hyperlipoproteinemia or dyslipidemia is the presence of raised or abnormal levels of lipids and/or lipoproteins in the blood. Lipids (fatty molecules) are transported in a protein capsule, and the density of the lipids and type of protein determines the fate of the particle and its influence on metabolism. Lipid and lipoprotein abnormalities are extremely common in the general population, and are regarded as a highly modifiable risk factor for cardiovascular disease due to the influence of cholesterol, one of the most clinically relevant lipid substances, on atherosclerosis. In addition, some forms may predispose to acute pancreatitis. Hyperlipoproteinemia may be classified into the following subtypes: Hyperlipidemia as used herein is to be understood as a condition characterized by blood plasma concentrations of HDL-cholesterol and/or LDL-cholesterol and/or triglycerides higher than the recommended values listed in table 1 herein.

Hyperlipoproteinemia Type I

This very rare form (also known as Buerger-Gruetz syndrome, primary hyperlipoproteinaemia, or familial hyperchylomicronemia) is due to a deficiency of lipoprotein lipase (LPL) or altered apolipoprotein C2, resulting in elevated chylomicrons, the particles that transfer fatty acids from the digestive tract to the liver. Lipoprotein lipase is also responsible for the initial breakdown of endogenously made triacyiglycerides in the form of very low density lipoprotein (VLDL). As such, one would expect a defect in LPL to also result in elevated VLDL. Its prevalence is 0.1% of the population.

Hyperlipoproteinemia Type II

Hyperlipoproteinemia type II, by far the most common form, is further classified into type IIa and type IIb, depending mainly on whether there is elevation in the triglyceride level in addition to LDL cholesterol.

Hyperlipoproteinemia Type IIa

Familial hypercholesterolemia—This may be sporadic (due to dietary factors), polygenic, or truly familial as a result of a mutation either in the LDL receptor gene on chromosome 19 (0.2% of the population) or the ApoB gene (0.2%). The familial form is characterized by tendon xanthoma, xanthelasma and premature cardiovascular disease.

Hyperlipoproteinemia Type IIb

The high VLDL levels are due to overproduction of substrates, including triglycerides, acetyl CoA, and an increase in B-100 synthesis. They may also be caused by the decreased clearance of LDL. Prevalence in the population is 10%.

Familial Combined Hyperlipoproteinemia (FCH)

Secondary combined hyperlipoproteinemia (usually in the context of metabolic syndrome, for which it is a diagnostic criterion). While dietary modification is the initial approach for treatment of the above mentioned types of hyperlipoproteinemia, many patients require treatment with statins (HMG-CoA reductase inhibitors) to reduce cardiovascular risk. If the triglyceride level is markedly raised, fibrates may be preferable due to their beneficial effects. Combination treatment of statins and fibrates, while highly effective, causes a markedly increased risk of myopathy and rhabdomyolysis and is therefore only done under close supervision. Other agents commonly added to statins are ezetimibe, niacin and bile acid sequestrants. There is some evidence for benefit of plant sterol-containing products and ω3-fatty acids. The present invention provide a novel strategy for controlling the lipid levels of patients in need thereof.

Hyperlipoproteinemia Type III

This form is due to high chylomicrons and IDL (intermediate density lipoprotein). Also known as broad beta disease or dysbetalipoproteinemia, the most common cause for this form is the presence of ApoE E2/E2 genotype. It is due to cholesterol-rich VLDL (β-VLDL). Prevalence is 0.02% of the population.

Hyperlipoproteinemia Type IV

This form is due to high triglycerides. It is also known as hypertriglyceridemia (or pure hypertriglyceridemia). According to the NCEP-ATPIII definition of high triglycerides (>200 mg/dl), prevalence is about 16% of adult population.

Hyperlipoproteinemia Type V

This type is very similar to Hyperlipoproteinemia type I, but with high VLDL in addition to chylomicrons. It is also associated with glucose intolerance and hyperuricemia. Further, unclassified and rare forms include Hypo-alpha lipoproteinemia and Hypo-beta lipoproteinemia.

Antagonists according to the present invention can be used for the preparation of a medicament for the treatment or prevention of hyperlipoproteinemia I, II a, IIb, III, IV and V.

Inhibiting: The term inhibiting as used herein refers to the prevention of binding between two or more components. Ligands identified by the present invention are capable of inhibiting binding between a Vps10p-domain receptor and a proneurotrophin.

Inhibiting binding: The term inhibiting binding between e.g. a proneurotrophin and sortilin as used herein refer to a method of providing a ligand identified by the present invention said ligand being capable of preventing the binding of a proneurotrophin to binding site 3 of sortilin thus preventing formation of a ternary complex between sortilin, proNGF and p75^{NTR} or any fragment or variant thereof. The term inhibiting binding may also refer to inhibiting binding of neurotensin and/or Sortilin propeptide to binding site 1 or 2 of the Vps10p-domain receptor Sortilin.

In vitro/in vivo: the terms are used in their normal meaning.

In silico: a method of performing an in vitro or in vivo operation by computer simulation.

Ischemia: Restriction in blood supply with resultant dysfunction or damage of tissue.

Ischemic tissue damage: Tissue damage due to ischemia.

Ligand: a substance or compound that is able to bind to and form a complex with a biomolecule to serve a biological purpose. In a narrower sense, it is a signal triggering molecule binding to a site on a target protein, by intermolecular forces such as ionic bonds, hydrogen bonds and Van der Waals forces. The docking (association) is usually reversible (dissociation). Actual irreversible covalent binding between a ligand and its target molecule is rare in biological systems. As opposed to the meaning in metalorganic and inorganic chemistry, it is irrelevant, whether or not the ligand actually binds at a metal site, as it is the case in hemoglobin. Ligand binding to receptors may alter the chemical conformation, i.e. the three dimensional shape of the receptor protein. The conformational state of a receptor protein determines the functional state of a receptor. The tendency or strength of binding is called affinity. Ligands include substrates, inhibitors, activators, and neurotransmitters. Radioligands are radioisotope labeled compounds and used in vivo as tracers in PET studies and for in vitro binding studies.

Moieties of a particular compound cover group(s) or part(s) of said particular compound.

Pharmaceutical agent: The terms “pharmaceutical agent” or “drug” or “medicament” refer to any therapeutic or prophylactic agent which may be used in the treatment (including the prevention, diagnosis, alleviation, or cure) of a malady, affliction, condition, disease or injury in a patient. Therapeutically useful genetic determinants, peptides, polypeptides and polynucleotides may be included within the meaning of the term pharmaceutical or drug. As defined herein, a “therapeutic agent,” “pharmaceutical agent” or “drug” or “medicament” is a type of bioactive agent.

Pharmaceutical composition: or drug, medicament or agent refers to any chemical or biological material, compound, or composition capable of inducing a desired therapeutic effect when properly administered to a patient. Some drugs are sold in an inactive form that is converted in vivo into a metabolite with pharmaceutical activity. For purposes of the present invention, the terms “pharmaceutical composition” and “medicament” encompass both the inactive drug and the active metabolite.

Polypeptide: The term “polypeptide” as used herein refers to a molecule comprising at least two amino acids. The amino acids may be natural or synthetic. “Oligopeptides” are defined herein as being polypeptides of length not more than 100 amino acids. The term “polypeptide” is also intended to include proteins, i.e. functional biomolecules comprising at least one polypeptide; when comprising at least two polypeptides, these may form complexes, be covalently linked or may be non-covalently linked. The polypeptides in a protein can be glycosylated and/or lipidated and/or comprise prosthetic groups.

Polynucleotide: “Polynucleotide” as used herein refers to a molecule comprising at least two nucleic acids. The nucleic acids may be naturally occurring or modified, such as locked nucleic acids (LNA), or peptide nucleic acids (PNA). Polynucleotide as used herein generally pertains to
i) a polynucleotide comprising a predetermined coding sequence, or
ii) a polynucleotide encoding a predetermined amino acid sequence, or
iii) a polynucleotide encoding a fragment of a polypeptide encoded by polynucleotides (i) or (ii), wherein said fragment has at least one predetermined activity as specified herein; and
iv) a polynucleotide the complementary strand of which hybridizes under stringent conditions with a polynucleotide as defined in any one of (i), (ii) and (iii), and encodes a polypeptide, or a fragment thereof, having at least one predetermined activity as specified herein; and
v) a polynucleotide comprising a nucleotide sequence which is degenerate to the nucleotide sequence of polynucleotides (iii) or (iv);
or the complementary strand of such a polynucleotide.

Purified antibody: The term a “purified antibody” is an antibody at least 60 weight percent of which is free from the polypeptides and naturally-occurring organic molecules with which it is naturally associated. Preferably, the preparation comprises antibody in an amount of at least 75 weight percent, more preferably at least 90 weight percent, and most preferably at least 99 weight percent.

Preferably the antibody of the present invention is a rabbit anti-Sortilin antibody.

Root mean square deviation: The term “root mean square deviation” (rmsd) is used as a mean of comparing two closely related structures and relates to a deviation in the distance between related atoms of the two structures after structurally minimizing this distance in an alignment. Related proteins with closely related structures will be characterized by relatively low RMSD values whereas larger differences will result in an increase of the RMSD value.

Sequence identity: Sequence identity is determined in one embodiment by utilising fragments of a peptide or polypeptide based Vps10p domain antagonist comprising at least 25 contiguous amino acids and having an amino acid sequence which is at least 80%, such as 85%, for example 90%, such as 95%, for example 99% identical to the amino acid sequence of any of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, SEQ ID NO: 10, SEQ ID NO: 11, SEQ ID NO: 12, SEQ ID NO: 13, SEQ ID NO: 14 and SEQ ID NO: 15 respectively, wherein the percent identity is determined with the algorithm GAP, BESTFIT, or FASTA in the Wisconsin Genetics Software Package Release 7.0, using default gap weights.

The following terms are used to describe the sequence relationships between two or more polynucleotides: “predetermined sequence”, “comparison window”, “sequence identity”, “percentage of sequence identity”, and “substantial identity”.

A “predetermined sequence” is a defined sequence used as a basis for a sequence comparison; a predetermined sequence may be a subset of a larger sequence, for example, as a segment of a full-length DNA or gene sequence given in a sequence listing, such as a polynucleotide sequence of SEQ ID NO:1, or may comprise a complete DNA or gene sequence. Generally, a predetermined sequence is at least nucleotides in length, frequently at least 25 nucleotides in length, and often at least 50 nucleotides in length.

Since two polynucleotides may each (1) comprise a sequence (i.e., a portion of the complete polynucleotide sequence) that is similar between the two polynucleotides, and (2) may further comprise a sequence that is divergent between the two polynucleotides, sequence comparisons between two (or more) polynucleotides are typically performed by comparing sequences of the two polynucleotides over a “comparison window” to identify and compare local regions of sequence similarity. A “comparison window”, as used herein, refers to a conceptual segment of at least 20 contiguous nucleotide positions wherein a polynucleotide sequence may be compared to a predetermined sequence of at least 20 contiguous nucleotides and wherein the portion of the polynucleotide sequence in the comparison window may comprise additions or deletions (i.e., gaps) of 20 percent or less as compared to the predetermined sequence (which does not comprise additions or deletions) for optimal alignment of the two sequences.

Optimal alignment of sequences for aligning a comparison window may be conducted by the local homology algorithm of Smith and Waterman (1981) Adv. Appl. Math. 2: 482, by the homology alignment algorithm of Needleman and Wunsch (1970) J. Mol. Biol. 48: 443, by the search for similarity method of Pearson and Lipman (1988) Proc. Natl. Acad. Sci. (U.S.A.) 85: 2444, by computerized implementations of these algorithms (GAP, BESTFIT, FASTA, and TFASTA in the Wisconsin Genetics Software Package Release 7.0, Genetics Computer Group, 575 Science Dr., Madison, Wis.), or by inspection, and the best alignment (i.e., resulting in the highest percentage of homology over the comparison window) generated by the various methods is selected.

The term “sequence identity” means that two polynucleotide sequences are identical (i.e., on a nucleotide-by-nucleotide basis) over the window of comparison. The term “percentage of sequence identity” is calculated by comparing two optimally aligned sequences over the window of comparison, determining the number of positions at which the identical nucleic acid base (e.g., A, T, C, G, U, or I) occurs in both sequences to yield the number of matched positions, dividing the number of matched positions by the total number of positions in the window of comparison (i.e., the window size), and multiplying the result by 100 to yield the percentage of sequence identity. The terms “substantial identity” as used herein denotes a characteristic of a polynucleotide sequence, wherein the polynucleotide comprises a sequence that has at least 85 percent sequence identity, preferably at least 90 to 95 percent sequence identity, more usually at least 99 percent sequence identity as compared to a predetermined sequence over a comparison window of at least 20 nucleotide positions, frequently over a window of at least 25-50 nucleotides, wherein the percentage of sequence identity is calculated by comparing the predetermined sequence to the polynucleotide sequence which may include deletions or additions which total 20 percent or less of the predetermined sequence over the window of comparison. The predetermined sequence may be a subset of a larger sequence, for example, as a segment of the full-length SEQ ID NO:1 polynucleotide sequence illustrated herein.

As applied to polypeptides, a degree of identity of amino acid sequences is a function of the number of identical amino acids at positions shared by the amino acid sequences. A degree of homology or similarity of amino acid sequences is a function of the number of amino acids, i.e. structurally related, at positions shared by the amino acid sequences.

An “unrelated” or “non-homologous” sequence shares less than 40% identity, though preferably less than 25% identity, with a peptide or polypeptide based Vps10p domain antagonist of the present invention. The term “substantial identity” means that two peptide sequences, when optimally aligned, such as by the programs GAP or BESTFIT using default gap weights, share at least 80 percent sequence identity, preferably at least 90 percent sequence identity, more preferably at least 95 percent sequence identity or more (e.g., 99 percent sequence identity). Preferably, residue positions which are not identical differ by conservative amino acid substitutions.

Conservative amino acid substitutions refer to the interchangeability of residues having similar side chains. For example, a group of amino acids having aliphatic side chains is glycine, alanine, valine, leucine, and isoleucine; a group of amino acids having aliphatic-hydroxyl side chains is serine and threonine, a group of amino acids having amide-containing side chains is asparagine and glutamine; a group of amino acids having aromatic side chains is phenylalanine, tyrosine, and tryptophan; a group of amino acids having basic side chains is lysine, arginine, and histidine; and a group of amino acids having sulphur-containing side chains is cysteine and methionine. Preferred conservative amino acids substitution groups are: valine-leucine-isoleucine, phenylalanine-tyrosine, lysine-arginine, alanine-valine, and asparagine-glutamine.

Additionally, variants are also determined based on a predetermined number of conservative amino acid substitutions as defined herein below. Conservative amino acid substitution as used herein relates to the substitution of one amino acid (within a predetermined group of amino acids) for another amino acid (within the same group), wherein the amino acids exhibit similar or substantially similar characteristics.

Within the meaning of the term “conservative amino acid substitution” as applied herein, one amino acid may be substituted for another within the groups of amino acids indicated herein below:
i) Amino acids having polar side chains (Asp, Glu, Lys, Arg, His, Asn, Gln, Ser, Thr, Tyr, and Cys,)
ii) Amino acids having non-polar side chains (Gly, Ala, Val, Leu, Ile, Phe, Trp, Pro, and Met)
iii) Amino acids having aliphatic side chains (Gly, Ala Val, Leu, Ile)
iv) Amino acids having cyclic side chains (Phe, Tyr, Trp, His, Pro)
v) Amino acids having aromatic side chains (Phe, Tyr, Trp)
vi) Amino acids having acidic side chains (Asp, Glu)
vii) Amino acids having basic side chains (Lys, Arg, His)
viii) Amino acids having amide side chains (Asn, Gln)
ix) Amino acids having hydroxy side chains (Ser, Thr)
x) Amino acids having sulphur-containing side chains (Cys, Met),
xi) Neutral, weakly hydrophobic amino acids (Pro, Ala, Gly, Ser, Thr)
xii) Hydrophilic, acidic amino acids (Gln, Asn, Glu, Asp), and
xiii) Hydrophobic amino acids (Leu, Ile, Val)

Accordingly, a variant or a fragment thereof according to the invention may comprise, within the same variant of the sequence or fragments thereof, or among different variants of the sequence or fragments thereof, at least one substitution, such as a plurality of substitutions introduced independently of one another.

It is clear from the above outline that the same variant or fragment thereof may comprise more than one conservative amino acid substitution from more than one group of conservative amino acids as defined herein above.

The addition or deletion of at least one amino acid may be an addition or deletion of from preferably 2 to 250 amino acids, such as from 10 to 20 amino acids, for example from 20 to 30 amino acids, such as from 40 to 50 amino acids. However, additions or deletions of more than 50 amino acids, such as additions from 50 to 100 amino acids, addition of 100 to 150 amino acids, addition of 150-250 amino acids, are also comprised within the present invention. The deletion and/or the addition may—independently of one another—be a deletion and/or an addition within a sequence and/or at the end of a sequence.

siRNA: “small interfering RNA” (siRNA) is a short (often, but not restricted to, less than 30 nucleotides long) double-stranded RNA molecule capable of causing gene-specific silencing in mammalian cells.

Substituted lower alkyl means a lower alkyl having one to three substituents selected from the group consisting of hydroxyl, alkoxy, amino, amido, carboxyl, acyl, halogen, cyano, nitro and thiol.

Treatment: The term “treatment” as used herein refers to a method involving therapy including surgery of a clinical condition in an individual including a human or animal body. The therapy may be ameliorating, curative or prophylactic, i.e. reducing the risk of aquiring a disease.

Variants: The term “variants” as used herein refers to amino acid sequence variants said variants preferably having at least 60% identity, for example at least 63% identity, such as at least 66% identity, for example at least 70% sequence identity, for example at least 72% sequence identity, for example at least 75% sequence identity, for example at least 80% sequence identity, such as at least 85% sequence identity, for example at least 90% sequence identity, such as at least 91% sequence identity, for example at least 91% sequence identity, such as at least 92% sequence identity, for example at least 93% sequence identity, such as at least 94% sequence identity, for example at least 95% sequence identity, such as at least 96% sequence identity, for example at least 97% sequence identity, such as at least 98% sequence identity, for example 99% sequence identity with any of the predetermined sequences. Variants of neurotensin include but not limited to artificial variants of neurotensin such as NT69L.

Up-regulation of expression: a process leading to increased expression of genes, preferably of endogenous genes.

Antagonist/Inhibitor to the Vps10p-Domain Receptor

In a main aspect the present invention relate to the use of at least one antagonist capable of binding to a receptor of the Vps10p-domain selected family thus inhibiting the activity of said Vps10p-domain receptor, in the manufacture of a medicament, for the treatment and/or prevention of abnormal plasma lipid concentrations in an animal.

In a main aspect the present invention relate to the use of at least one antagonist capable of binding to the Vps10p-domain receptor Sortilin (SEQ ID NO. 1) or a fragment or variant thereof, thus inhibiting the activity of said the Vps10p-domain receptor Sortilin (SEQ ID NO. 1), in the manufacture of a medicament, for the treatment and/or prevention of abnormal plasma lipid concentrations in an animal.

In a main aspect the present invention relate to the use of at least one antagonist capable of binding to the Vps10p-domain receptor SorLA (SEQ ID NO. 2) or a fragment or variant thereof, thus inhibiting the activity of said the Vps10p-domain receptor SorLA (SEQ ID NO. 2), in the manufacture of a medicament, for the treatment and/or prevention of abnormal plasma lipid concentrations in an animal.

In a main aspect the present invention relate to the use of at least one antagonist capable of binding to the Vps10p-domain receptor SorCS1 (SEQ ID NO. 3) or a fragment or variant thereof, thus inhibiting the activity of said the Vps10p-domain receptor SorCS1 (SEQ ID NO. 3), in the manufacture of a medicament, for the treatment and/or prevention of abnormal plasma lipid concentrations in an animal.

In a main aspect the present invention relate to the use of at least one antagonist capable of binding to the Vps10p-domain receptor SorCS2 (SEQ ID NO. 4) or a fragment or variant thereof, thus inhibiting the activity of said the Vps10p-domain receptor SorCS2 (SEQ ID NO. 4), in the manufacture of a medicament, for the treatment and/or prevention of abnormal plasma lipid concentrations in an animal.

In a main aspect the present invention relate to the use of at least one antagonist capable of binding to the Vps10p-domain receptor SorCS3 (SEQ ID NO. 5) or a fragment or variant thereof, thus inhibiting the activity of said the Vps10p-domain receptor SorCS3 (SEQ ID NO. 5), in the manufacture of a medicament, for the treatment and/or prevention of abnormal plasma lipid concentrations in an animal.

In a main aspect of the present invention the antagonist has the general structure of formula (I):

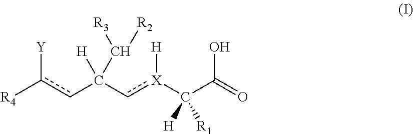

wherein X is an atom acting as hydrogen donor said atom selected from the group consisting of N, O, S, P and wherein

Y is an electronegative atom acting as hydrogen bond acceptor selected from the group consisting of O, N, S, F, Cl, Br, I, and wherein

R₁ is C3-6 alkyl, C4-6 cyclyl, a heterocyclic or a heteroaromatic structure having one ring, 4 to 6 ring members in each and 1 to 3 heteroatoms, or a heteroalkyl comprising 1 to 3 heteroatoms selected from the group consisting of N, O, S(O)₀₋₂, and wherein

R₂ is a hydrogen, a C1-12 alkyl or an aromatic, a carbocyclic, a heterocyclic or a heteroaromatic structure having 1-3 rings, 3-8 ring members in each and 0 to 4 heteroatoms, or a heteroalkyl comprising 1 to 8 heteroatoms selected from the group consisting of N, O, S(O)₀₋₂, and wherein

R₃ is hydrogen, SH, imidazole, C1-12 alkyl or an aromatic, a carbocyclic, a heterocyclic or a heteroaromatic structure having 1-3 rings, 3-8 ring members in each and 0 to 4 heteroatoms, or a heteroalkyl comprising 1 to 8 heteroatoms selected from the group consisting of N, O, S, and wherein

R₄ is selected from the functional groups C1-100 linear or branched alkyl, linear or branched alkenyl, linear or branched alkynyl, phenyl, benzyl, haloalkane, chloroalkane, bromoalkane, iodoalkane, haloformyl, hydroxyl, carbonyl, aldehyde, carbonate ester, carboxylate, carboxyl, ether, ester, hydroperoxy, peroxy, carboxamide, primary amine, secondary amine, tertiary amine, ammonium, primary ketimine, secondary ketimine, primary aldimine, secondary aldimine, imide, azide, azo (diimide), cyanate, isocyanide, isothiocyanate, nitrate, nitrile, nitrosooxy, nitro, nitroso, priidyl, phosphino, phosphate, phosphono, sulfonyl, sulfinyl, sulfhydryl (SH), thiocyanate, disulfide, a linker L2 or L3, and an amino acid sequence being at least 50% identical to SEQ ID NO: 10 or a fragment thereof.

The antagonist of formula (I) is specific for binding site 1 (high affinity Neurotensin binding site) of Sortilin.

In another main aspect the antagonist has the general structure of formula (II):

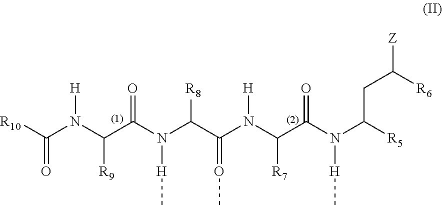

wherein Z is a hydrogen bond donor or acceptor selected from the group consisting of carbonyl, hydroxyl, amino, imino, amide, sulfhydryl, chloro, fluoro, and wherein

R₅ is selected from the group consisting of H, CH₃, and a linker L2, and wherein

R₆ is selected from the group consisting of H, —CH₃, —CH₂CH₃ and —OCH₃, and wherein

R₇ is selected from the group consisting of side chains of glutamate, glutamine, lysine, arginine, histidine, tyrosine, methionine, cysteine, aliphatic C4-6 groups, and wherein

R₈ is selected from the group consisting of side chains of tyrosine, histidine, serine, threonine, aspartate, asparagine, cysteine, phenylalanine, iodo-tyrosine and —CH₂—NH₂, and wherein

R₉ is selected from the group consisting of side chain of lysine, arginine, glutamine, C3-8 aliphatic and heteroaliphatic groups, carbocyclic and heterocyclic groups comprising 5 or 6 membered rings, and wherein

R₁₀ is selected from the group consisting of a pyroglutamate, poly-carbohydrates and a polypeptide of length greater than equal to 10, and wherein

R₁₁ and R₁₂ individually are selected from the group consisting of H, C1-12 linear or branched alkyl, linear or branched alkenyl, linear or branched alkynyl, phenyl, benzyl, haloalkane, chloroalkane, bromoalkane, iodoalkane, haloformyl, hydroxyl, carbonyl, aldehyde, carbonate ester, carboxylate, carboxyl, ether, ester, hydroperoxy, peroxy, carboxamide, primary amine, secondary amine, tertiary amine, ammonium, primary ketimine, secondary ketimine, primary aldimine, secondary aldimine, imide, azide, azo (diimide), cyanate, isocyanide, isothiocyanate, nitrate, nitrile, nitrosooxy, nitro, nitroso, priidyl, phosphino, phosphate, phosphono, sulfonyl, sulfinyl, sulfhydryl (SH), and wherein

the covalent bonds (1) and (2) individually are selected from the group consisting of single bonds and double bonds.

The antagonist of formula (II) is specific for binding site 2 (low affinity Neurotensin binding site) of Sortilin.

In another main aspect the antagonist has the general structure of formula (III):

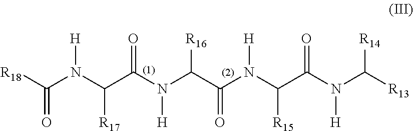

wherein R₁₃ is selected from the group consisting of H, C1-12 alkyl, alkenyl, alkynyl and a linker L3, and wherein

R₁₄, R₁₅, R₁₇, R₁₉, R₂₀ individually are selected from the group consisting of H, C1-12 alkyl, alkenyl and alkynyl, and wherein

R₁₆ is selected from the group consisting of sidechains of phenylalanine, leucine, isoleucine, valine, methionine, histidine, cysteine, lysine and aliphatic C3-7, and wherein

R₁₈ is selected from the group consisting of H, —CH₃ and —CH₂OH, and wherein

the covalent bonds (1) and (2) individually are selected from the group consisting of single bonds and double bonds.

The antagonist of formula (I) or (II), wherein the linker L2 is selected from the group consisting of a peptide backbone of 5 to 6 residues, C15-20 alkyl, 015-20 alkenyl and C15-20 alkynyl.

The antagonist of formula (III) is specific for binding site 3 (proneurotrophin binding site) of Sortilin.

In one embodiment the antagonist of formula (I) is linked to the antagonist of formula (II) by a linker L2, thereby forming the general formula (IV):

[Formula(I)]-[Linker L2]-[Formula(II)] (IV)

In one embodiment the linker L3 is selected from the group consisting of a peptide backbone of 12 to 20 residues, C30-60 alkyl, C30-60 alkenyl, C30-60 alkynyl.

The antagonist of formula (I) linked to the antagonist of formula (III) by the linker L3, thereby forming the general formula (V):

[Formula(I)]-[Linker L3]-[Formula(III)] (V)

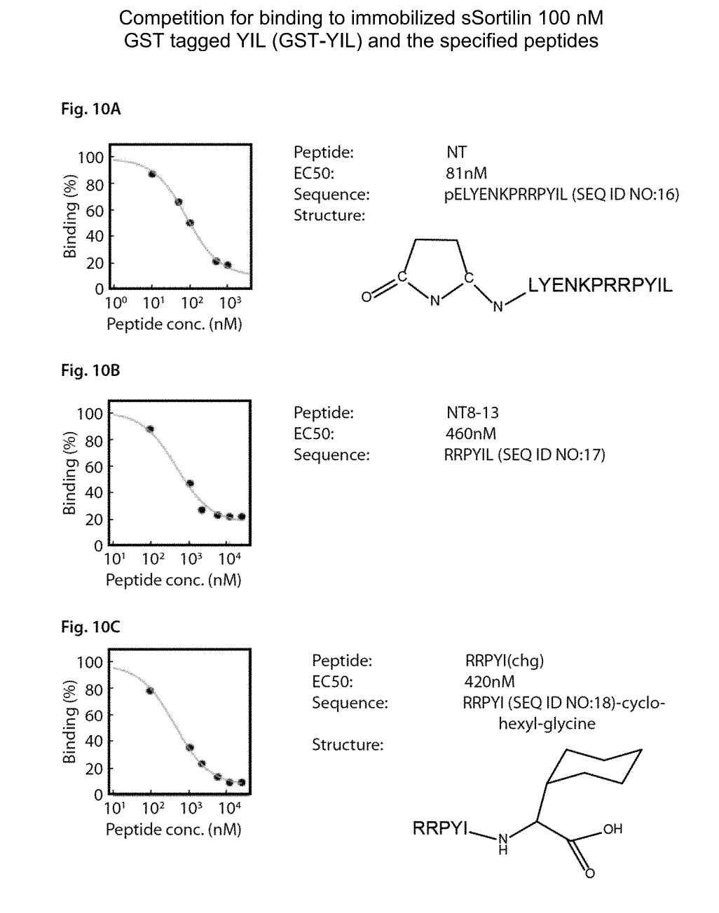

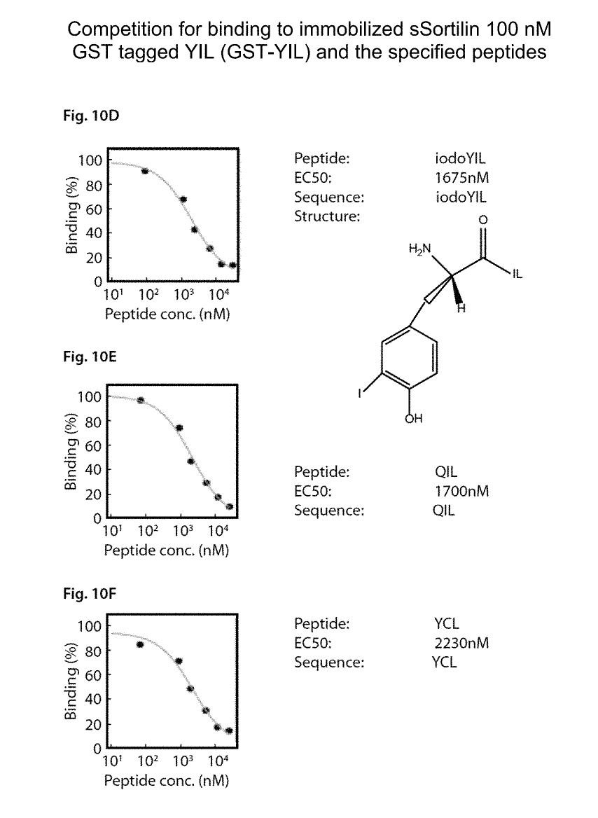

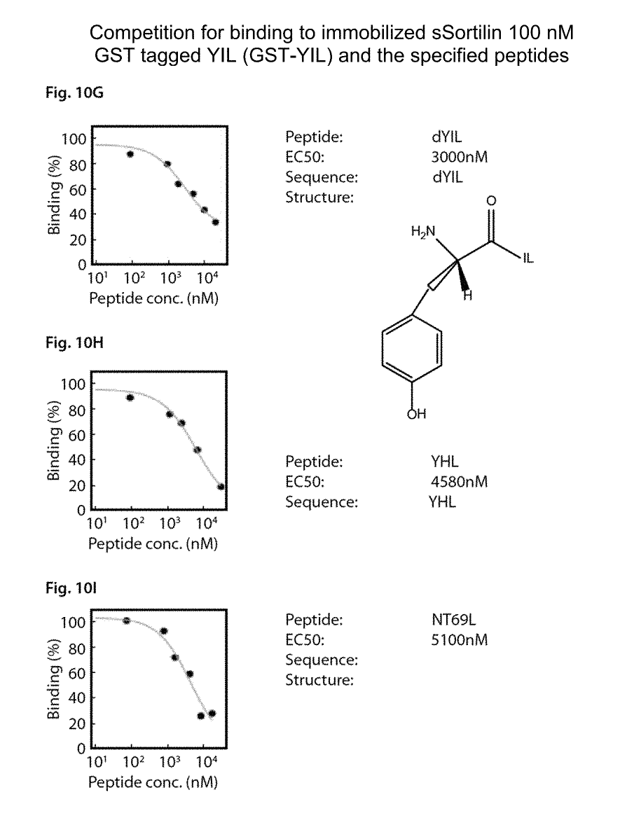

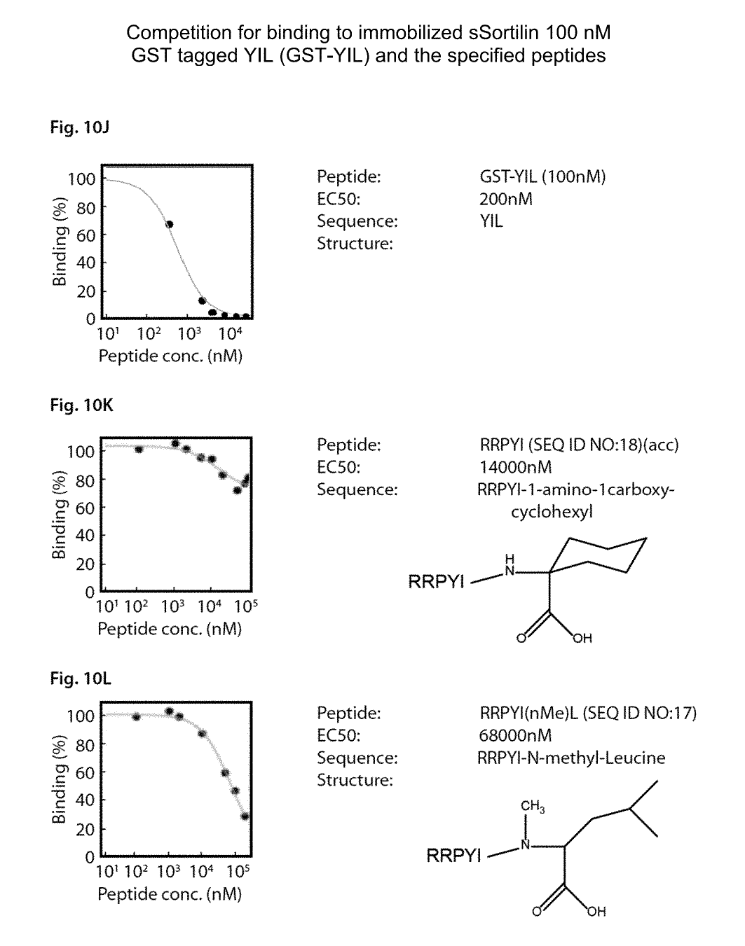

The antagonist as defined herein above wherein said antagonist is selected from the group consisting of RRPYI(chg), iodoYlL, OIL, YCL, dYIL, YHL, RRPYI(acc), RRPYI(nMe)L, YIL depicted in FIG. 10A-10L.

The antagonist as defined herein above wherein said antagonist is RRPYI(chg) depicted in FIG. 10A-10L.

The antagonist as defined herein above wherein said antagonist is iodoYlL depicted in FIG. 10A-10L.

The antagonist as defined herein above wherein said antagonist is QIL depicted in FIG. 10A-10L.

The antagonist as defined herein above wherein said antagonist is YCL depicted in FIG. 10A-10L.

The antagonist as defined herein above wherein said antagonist is dYIL depicted in FIG. 10A-10L.

The antagonist as defined herein above wherein said antagonist is YHL depicted in FIG. 10A-10L.

The antagonist as defined herein above wherein said antagonist is RRPYI(acc) depicted in FIG. 10A-10L.

The antagonist as defined herein above wherein said antagonist is RRPYI(nMe)L depicted in FIG. 10A-10L.

The antagonist as defined herein above wherein said antagonist is YIL depicted in FIG. 10A-10L.

In one embodiment of the present invention the animal is a human being (Homo Sapiens Sapiens).

In one embodiment of the present invention the animal is selected from the group consisting of mouse, rat, rabbit, canine and dog.

Indications

In one embodiment of the present invention the abnormal plasma lipid concentration is hyperlipoproteinemia.

In one embodiment of the present invention the hyperlipoproteinemia is selected from the group consisting of Types I, IIa, IIb, III, IV or V hyperlipoproteinemia.

In a further embodiment of the present invention the Type I hyperlipoproteinemia is selected from the group consisting of Buerger-Gruetz syndrome, Primary hyperlipoproteinaemia, or Familial hyperchylomicronemia.

In a further embodiment of the present invention the Type IIa hyperlipoproteinemia is selected from the group consisting of Polygenic hypercholesterolemia or Familial hypercholes-terolemia.

In a further embodiment of the present invention the Type lib hyperlipoproteinemia is Combined hyperlipidemia.

In a further embodiment of the present invention the Type III hyperlipoproteinemia is Familial Dysbe-talipoproteinemia.

In a further embodiment of the present invention the Type IV hyperlipoproteinemia is Endogenous Hyperlipemia.

In a further embodiment of the present invention the Type V hyperlipoproteinemia is Familial Hyper-triglyceridemia.

In a further embodiment of the present invention the hyperlipoproteinemia effect a disease or disorder selected from the group consisting of Aneurysm, Angina pectoris, Atherosclerosis, Cerebrovascular Accident (Stroke), Cerebrovas-cular disease, Congenital heart disease, Congestive Heart Failure, Coronary Ar-tery Disease, Dilated cardiomyopathy, Diastolic dysfunction, Endocarditis, Hypercholesterolemia, Hypertension, Hyperlipidemia, Hypertrophic cardiomyopa-thy, Mitral valve prolapse, Myocardial infarction (Heart Attack) and Venous Thromboembolism, in an animal.

In a further embodiment of the present invention the Vps10p-domain receptor comprises an amino acid sequence having at least 60% sequence identity to SEQ ID NO. 1, SEQ ID NO. 2, SEQ ID NO. 3, SEQ ID NO. 4 or SEQ ID NO. 5.

In a further embodiment of the present invention the Vps10p-domain receptor comprises an amino acid sequence having at least 65% sequence identity to SEQ ID NO. 1, SEQ ID NO. 2, SEQ ID NO. 3, SEQ ID NO. 4 or SEQ ID NO. 5.

In a further embodiment of the present invention the Vps10p-domain receptor comprises an amino acid sequence having at least 70% sequence identity to SEQ ID NO. 1, SEQ ID NO. 2, SEQ ID NO. 3, SEQ ID NO. 4 or SEQ ID NO. 5.

In a further embodiment of the present invention the Vps10p-domain receptor comprises an amino acid sequence having at least 75% sequence identity to SEQ ID NO. 1, SEQ ID NO. 2, SEQ ID NO. 3, SEQ ID NO. 4 or SEQ ID NO. 5.

In a further embodiment of the present invention the Vps10p-domain receptor comprises an amino acid sequence having at least 80% sequence identity to SEQ ID NO. 1, SEQ ID NO. 2, SEQ ID NO. 3, SEQ ID NO. 4 or SEQ ID NO. 5.

In a further embodiment of the present invention the Vps10p-domain receptor comprises an amino acid sequence having at least 85% sequence identity to SEQ ID NO. 1, SEQ ID NO. 2, SEQ ID NO. 3, SEQ ID NO. 4 or SEQ ID NO. 5. In a further embodiment of the present invention the Vps10p-domain receptor comprises an amino acid sequence having at least 90% sequence identity to SEQ ID NO. 1, SEQ ID NO. 2, SEQ ID NO. 3, SEQ ID NO. 4 or SEQ ID NO. 5.

In a further embodiment of the present invention the Vps10p-domain receptor comprises an amino acid sequence having at least 91% sequence identity to SEQ ID NO. 1, SEQ ID NO. 2, SEQ ID NO. 3, SEQ ID NO. 4 or SEQ ID NO. 5.

In a further embodiment of the present invention the Vps10p-domain receptor comprises an amino acid sequence having at least 92% sequence identity to SEQ ID NO. 1, SEQ ID NO. 2, SEQ ID NO. 3, SEQ ID NO. 4 or SEQ ID NO. 5.

In a further embodiment of the present invention the Vps10p-domain receptor comprises an amino acid sequence having at least 93% sequence identity to SEQ ID NO. 1, SEQ ID NO. 2, SEQ ID NO. 3, SEQ ID NO. 4 or SEQ ID NO. 5.

In a further embodiment of the present invention the Vps10p-domain receptor comprises an amino acid sequence having at least 94% sequence identity to SEQ ID NO. 1, SEQ ID NO. 2, SEQ ID NO. 3, SEQ ID NO. 4 or SEQ ID NO. 5.

In a further embodiment of the present invention the Vps10p-domain receptor comprises an amino acid sequence having at least 95% sequence identity to SEQ ID NO. 1, SEQ ID NO. 2, SEQ ID NO. 3, SEQ ID NO. 4 or SEQ ID NO. 5.

In a further embodiment of the present invention the Vps10p-domain receptor comprises an amino acid sequence having at least 96% sequence identity to SEQ ID NO. 1, SEQ ID NO. 2, SEQ ID NO. 3, SEQ ID NO. 4 or SEQ ID NO. 5.

In a further embodiment of the present invention the Vps10p-domain receptor comprises an amino acid sequence having at least 97% sequence identity to SEQ ID NO. 1, SEQ ID NO. 2, SEQ ID NO. 3, SEQ ID NO. 4 or SEQ ID NO. 5.

In a further embodiment of the present invention the Vps10p-domain receptor comprises an amino acid sequence having at least 98% sequence identity to SEQ ID NO. 1, SEQ ID NO. 2, SEQ ID NO. 3, SEQ ID NO. 4 or SEQ ID NO. 5.

In a further embodiment of the present invention the Vps10p-domain receptor comprises an amino acid sequence having at least 99% sequence identity to SEQ ID NO. 1, SEQ ID NO. 2, SEQ ID NO. 3, SEQ ID NO. 4 or SEQ ID NO. 5.

In a further embodiment of the present invention the Vps10p-domain receptor comprises an amino acid sequence having at least 99.5% sequence identity to SEQ ID NO. 1, SEQ ID NO. 2, SEQ ID NO. 3, SEQ ID NO. 4 or SEQ ID NO. 5.

In a further embodiment of the present invention the Vps10p-domain receptor comprises an amino acid sequence having at least 99.9% sequence identity to SEQ ID NO. 1, SEQ ID NO. 2, SEQ ID NO. 3, SEQ ID NO. 4 or SEQ ID NO. 5.

In one embodiment of the present invention the at least one antagonist as defined herein is capable of inhibiting binding of an agonist selected from the group consisting of SEQ ID NO. 6 (proNGF), SEQ ID NO. 7 (proBDNF), SEQ ID NO. 8 (proNT3), SEQ ID NO. 9 (pro-NT4/5), SEQ ID NO. 14 (ApoE) or SEQ ID NO. 15 (LpL) or a fragment or variant thereof, to said Vps10p-domain receptor.

In another embodiment of the present invention the at least one antagonist as defined herein above is bound to at least one amino acid residue of the binding site comprising amino acid residues R325, S316, Y351, I353, K260, I327, F314, F350 to M363, S305, F306, T398 to G400, I303-G309, Q349-A356, Y395 and T402 of SEQ ID NO. 1 (Sortilin) or a fragment or variant thereof wherein the fragment is selected from, but not limited to the group comprising soluble Sortilin, pro-Sortilin and mature Sortilin and the variant is selected from, but not limited to the group comprising a sequence having at least 60% sequence identity to SEQ ID NO. 1, or any of the fragments soluble Sortilin, pro-Sortilin and mature Sortilin and a sequence having at least 65% sequence identity to SEQ ID NO. 1, or any of the fragments soluble Sortilin, pro-Sortilin and mature Sortilin and a sequence having at least 70% sequence identity to SEQ ID NO. 1, or any of the fragments soluble Sortilin, pro-Sortilin and mature Sortilin and a sequence having at least 75% sequence identity to SEQ ID NO. 1, or any of the fragments soluble Sortilin, pro-Sortilin and mature Sortilin and a sequence having at least 80% sequence identity to SEQ ID NO. 1, or any of the fragments soluble Sortilin, pro-Sortilin and mature Sortilin and a sequence having at least 85% sequence identity to SEQ ID NO. 1, or any of the fragments soluble Sortilin, pro-Sortilin and mature Sortilin a sequence having at least 90% sequence identity to SEQ ID NO. 1, or any of the fragments soluble Sortilin, pro-Sortilin and mature Sortilin a sequence having at least 95% sequence identity to SEQ ID NO. 1, or any of the fragments soluble Sortilin, pro-Sortilin and mature Sortilin and a sequence having at least 99% sequence identity to SEQ ID NO. 1, or any of the fragments soluble Sortilin, pro-Sortilin and mature Sortilin.

In yet another embodiment of the present invention the at least one antagonist as defined herein above is bound to at least one amino acid residue of the binding site comprising amino acid residues R325, S316, Y351, I353, K260, I327. F314, F350 to M363, S305, F306 and T398 to G400 of SEQ ID NO. 1 (Sortilin) or a fragment or variant thereof wherein the fragment is selected from, but not limited to the group comprising soluble Sortilin, pro-Sortilin and mature Sortilin and the variant is selected from, but not limited to the group comprising a sequence having at least 60% sequence identity to SEQ ID NO. 1, or any of the fragments soluble Sortilin, pro-Sortilin and mature Sortilin and a sequence having at least 65% sequence identity to SEQ ID NO. 1, or any of the fragments soluble Sortilin, pro-Sortilin and mature Sortilin and a sequence having at least 70% sequence identity to SEQ ID NO. 1, or any of the fragments soluble Sortilin, pro-Sortilin and mature Sortilin and a sequence having at least 75% sequence identity to SEQ ID NO. 1, or any of the fragments soluble Sortilin, pro-Sortilin and mature Sortilin and a sequence having at least 80% sequence identity to SEQ ID NO. 1, or any of the fragments soluble Sortilin, pro-Sortilin and mature Sortilin and a sequence having at least 85% sequence identity to SEQ ID NO. 1, or any of the fragments soluble Sortilin, pro-Sortilin and mature Sortilin a sequence having at least 90% sequence identity to SEQ ID NO. 1, or any of the fragments soluble Sortilin, pro-Sortilin and mature Sortilin a sequence having at least 95% sequence identity to SEQ ID NO. 1, or any of the fragments soluble Sortilin, pro-Sortilin and mature Sortilin and a sequence having at least 99% sequence identity to SEQ ID NO. 1, or any of the fragments soluble Sortilin, pro-Sortilin and mature Sortilin.

In yet another embodiment of the present invention the at least one antagonist as defined herein above is bound to at least one amino acid residue of the binding site comprising amino acid residues R325, S316, Y351, I353, K260, I327, F314 and F350 to M363 of SEQ ID NO. 1 (Sortilin) or a fragment or variant thereof wherein the fragment is selected from, but not limited to the group comprising soluble Sortilin, pro-Sortilin and mature Sortilin and the variant is selected from, but not limited to the group comprising a sequence having at least 60% sequence identity to SEQ ID NO. 1, or any of the fragments soluble Sortilin, pro-Sortilin and mature Sortilin and a sequence having at least 65% sequence identity to SEQ ID NO. 1, or any of the fragments soluble Sortilin, pro-Sortilin and mature Sortilin and a sequence having at least 70% sequence identity to SEQ ID NO. 1, or any of the fragments soluble Sortilin, pro-Sortilin and mature Sortilin and a sequence having at least 75% sequence identity to SEQ ID NO. 1, or any of the fragments soluble Sortilin, pro-Sortilin and mature Sortilin and a sequence having at least 80% sequence identity to SEQ ID NO. 1, or any of the fragments soluble Sortilin, pro-Sortilin and mature Sortilin and a sequence having at least 85% sequence identity to SEQ ID NO. 1, or any of the fragments soluble Sortilin, pro-Sortilin and mature Sortilin a sequence having at least 90% sequence identity to SEQ ID NO. 1, or any of the fragments soluble Sortilin, pro-Sortilin and mature Sortilin a sequence having at least 95% sequence identity to SEQ ID NO. 1, or any of the fragments soluble Sortilin, pro-Sortilin and mature Sortilin and a sequence having at least 99% sequence identity to SEQ ID NO. 1, or any of the fragments soluble Sortilin, pro-Sortilin and mature Sortilin.

In yet another embodiment of the present invention the at least one antagonist as defined herein above is bound to at least one amino acid residue of the binding site comprising amino acid residues L572, L114, V112, R109 to S111, S115 to G118, T570, G571, W586, W597, T168-I174, L572, A573 and S584 to F588 of SEQ ID NO. 1 (Sortilin) or a fragment or variant thereof wherein the fragment is selected from, but not limited to the group comprising soluble Sortilin, pro-Sortilin and mature Sortilin and the variant is selected from, but not limited to the group comprising a sequence having at least 60% sequence identity to SEQ ID NO. 1, or any of the fragments soluble Sortilin, pro-Sortilin and mature Sortilin and a sequence having at least 65% sequence identity to SEQ ID NO. 1, or any of the fragments soluble Sortilin, pro-Sortilin and mature Sortilin and a sequence having at least 70% sequence identity to SEQ ID NO. 1, or any of the fragments soluble Sortilin, pro-Sortilin and mature Sortilin and a sequence having at least 75% sequence identity to SEQ ID NO. 1, or any of the fragments soluble Sortilin, pro-Sortilin and mature Sortilin and a sequence having at least 80% sequence identity to SEQ ID NO. 1, or any of the fragments soluble Sortilin, pro-Sortilin and mature Sortilin and a sequence having at least 85% sequence identity to SEQ ID NO. 1, or any of the fragments soluble Sortilin, pro-Sortilin and mature Sortilin a sequence having at least 90% sequence identity to SEQ ID NO. 1, or any of the fragments soluble Sortilin, pro-Sortilin and mature Sortilin a sequence having at least 95% sequence identity to SEQ ID NO. 1, or any of the fragments soluble Sortilin, pro-Sortilin and mature Sortilin and a sequence having at least 99% sequence identity to SEQ ID NO. 1, or any of the fragments soluble Sortilin, pro-Sortilin and mature Sortilin.

In yet another embodiment of the present invention the at least one antagonist as defined herein above is bound to at least one amino acid residue of the binding site comprising amino acid residues L572, L114, V112, R109 to S111, S115 to G118, T570, G571, W586 and W597 of SEQ ID NO. 1 (Sortilin) or a fragment or variant thereof wherein the fragment is selected from, but not limited to the group comprising soluble Sortilin, pro-Sortilin and mature Sortilin and the variant is selected from, but not limited to the group comprising a sequence having at least 60% sequence identity to SEQ ID NO. 1, or any of the fragments soluble Sortilin, pro-Sortilin and mature Sortilin and a sequence having at least 65% sequence identity to SEQ ID NO. 1, or any of the fragments soluble Sortilin, pro-Sortilin and mature Sortilin and a sequence having at least 70% sequence identity to SEQ ID NO. 1, or any of the fragments soluble Sortilin, pro-Sortilin and mature Sortilin and a sequence having at least 75% sequence identity to SEQ ID NO. 1, or any of the fragments soluble Sortilin, pro-Sortilin and mature Sortilin and a sequence having at least 80% sequence identity to SEQ ID NO. 1, or any of the fragments soluble Sortilin, pro-Sortilin and mature Sortilin and a sequence having at least 85% sequence identity to SEQ ID NO. 1, or any of the fragments soluble Sortilin, pro-Sortilin and mature Sortilin a sequence having at least 90% sequence identity to SEQ ID NO. 1, or any of the fragments soluble Sortilin, pro-Sortilin and mature Sortilin a sequence having at least 95% sequence identity to SEQ ID NO. 1, or any of the fragments soluble Sortilin, pro-Sortilin and mature Sortilin and a sequence having at least 99% sequence identity to SEQ ID NO. 1, or any of the fragments soluble Sortilin, pro-Sortilin and mature Sortilin.

In yet another embodiment of the present invention the at least one antagonist as defined herein above is bound to at least one amino acid residue of the binding site comprising amino acid residues L572, L114 and V112 of SEQ ID NO. 1 (Sortilin) or a fragment or variant thereof wherein the fragment is selected from, but not limited to the group comprising soluble Sortilin, pro-Sortilin and mature Sortilin and the variant is selected from, but not limited to the group comprising a sequence having at least 60% sequence identity to SEQ ID NO. 1, or any of the fragments soluble Sortilin, pro-Sortilin and mature Sortilin and a sequence having at least 65% sequence identity to SEQ ID NO. 1, or any of the fragments soluble Sortilin, pro-Sortilin and mature Sortilin and a sequence having at least 70% sequence identity to SEQ ID NO. 1, or any of the fragments soluble Sortilin, pro-Sortilin and mature Sortilin and a sequence having at least 75% sequence identity to SEQ ID NO. 1, or any of the fragments soluble Sortilin, pro-Sortilin and mature Sortilin and a sequence having at least 80% sequence identity to SEQ ID NO. 1, or any of the fragments soluble Sortilin, pro-Sortilin and mature Sortilin and a sequence having at least 85% sequence identity to SEQ ID NO. 1, or any of the fragments soluble Sortilin, pro-Sortilin and mature Sortilin a sequence having at least 90% sequence identity to SEQ ID NO. 1, or any of the fragments soluble Sortilin, pro-Sortilin and mature Sortilin a sequence having at least 95% sequence identity to SEQ ID NO. 1, or any of the fragments soluble Sortilin, pro-Sortilin and mature Sortilin and a sequence having at least 99% sequence identity to SEQ ID NO. 1, or any of the fragments soluble Sortilin, pro-Sortilin and mature Sortilin.

In an important embodiment of the present invention the at least one antagonist as defined herein above is bound to at least one amino acid residue of the binding site comprising amino acid residues D403, S420, D422, N423, S424, I425, Q426, E444, T451, Y466, E470, I498, S499 and V500 of SEQ ID NO. 1 (Sortilin) or a fragment or variant thereof wherein the fragment is selected from, but not limited to the group comprising soluble Sortilin, pro-Sortilin and mature Sortilin and the variant is selected from, but not limited to the group comprising a sequence having at least 60% sequence identity to SEQ ID NO. 1, or any of the fragments soluble Sortilin, pro-Sortilin and mature Sortilin and a sequence having at least 65% sequence identity to SEQ ID NO. 1, or any of the fragments soluble Sortilin, pro-Sortilin and mature Sortilin and a sequence having at least 70% sequence identity to SEQ ID NO. 1, or any of the fragments soluble Sortilin, pro-Sortilin and mature Sortilin and a sequence having at least 75% sequence identity to SEQ ID NO. 1, or any of the fragments soluble Sortilin, pro-Sortilin and mature Sortilin and a sequence having at least 80% sequence identity to SEQ ID NO. 1, or any of the fragments soluble Sortilin, pro-Sortilin and mature Sortilin and a sequence having at least 85% sequence identity to SEQ ID NO. 1, or any of the fragments soluble Sortilin, pro-Sortilin and mature Sortilin a sequence having at least 90% sequence identity to SEQ ID NO. 1, or any of the fragments soluble Sortilin, pro-Sortilin and mature Sortilin a sequence having at least 95% sequence identity to SEQ ID NO. 1, or any of the fragments soluble Sortilin, pro-Sortilin and mature Sortilin and a sequence having at least 99% sequence identity to SEQ ID NO. 1, or any of the fragments soluble Sortilin, pro-Sortilin and mature Sortilin.

In a preferred embodiment of the present invention the at least one antagonist as defined herein above is bound to at least one amino acid residue of the binding site comprising amino acid residues D403, N423, S424, I425, E444, T451, Y466, I498 and V500 of SEQ ID NO. 1 (Sortilin) or a fragment or variant thereof wherein the fragment is selected from, but not limited to the group comprising soluble Sortilin, pro-Sortilin and mature Sortilin and the variant is selected from, but not limited to the group comprising a sequence having at least 60% sequence identity to SEQ ID NO. 1, or any of the fragments soluble Sortilin, pro-Sortilin and mature Sortilin and a sequence having at least 65% sequence identity to SEQ ID NO. 1, or any of the fragments soluble Sortilin, pro-Sortilin and mature Sortilin and a sequence having at least 70% sequence identity to SEQ ID NO. 1, or any of the fragments soluble Sortilin, pro-Sortilin and mature Sortilin and a sequence having at least 75% sequence identity to SEQ ID NO. 1, or any of the fragments soluble Sortilin, pro-Sortilin and mature Sortilin and a sequence having at least 80% sequence identity to SEQ ID NO. 1, or any of the fragments soluble Sortilin, pro-Sortilin and mature Sortilin and a sequence having at least 85% sequence identity to SEQ ID NO. 1, or any of the fragments soluble Sortilin, pro-Sortilin and mature Sortilin a sequence having at least 90% sequence identity to SEQ ID NO. 1, or any of the fragments soluble Sortilin, pro-Sortilin and mature Sortilin a sequence having at least 95% sequence identity to SEQ ID NO. 1, or any of the fragments soluble Sortilin, pro-Sortilin and mature Sortilin and a sequence having at least 99% sequence identity to SEQ ID NO. 1, or any of the fragments soluble Sortilin, pro-Sortilin and mature Sortilin.

In a highly preferred embodiment of the present invention the at least one antagonist as defined herein above is bound to at least one amino acid residue of the binding site comprising amino acid residues E444, T451, Y466, I498 and V500 of SEQ ID NO. 1 (Sortilin) or a fragment or variant thereof wherein the fragment is selected from, but not limited to the group comprising soluble Sortilin, pro-Sortilin and mature Sortilin and the variant is selected from, but not limited to the group comprising a sequence having at least 60% sequence identity to SEQ ID NO. 1, or any of the fragments soluble Sortilin, pro-Sortilin and mature Sortilin and a sequence having at least 65% sequence identity to SEQ ID NO. 1, or any of the fragments soluble Sortilin, pro-Sortilin and mature Sortilin and a sequence having at least 70% sequence identity to SEQ ID NO. 1, or any of the fragments soluble Sortilin, pro-Sortilin and mature Sortilin and a sequence having at least 75% sequence identity to SEQ ID NO. 1, or any of the fragments soluble Sortilin, pro-Sortilin and mature Sortilin and a sequence having at least 80% sequence identity to SEQ ID NO. 1, or any of the fragments soluble Sortilin, pro-Sortilin and mature Sortilin and a sequence having at least 85% sequence identity to SEQ ID NO. 1, or any of the fragments soluble Sortilin, pro-Sortilin and mature Sortilin a sequence having at least 90% sequence identity to SEQ ID NO. 1, or any of the fragments soluble Sortilin, pro-Sortilin and mature Sortilin a sequence having at least 95% sequence identity to SEQ ID NO. 1, or any of the fragments soluble Sortilin, pro-Sortilin and mature Sortilin and a sequence having at least 99% sequence identity to SEQ ID NO. 1, or any of the fragments soluble Sortilin, pro-Sortilin and mature Sortilin.

The antagonist which in this sense is synonymous with an inhibitor to the Vps10p-domain receptor is selected from but not limited to the group comprising proteins, peptides, polypeptides, antibodies, antisense RNA, antisense-DNA, small organic molecules and siRNA.

Antibodies Against Vps10p-Domain Receptor

An antibody binds tightly to a particular target molecule, thereby either inactivating it directly or marking it for destruction. The antibody recognizes its target (antigen) with remarkable specificity and strength dictated by the sum of many chemical forces, including hydrogen bonds, hydrophobic and van der Waal's forces, as well as ionic interactions. In general, the more complex the target is chemically, the more immunogenic it will be. The antigenic determinant may encompass short linear amino acid stretches or a more complicated, three-dimensional protein module.

Conceptually, antibodies directed against a target receptor may inhibit ligand binding in two ways: competitive or allosteric. Competitive inhibition involves the direct binding of the antibody to or near the ligand binding site on the receptor, thereby displacing the ligand from its receptor or sterically inhibiting the approach of the ligand to the ligand binding site. Allosteric inhibition involves the binding of the antibody to a site on the receptor polypeptide that is distinct from the ligand binding epitope. However, binding to this site will induce a conformational change in the overall structure of the receptor that makes it more difficult or even impossible for the ligand to bind to its cognate recognition site.

The inventors of this application have raised antibodies against several parts of the Vps10p-domain receptors. The present invention is directed to antibodies against the unifying feature of this receptor family-the Vps10p domain. The below sequence alignment of the Vps10p-domain demonstrate the conservation within this receptor family.

TABLE 2
Antibodies against Vps10p-domain receptors

| Receptor | Name | Antigen | Species | Western | IH/IC | Ref. |
|---|---|---|---|---|---|---|
| SorLA | SORLA goat | extracellular domain | goat | X | X | Schmidt et. al., J. Biol. Chem. 282: 32956-67, 2007 |
| | Hale SORLA | Cytoplasmic domain | rabbit | X | | |
| | SORLA LA | Complement type repeat | rabbit | X | | |
| | Sol SORLA | extracellular domain | rabbit | X | X | Andersen et al., PNAS 103: 13461-6, 2005 |
| | SORLA tail | Cytoplasmic domain | rabbit | X | | |
| | SORLA VPS | VPS10p domain | rabbit | X | | |
| | #606870 | Peptide seq. in Vps10p- | rabbit | X | | |
| | | domain | | | | |
| | #642739 | C-terminal | rabbit | X | | |
| | #643739 | Cytoplasmic tail | rabbit | X | | |
| | 20C11 | Extracellular domain | mouse | X | X | |
| | AG4 | Extracellular domain | mouse | X | | |
| Sortilin | #5264 | Extracellular domain | rabbit | X | X | Munck Petersen et al, EMBO J. 18: 595-604, 1999 |
| | #5448 | Cytoplasmic domain | rabbit | X | X | Jansen et al, Nature Neurosci. 10: 1449-1457, 2007 |
| | #5287 | Cytoplasmic domain | rabbit | X | | |
| | CP 96 334 SR 96 | propeptide | Rabbit | X | | Munck Petersen et al, EMBO J. 18: 595-604, 1999 |
| | 204 | | | | | |
| | #5438 | Vps10p | rabbit | X | | |
| | Sortilin goat/ | Extracellular domain | goat | X | | |
| | Laika | | | | | |
| | F9 | Extracellular domain | mouse | X | X | |
| | F11 | Extracellular domain | mouse | X | X | |
| | AF2934 | Extracellular domain | goat | X | X | R&D Systems, Jansen et al, Nature Neurosci. 10: 1449-1457, |
| | | | | | | 2007 |
| | AF3154 | Extracellular domain | goat | X | X | R&D Systems; Jansen et al, Nature Neurosci. 10: 1449-1457, |
| | | | | | | 2007 |
| | anti-NTR3 | Extracellular domain | mouse | X | X | BD Transduction Laboratories, |
| | ANT-009 | Extracellular domain | mouse | X | X | Alomone Labs; Nykjaer et al, Nature427: 843-848, 2004 |
| SorCS1 | AF3457 | Extracellular domain | goat | X | X | BD Transduction Laboratories |
| | SorCS1 goat | Extracellular domain | goat | X | | |
| | L-SorCS1 | Extracellular domain | rabbit | X | X | Hermey et al, J. Biol. Chem. 279: 50221-50229, 2003 |
| | Leu-SorCS1 | Leucine-rich domain | rabbit | X | X | Hermey et al, J. Biol. Chem. 279: 50221-50229, 2003 |
| | #5466 | Extracellular domain | rabbit | X | X | |
| | 1D | Extracellular domain | mouse | X | | |
| | 4H | Extracellular domain | mouse | X | | |
| | 6B | Extracellular domain | mouse | X | | |
| | 4A | Extracellular domain | mouse | X | | |
| SorCS2 | AF4237 | Extracellular domain | sheep | X | | BD Transduction Laboratories |
| | SorCS2 goat | Extracellular domain | goat | X | X | |
| | #5422 | Extracellular domain | rabbit | X | X | Hermey et al, Biochem. J., 395: 285-93, 2006 |
| | #5431 | 28 C-terminal amino | rabbit | X | X | |
| | | acids | | | | |
| | SorCS2-prp | propeptide | rabbit | X | | Schousboe Sjoegaard, Dissertation, Aarhus University, 2005 |
| | M1 | Extracellular domain | mouse | | X | Roland Holst, Master of Science Thesis, Aarhus University, |
| | | | | | | 2006 |
| | M3 | Extracellular domain | mouse | | X | Roland Holst, Master of Science Thesis, Aarhus University, |
| | | | | | | 2006 |
| | M4 | Extracellular domain | mouse | | X | Roland Holst, Master of Science Thesis, Aarhus University, |
| | | | | | | 2006 |
| | M7 | Extracellular domain | mouse | | X | Roland Holst, Master of Science Thesis, Aarhus University, |
| | | | | | | 2006 |
| | M9 | Extracellular domain | mouse | | X | Roland Holst, Master of Science Thesis, Aarhus University, |
| | | | | | | 2006 |
| | M10 | Extracellular domain | mouse | | X | Roland Holst, Master of Science Thesis, Aarhus University, |
| | | | | | | 2006 |
| | M13 | Extracellular domain | mouse | X | | Roland Holst, Master of Science Thesis, Aarhus University, |
| | | | | | | 2006 |
| | M15 | Extracellular domain | mouse | | X | Roland Holst, Master of Science Thesis, Aarhus University, |
| | | | | | | 2006 |
| | M18 | Extracellular domain | mouse | X | X | Roland Holst, Master of Science Thesis, Aarhus University, |
| | | | | | | 2006 |
| | M19 | Extracellular domain | mouse | X | X | Roland Holst, Master of Science Thesis, Aarhus University, |
| | | | | | | 2006 |
| | S21 | Extracellular domain | mouse | X | | Roland Holst, Master of Science Thesis, Aarhus University, |
| | | | | | | 2006 |
| | SorCS2-GST- | Extracellular domain | rabbit | X | | |
| | 73aa | | | | | |
| | SorCS2-GST- | Extracellular domain | rabbit | X | | |
| | 100aa | | | | | |
| | SorCS2-GST- | Extracellular domain | rabbit | X | | |
| | 172aa | | | | | |
| SorCS3 | SorCS3-N | extracellular domain | rabbit | X | | |
| | SorCS3-C | 15 C-terminal aa | rabbit | X | | |
| | Sort3 N Term | N-terminal domain | rabbit | X | X | Westergaard et al, FEBS Lett. 579: 1172-6, 2005 |
| | #5389 | | | | | |
| | #5432 | Extracellular domain | rabbit | X | X | |
| | MAB3067 | Extracellular domain | mouse | X | | BD Transduction Laboratories |
| | MAB30671 | Extracellular domain | mouse | X | | BD Transduction Laboratories |
| | AF3326 | Extracellular domain | goat | X | | BD Transduction Laboratories |
| | SorCS3 goat | Extracellular domain | goat | X | | |

Generic Use of an Antibody to Inhibit Binding of a Ligand

An antibody binds tightly to a particular target molecule, thereby either inactivating it directly or marking it for destruction. The antibody recognizes its target (antigen) with remarkable specificity and strength dictated by the sum of many chemical forces, including hydrogen bonds, hydrophobic and van der Waal's forces, as well as ionic interactions. In general, the more complex the target is chemically, the more immunogenic it will be. The antigenic determinant may encompass short linear amino acid stretches or a more complicated, three-dimensional protein module.

Procedures for Making Antibodies

Polyclonal and monoclonal antibodies directed against a specific antigen, or epitope of an antigen, can be produced according to standard procedures (see e.g. Antibodies—A laboratory Manual by Ed Harlow and David Lane, Cold Spring Harbor Laboratory 1998, ISBN 0-87969-314-2). The procedure for subsequent generation of humanized antibodies or fragments thereof has also been described (e.g. A. M. Scott et al, Cancer Research 60:3254-3261, 2000; A. Nissim and Y. Chernajovsky, Handb. Exp. Pharmacol. 181:3-18, 2008; A. Mountain and J. R. Adair, Biotechnol. Genet. Eng. Rev. 10:1-142, 1992).

General Expectations of Success in Making Antibodies

It is possible to generate antibodies against any peptide motif of choice using short synthetic oligopeptides that encompass the desired target epitope. Therefore, it is guaranteed that antibodies against ligand binding sites on receptors can be generated. Whether or not individual antibody species have the potential to inhibit ligand binding simply depends on the fact that the affinity of the immunoglobulin for the receptor exceeds that of the ligand. In the end, it is a matter of screening the inhibitory potential of a number of individual antibodies to find one with the desired properties.

Screening assays for inhibitory antibodies are common knowledge and typically involve a competitive enzyme linked immunosorbent assay (ELISA). In detail, the recombinant receptor or a fragment encompassing its ligand binding motif are immobilized in replicate wells of microtiter plates. Subsequently, the wells are incubated with a solution containing the ligand. Binding of the ligand to the immobilized receptor is confirmed using an antibody that recognizes the ligand and that is coupled with a color dye reaction. Binding of the ligand to the receptor is tested in the presence of various antibodies to identify those immunoglobulin species that block ligand binding to the receptor and hence prevent color reaction in the respective microtiter plate well.

Successful Clinical Use of Antibodies

A number of therapeutic antibodies are in clinical use. Examples include Genentech's Rituxan, an antibody directed against the CD20 receptor (used in rheumatoid arthritis), Johnson & Johnson's Remicade, an antibody directed against TNF alpha receptor (in Psoriasis), Roche's Avastin, an anti-VEGF antibody used for treatment of colorectal and lung cancer, as well as Herceptin, an antibody against the receptor HRE2 used in breast cancer therapy.

Assessing binding to a receptor is routine work for the person skilled in the biotechnical field. In this regard it has to be mentioned that pro-neurotrophins as well as the Vps10p-domain receptor family were known at the priority date of this invention and binding assays involving for example pro-neurotrophins has been mentioned in the prior art, for example in the article by Lee et al (2001) Science 294:1945-1948.

Accordingly, in an important embodiment the antagonist of the present invention is an antibody.

In a further embodiment the antibody is directed against an extracellular part of the Vps10p-domain receptor.

In a further embodiment the antibody is directed against an intracellular part of the Vps10p-domain receptor.

In a further embodiment the antibody is directed against an a transmembrane part of the Vps10p-domain receptor.

In one embodiment of the present invention the antibody as defined herein above is selected from the group consisting of: polyclonal antibodies, monoclonal antibodies, humanised antibodies, single chain antibodies, recombinant antibodies.

In another aspect, the invention relate to the use of at least one antagonist capable of binding to at least one amino acid residue of a Vps10p-domain receptor agonist selected from the group consisting of SEQ ID NOs. 6, 7, 8, 9, 10, 14 or 15 or a fragment or variant thereof, in the manufacture of a medicament, for the treatment and/or prevention of abnormal plasma lipid concentrations in an animal.

In aspect the present invention relates to an immunoconjugate comprising the antibody as defined herein above and a conjugate selected from the group consisting of: a cytotoxic agent such as a chemotherapeutic agent, a toxin, or a radioactive isotope; a member of a specific binding pair, such as avidin or streptavidin or an antigen.

Methods of Screening for Antagonists/Inhibitors of Vps10p-Domain Receptors

The present invention also relate to in vitro and in vivo methods of identifying an antagonist of a Vps10p-domain receptor, said antagonist being capable of binding to said Vps10p-domain receptor and thus inhibit binding of an endogenous agonist to said receptor, consequently preventing/inhibiting a physiological response associated with regulation of blood plasma lipid concentrations.

Accordingly, in one aspect, the invention concerns an in vitro method for screening for an antagonist capable of binding to a Vps10p-domain receptor, comprising the steps of:

a) providing a Vps10p-domain receptor, and

b) providing an agonist,

c) providing a library of potential antagonists, and

d) providing an assay for measuring the binding of an agonist to a Vps10p-domain receptor, and

e) adding the library of potential antagonists to be tested to the assay, and

f) determining the amount of agonist bound to the Vps10p-domain receptor, and

g) comparing the amount determined in step f) with an amount measured in the absence of the antagonist to be tested,

h) wherein the difference in the two amounts identifies an antagonist which alters the binding of the agonist to the Vps10p-domain receptor.

In yet another aspect the present invention relates to a method for determining the degree of inhibition of an antagonist on activity of a Vps10p-domain receptor in a cell culture expressing said receptor, wherein said Vps10p-domain receptor comprises an amino acid sequence having at least 60% sequence identity to SEQ ID NO. 1, SEQ ID NO. 2, SEQ ID NO. 3, SEQ ID NO. 4 or SEQ ID NO. 5, said method comprising the steps of:

a) providing a cell culture expressing a Vps10p-domain receptor, and

b) providing an agonist of the Vps10p-domain receptor, and

c) providing a library of potential antagonists, and

d) providing an assay for determination of binding to, internalisation of and signalling through, a Vps10p-domain receptor, said assay comprising

e) adding the library of potential antagonists to be tested c) to the cell culture a), in the presence of the agonist b), and

f) determining
i) the amount of antagonist bound to the Vps10p-domain receptor, and/or
ii) the amount of antagonist internalised by the Vps10p-domain receptor, and/or
iii) the degree of signalling through the Vps10p-domain receptor, and

g) comparing the amount determined in step f) with an amount measured in the absence of the antagonist to be tested,

h) wherein the difference in the two amounts identifies an antagonist
i) capable of binding to a Vps10p-domain receptor, and/or
ii) capable of inhibiting signalling through a Vps10p-domain receptor, and/or
iii) capable of inhibiting internalisation of an agonist of said Vps10p-domain receptor.

In a further aspect the present invention relates to a method for determining the degree of inhibition of an antagonist on activity of a Vps10p-domain receptor in a cell culture expressing said receptor and with the a cell culture lacking expression of said receptor, said method comprising the steps of:

a) providing a cell culture expressing a Vps10p-domain receptor, and

b) providing a cell culture not expressing a Vps10p-domain receptor, and

c) optionally providing a cell culture overexpressing a Vps10p-domain receptor

d) providing an agonist of the Vps10p-domain receptor, and

e) providing a library of potential antagonists, and

f) providing a first assay comprising a) and a second assay comprising b) and optionally a third assay comprising c), and

g) adding the library of potential antagonists to be tested to the three assays, and

h) determining
i) the amount of antagonist bound to the Vps10p-domain receptor, and/or
ii) the amount of antagonist internalised by the Vps10p-domain receptor, and/or
iii) the degree of signalling through the Vps10p-domain receptor, and

i) comparing the amount of antagonist determined in step g) using a) with the amount determined in g) using b) and the amount determined in g) using c),
j) wherein the difference in the amounts identifies an antagonist
i) capable of binding to a Vps10p-domain receptor, and/or
ii) capable of inhibiting signalling through a Vps10p-domain receptor, and/or
iii) capable of inhibiting internalisation of an agonist of said Vps10p-domain receptor.

In a further embodiment the agonist as defined herein above is selected from the group consisting of SEQ ID NO. 6 (proNGF), SEQ ID NO. 7 (proBDNF), SEQ ID NO. 8 (proNT3), SEQ ID NO. 9 (pro-NT4/5), SEQ ID NO. 14 (ApoE) or SEQ ID NO. 15 (LpL) or a fragment or variant thereof.

In a further aspect the present invention relates to a method for determining the degree of inhibition of an antagonist on activity of a Vps10p-domain receptor in a mammal expressing said receptor, said method comprising the steps of:

a) administering said antagonist to a mammal naturally expressing the receptor,

b) determining
i) the amount of antagonist bound to the Vps10p-domain receptor, and/or
ii) the amount of antagonist internalised by the Vps10p-domain receptor, and/or
iii) the degree of signalling through the Vps10p-domain receptor, and

c) comparing the measurement of step b) with a measurement obtained in the absence of the compound to be tested,

d) wherein the difference in the two measurements identifies the effect of said antagonist on said mammal naturally expressing the receptor.

In yet another aspect the present invention relate to a method for determining the degree of inhibition of an antagonist on activity of a Vps10p-domain receptor in a mammal expressing said receptor with a second mammal, lacking expression of said receptor and a third mammal overexpressing said receptor, said method comprising the steps of:

a) providing a mammal expressing a Vps10p-domain receptor, and

b) providing a mammal not expressing a Vps10p-domain receptor, and

c) providing a mammal overexpressing a Vps10p-domain receptor, and

d) providing an agonist of the Vps10p-domain receptor, and

e) providing a library of potential antagonists, and

f) administering said library of antagonists to said mammal of a), b) and c) respectively, and

g) determining
i) the amount of antagonist bound to the Vps10p-domain receptor, and/or
ii) the amount of antagonist internalised by the Vps10p-domain receptor, and/or
iii) the degree of signalling through the Vps10p-domain receptor, in each of the mammals defined in a), b) and c), and

h) comparing the amount of antagonist determined in step g) using a) with the amount determined in g) using b) with the amount determined in g) using c),

i) wherein the difference in the amounts identifies an antagonist
i) capable of binding to a Vps10p-domain receptor, and/or
ii) capable of inhibiting signalling through a Vps10p-domain receptor, and/or
iii) capable of inhibiting internalisation of an agonist of said Vps10p-domain receptor.

Pharmaceutical Composition

In a further aspect the present invention relates to a pharmaceutical composition comprising the antagonist of claim 1, said antagonist selected from the group consisting of small organic compounds, oligo-peptides, proteins and monoclonal or polyclonal antibodies.

The pharmaceutical composition according to claim 36 wherein said antagonist is an antagonist of a Vps10p-domain as defined in claim 2.

In a further embodiment the pharmaceutical composition as defined herein above comprises a pharmaceutically acceptable carrier.

In a further embodiment the pharmaceutical composition as defined herein above comprises a second active ingredient selected from but not limited to the group consisting of analgesics, opiods, adrenergic antagonists, antihypertensives and compounds capable of modulating plasma lipid concentrations.

In an important embodiment the compound capable of modulating plasma lipid concentrations is a statin selected from the group consisting of Atorvastatin, Cerivastatin, Fluvastatin, Lovastatin, Mevastatin, Pitavastatin, Pravastatin, Rosuvastatin, Simvastatin, Simvastatin/Ezetimibe combination, Lovastatin/Niacin combination and Atorvastatin/Amlodipine Besylate Caduet combination.

In a further embodiment the pH of the pharmaceutical composition defined herein above is between pH 5 and pH 9.

In an important aspecty the present invention relate to the use of the pharmaceutical composition described herein above for the preparation of a medicament for the treatment or prevention of a disease or disorder associated with abnormal plasma lipid concentrations.

Method of Treatment

In one aspect the present invention relates to a method of treatment of a pathological condition of the cardiovascular system associated with abnormal plasma lipid concentrations in a subject comprising administering to an individual in need thereof a therapeutically effective amount of the pharmaceutical composition defined herein above.

In one embodiment of the present invention the abnormal plasma lipid concentration as defined herein above is abnormal concentrations of LDL-cholesterol

In a further embodiment of the present invention the abnormal plasma lipid concentration as defined herein above is abnormal concentrations of triglycerides.

Kit of Parts

In one aspect the present invention relates to a kit in parts comprising:
a pharmaceutical composition as defined herein above,
a medical instrument or other means for administering the medicament,
instructions on how to use the kit in parts.

In one embodiment the kit in parts as defined herein above comprises a second active ingredient.

In a further aspect the present invention relates to the use at least one antagonist wherein said antagonist is capable of inhibiting expression of a Vps10p-domain receptor in an animal.

Administration Forms

The main routes of drug delivery, in the treatment method are intravenous, oral, and topical. Other drug-administration methods, such as subcutaneous injection or via inhalation, which are effective to deliver the drug to a target site or to introduce the drug into the bloodstream, are also contemplated.

The mucosal membrane to which the pharmaceutical preparation of the invention is administered may be any mucosal membrane of the mammal to which the biologically active substance is to be given, e.g. in the nose, vagina, eye, mouth, genital tract, lungs, gastrointestinal tract, or rectum, preferably the mucosa of the nose, mouth or vagina.

Compounds of the invention may be administered parenterally, that is by intravenous, intramuscular, subcutaneous intranasal, intrarectal, intravaginal or intraperitoveal administration. The subcutaneous and intramuscular forms of parenteral administration are generally preferred. Appropriate dosage forms for such administration may be prepared by conventional techniques. The compounds may also be administered by inhalation, which is by intranasal and oral inhalation administration. Appropriate dosage forms for such administration, such as an aerosol formulation or a metered dose inhaler, may be prepared by conventional techniques.

The compounds according to the invention may be administered with at least one other compound. The compounds may be administered simultaneously, either as separate formulations or combined in a unit dosage form, or administered sequentially.

Formulations

Whilst it is possible for the compounds or salts of the present invention to be administered as the raw chemical, it is preferred to present them in the form of a pharmaceutical formulation. Accordingly, the present invention further provides a pharmaceutical formulation, for medicinal application, which comprises a compound of the present invention or a pharmaceutically acceptable salt thereof, as herein defined, and a pharmaceutically acceptable carrier therefore.

The compounds of the present invention may be formulated in a wide variety of oral administration dosage forms. The pharmaceutical compositions and dosage forms may comprise the compounds of the invention or its pharmaceutically acceptable salt or a crystal form thereof as the active component. The pharmaceutically acceptable carriers can be either solid or liquid. Solid form preparations include powders, tablets, pills, capsules, cachets, suppositories, and dispersible granules. A solid carrier can be one or more substances which may also act as diluents, flavoring agents, solubilizers, lubricants, suspending agents, binders, preservatives, wetting agents, tablet disintegrating agents, or an encapsulating material.

Preferably, the composition will be about 0.5% to 75% by weight of a compound or compounds of the invention, with the remainder consisting of suitable pharmaceutical excipients. For oral administration, such excipients include pharmaceutical grades of mannitol, lactose, starch, magnesium stearate, sodium saccharine, talcum, cellulose, glucose, gelatin, sucrose, magnesium carbonate, and the like.

In powders, the carrier is a finely divided solid which is a mixture with the finely divided active component. In tablets, the active component is mixed with the carrier having the necessary binding capacity in suitable proportions and compacted in the shape and size desired. Powders and tablets preferably contain from one to about seventy percent of the active compound. Suitable carriers are magnesium carbonate, magnesium stearate, talc, sugar, lactose, pectin, dextrin, starch, gelatin, tragacanth, methylcellulose, sodium carboxymethylcellulose, a low melting wax, cocoa butter, and the like. The term “preparation” is intended to include the formulation of the active compound with encapsulating material as carrier providing a capsule in which the active component, with or without carriers, is surrounded by a carrier, which is in association with it. Similarly, cachets and lozenges are included. Tablets, powders, capsules, pills, cachets, and lozenges can be as solid forms suitable for oral administration.

Drops according to the present invention may comprise sterile or non-sterile aqueous or oil solutions or suspensions, and may be prepared by dissolving the active ingredient in a suitable aqueous solution, optionally including a bactericidal and/or fungicidal agent and/or any other suitable preservative, and optionally including a surface active agent. The resulting solution may then be clarified by filtration, transferred to a suitable container which is then sealed and sterilized by autoclaving or maintaining at 98-100° C. for half an hour. Alternatively, the solution may be sterilized by filtration and transferred to the container aseptically. Examples of bactericidal and fungicidal agents suitable for inclusion in the drops are phenylmercuric nitrate or acetate (0.002%), benzalkonium chloride (0.01%) and chlorhexidine acetate (0.01%). Suitable solvents for the preparation of an oily solution include glycerol, diluted alcohol and propylene glycol.

Also included are solid form preparations which are intended to be converted, shortly before use, to liquid form preparations for oral administration. Such liquid forms include solutions, suspensions, and emulsions. These preparations may contain, in addition to the active component, colorants, flavours, stabilizers, buffers, artificial and natural sweeteners, dispersants, thickeners, solubilizing agents, and the like.

Other forms suitable for oral administration include liquid form preparations including emulsions, syrups, elixirs, aqueous solutions, aqueous suspensions, toothpaste, gel dentrifrice, chewing gum, or solid form preparations which are intended to be converted shortly before use to liquid form preparations. Emulsions may be prepared in solutions in aqueous propylene glycol solutions or may contain emulsifying agents such as lecithin, sorbitan monooleate, or acacia. Aqueous solutions can be prepared by dissolving the active component in water and adding suitable colorants, flavours, stabilizing and thickening agents. Aqueous suspensions can be prepared by dispersing the finely divided active component in water with viscous material, such as natural or synthetic gums, resins, methylcellulose, sodium carboxymethylcellulose, and other well known suspending agents. Solid form preparations include solutions, suspensions, and emulsions, and may contain, in addition to the active component, colorants, flavours, stabilizers, buffers, artificial and natural sweeteners, dispersants, thickeners, solubilizing agents, and the like.

The compounds of the present invention may be formulated for parenteral administration (e.g., by injection, for example bolus injection or continuous infusion) and may be presented in unit dose form in ampoules, pre-filled syringes, small volume infusion or in multi-dose containers with an added preservative. The compositions may take such forms as suspensions, solutions, or emulsions in oily or aqueous vehicles, for example solutions in aqueous polyethylene glycol. Examples of oily or nonaqueous carriers, diluents, solvents or vehicles include propylene glycol, polyethylene glycol, vegetable oils (e.g., olive oil), and injectable organic esters (e.g., ethyl oleate), and may contain formulatory agents such as preserving, wetting, emulsifying or suspending, stabilizing and/or dispersing agents. Alternatively, the active ingredient may be in powder form, obtained by aseptic isolation of sterile solid or by lyophilisation from solution for constitution before use with a suitable vehicle, e.g., sterile, pyrogen-free water.

Oils useful in parenteral formulations include petroleum, animal, vegetable, or synthetic oils. Specific examples of oils useful in such formulations include peanut, soybean, sesame, cottonseed, corn, olive, petrolatum, and mineral. Suitable fatty acids for use in parenteral formulations include oleic acid, stearic acid, and isostearic acid. Ethyl oleate and isopropyl myristate are examples of suitable fatty acid esters.

Suitable soaps for use in parenteral formulations include fatty alkali metal, ammonium, and triethanolamine salts, and suitable detergents include (a) cationic detergents such as, for example, dimethyl dialkyl ammonium halides, and alkyl pyridinium halides; (b) anionic detergents such as, for example, alkyl, aryl, and olefin sulfonates, alkyl, olefin, ether, and monoglyceride sulfates, and sulfosuccinates, (c) nonionic detergents such as, for example, fatty amine oxides, fatty acid alkanolamides, and polyoxyethylenepolypropylene copolymers, (d) amphoteric detergents such as, for example, alkyl-.beta.-aminopropionates, and 2-alkylimidazoline quaternary ammonium salts, and (e) mixtures thereof.

The parenteral formulations typically will contain from about 0.5 to about 25% by weight of the active ingredient in solution. Preservatives and buffers may be used. In order to minimize or eliminate irritation at the site of injection, such compositions may contain one or more nonionic surfactants having a hydrophile-lipophile balance (HLB) of from about 12 to about 17. The quantity of surfactant in such formulations will typically range from about 5 to about 15% by weight. Suitable surfactants include polyethylene sorbitan fatty acid esters, such as sorbitan monooleate and the high molecular weight adducts of ethylene oxide with a hydrophobic base, formed by the condensation of propylene oxide with propylene glycol. The parenteral formulations can be presented in unit-dose or multi-dose sealed containers, such as ampules and vials, and can be stored in a freeze-dried (lyophilized) condition requiring only the addition of the sterile liquid excipient, for example, water, for injections, immediately prior to use. Extemporaneous injection solutions and suspensions can be prepared from sterile powders, granules, and tablets of the kind previously described.

The compounds of the invention can also be delivered topically. Regions for topical administration include the skin surface and also mucous membrane tissues of the vagina, rectum, nose, mouth, and throat. Compositions for topical administration via the skin and mucous membranes should not give rise to signs of irritation, such as swelling or redness.

The topical composition may include a pharmaceutically acceptable carrier adapted for topical administration. Thus, the composition may take the form of a suspension, solution, ointment, lotion, sexual lubricant, cream, foam, aerosol, spray, suppository, implant, inhalant, tablet, capsule, dry powder, syrup, balm or lozenge, for example. Methods for preparing such compositions are well known in the pharmaceutical industry.

The compounds of the present invention may be formulated for topical administration to the epidermis as ointments, creams or lotions, or as a transdermal patch. Ointments and creams may, for example, be formulated with an aqueous or oily base with the addition of suitable thickening and/or gelling agents. Lotions may be formulated with an aqueous or oily base and will in general also containing one or more emulsifying agents, stabilizing agents, dispersing agents, suspending agents, thickening agents, or colouring agents. Formulations suitable for topical administration in the mouth include lozenges comprising active agents in a flavoured base, usually sucrose and acacia or tragacanth; pastilles comprising the active ingredient in an inert base such as gelatin and glycerin or sucrose and acacia; and mouthwashes comprising the active ingredient in a suitable liquid carrier.

Creams, ointments or pastes according to the present invention are semi-solid formulations of the active ingredient for external application. They may be made by mixing the active ingredient in finely-divided or powdered form, alone or in solution or suspension in an aqueous or non-aqueous fluid, with the aid of suitable machinery, with a greasy or non-greasy base. The base may comprise hydrocarbons such as hard, soft or liquid paraffin, glycerol, beeswax, a metallic soap; a mucilage; an oil of natural origin such as almond, corn, arachis, castor or olive oil; wool fat or its derivatives or a fatty acid such as steric or oleic acid together with an alcohol such as propylene glycol or a macrogel. The formulation may incorporate any suitable surface active agent such as an anionic, cationic or nonionic surfactant such as a sorbitan ester or a polyoxyethylene derivative thereof. Suspending agents such as natural gums, cellulose derivatives or inorganic materials such as s licaceous silicas, and other ingredients such as lanolin, may also be included.

Lotions according to the present invention include those suitable for application to the skin or eye. An eye lotion may comprise a sterile aqueous solution optionally containing a bactericide and may be prepared by methods similar to those for the preparation of drops. Lotions or liniments for application to the skin may also include an agent to hasten drying and to cool the skin, such as an alcohol or acetone, and/or a moisturizer such as glycerol or an oil such as castor oil or arachis oil.

Transdermal Delivery

The pharmaceutical agent-chemical modifier complexes described herein can be administered transdermally. Transdermal administration typically involves the delivery of a pharmaceutical agent for percutaneous passage of the drug into the systemic circulation of the patient. The skin sites include anatomic regions for transdermally administering the drug and include the forearm, abdomen, chest, back, buttock, mastoidal area, and the like.

Transdermal delivery is accomplished by exposing a source of the complex to a patient's skin for an extended period of time. Transdermal patches have the added advantage of providing controlled delivery of a pharmaceutical agent-chemical modifier complex to the body. See Transdermal Drug Delivery: Developmental Issues and Research Initiatives, Hadgraft and Guy (eds.), Marcel Dekker, Inc., (1989); Controlled Drug Delivery: Fundamentals and Applications, Robinson and Lee (eds.), Marcel Dekker Inc., (1987); and Transdermal Delivery of Drugs, Vols. 1-3, Kydonieus and Berner (eds.), CRC Press, (1987). Such dosage forms can be made by dissolving, dispersing, or otherwise incorporating the pharmaceutical agent-chemical modifier complex in a proper medium, such as an elastomeric matrix material. Absorption enhancers can also be used to increase the flux of the compound across the skin. The rate of such flux can be controlled by either providing a rate-controlling membrane or dispersing the compound in a polymer matrix or gel.

Passive Transdermal Drug Delivery

A variety of types of transdermal patches will find use in the methods described herein. For example, a simple adhesive patch can be prepared from a backing material and an acrylate adhesive. The pharmaceutical agent-chemical modifier complex and any enhancer are formulated into the adhesive casting solution and allowed to mix thoroughly. The solution is cast directly onto the backing material and the casting solvent is evaporated in an oven, leaving an adhesive film. The release liner can be attached to complete the system.

Alternatively, a polyurethane matrix patch can be employed to deliver the pharmaceutical agent-chemical modifier complex. The layers of this patch comprise a backing, a polyurethane drug/enhancer matrix, a membrane, an adhesive, and a release liner. The polyurethane matrix is prepared using a room temperature curing polyurethane prepolymer. Addition of water, alcohol, and complex to the prepolymer results in the formation of a tacky firm elastomer that can be directly cast only the backing material.

A further embodiment of this invention will utilize a hydrogel matrix patch. Typically, the hydrogel matrix will comprise alcohol, water, drug, and several hydrophilic polymers. This hydrogel matrix can be incorporated into a transdermal patch between the backing and the adhesive layer.

The liquid reservoir patch will also find use in the methods described herein. This patch comprises an impermeable or semipermeable, heat sealable backing material, a heat sealable membrane, an acrylate based pressure sensitive skin adhesive, and a siliconized release liner. The backing is heat sealed to the membrane to form a reservoir which can then be filled with a solution of the complex, enhancers, gelling agent, and other excipients.

Foam matrix patches are similar in design and components to the liquid reservoir system, except that the gelled pharmaceutical agent-chemical modifier solution is constrained in a thin foam layer, typically a polyurethane. This foam layer is situated between the backing and the membrane which have been heat sealed at the periphery of the patch.

For passive delivery systems, the rate of release is typically controlled by a membrane placed between the reservoir and the skin, by diffusion from a monolithic device, or by the skin itself serving as a rate-controlling barrier in the delivery system. See U.S. Pat. Nos. 4,816,258; 4,927,408; 4,904,475; 4,588,580, 4,788,062; and the like. The rate of drug delivery will be dependent, in part, upon the nature of the membrane. For example, the rate of drug delivery across membranes within the body is generally higher than across dermal barriers. The rate at which the complex is delivered from the device to the membrane is most advantageously controlled by the use of rate-limiting membranes which are placed between the reservoir and the skin. Assuming that the skin is sufficiently permeable to the complex (i.e., absorption through the skin is greater than the rate of passage through the membrane), the membrane will serve to control the dosage rate experienced by the patient.

Suitable permeable membrane materials may be selected based on the desired degree of permeability, the nature of the complex, and the mechanical considerations related to constructing the device. Exemplary permeable membrane materials include a wide variety of natural and synthetic polymers, such as polydimethylsiloxanes (silicone rubbers), ethylenevinylacetate copolymer (EVA), polyurethanes, polyurethane-polyether copolymers, polyethylenes, polyamides, polyvinylchlorides (PVC), polypropylenes, polycarbonates, polytetrafluoroethylenes (PTFE), cellulosic materials, e.g., cellulose triacetate and cellulose nitrate/acetate, and hydrogels, e.g., 2-hydroxyethylmethacrylate (HEMA).

Other items may be contained in the device, such as other conventional components of therapeutic products, depending upon the desired device characteristics. For example, the compositions according to this invention may also include one or more preservatives or bacteriostatic agents, e.g., methyl hydroxybenzoate, propyl hydroxybenzoate, chlorocresol, benzalkonium chlorides, and the like. These pharmaceutical compositions also can contain other active ingredients such as antimicrobial agents, particularly antibiotics, anesthetics, analgesics, and antipruritic agents.

The compounds of the present invention may be formulated for administration as suppositories. A low melting wax, such as a mixture of fatty acid glycerides or cocoa butter is first melted and the active component is dispersed homogeneously, for example, by stirring. The molten homogeneous mixture is then poured into convenient sized molds, allowed to cool, and to solidify.

The active compound may be formulated into a suppository comprising, for example, about 0.5% to about 50% of a compound of the invention, disposed in a polyethylene glycol (PEG) carrier (e.g., PEG 1000 [96%] and PEG 4000 [4%].

The compounds of the present invention may be formulated for vaginal administration. Pessaries, tampons, creams, gels, pastes, foams or sprays containing in addition to the active ingredient such carriers as are known in the art to be appropriate.

The compounds of the present invention may be formulated for nasal administration. The solutions or suspensions are applied directly to the nasal cavity by conventional means, for example with a dropper, pipette or spray. The formulations may be provided in a single or multidose form. In the latter case of a dropper or pipette this may be achieved by the patient administering an appropriate, predetermined volume of the solution or suspension. In the case of a spray this may be achieved for example by means of a metering atomizing spray pump.

The compounds of the present invention may be formulated for aerosol administration, particularly to the respiratory tract and including intranasal administration. The compound will generally have a small particle size for example of the order of 5 microns or less. Such a particle size may be obtained by means known in the art, for example by micronization. The active ingredient is provided in a pressurized pack with a suitable propellant such as a chlorofluorocarbon (CFC) for example dichlorodifluoromethane, trichlorofluoromethane, or dichlorotetrafluoroethane, carbon dioxide or other suitable gas. The aerosol may conveniently also contain a surfactant such as lecithin. The dose of drug may be controlled by a metered valve. Alternatively the active ingredients may be provided in a form of a dry powder, for example a powder mix of the compound in a suitable powder base such as lactose, starch, starch derivatives such as hydroxypropylmethyl cellulose and polyvinylpyrrolidine (PVP). The powder carrier will form a gel in the nasal cavity. The powder composition may be presented in unit dose form for example in capsules or cartridges of e.g., gelatin or blister packs from which the powder may be administered by means of an inhaler.

When desired, formulations can be prepared with enteric coatings adapted for sustained or controlled release administration of the active ingredient.

The pharmaceutical preparations are preferably in unit dosage forms. In such form, the preparation is subdivided into unit doses containing appropriate quantities of the active component. The unit dosage form can be a packaged preparation, the package containing discrete quantities of preparation, such as packeted tablets, capsules, and powders in vials or ampoules. Also, the unit dosage form can be a capsule, tablet, cachet, or lozenge itself, or it can be the appropriate number of any of these in packaged form.

Pharmaceutically Acceptable Salts

Pharmaceutically acceptable salts of the instant compounds, where they can be prepared, are also intended to be covered by this invention. These salts will be ones which are acceptable in their application to a pharmaceutical use. By that it is meant that the salt will retain the biological activity of the parent compound and the salt will not have untoward or deleterious effects in its application and use in treating diseases.

Pharmaceutically acceptable salts are prepared in a standard manner. If the parent compound is a base it is treated with an excess of an organic or inorganic acid in a suitable solvent. If the parent compound is an acid, it is treated with an inorganic or organic base in a suitable solvent.

The compounds of the invention may be administered in the form of an alkali metal or earth alkali metal salt thereof, concurrently, simultaneously, or together with a pharmaceutically acceptable carrier or diluent, especially and preferably in the form of a pharmaceutical composition thereof, whether by oral, rectal, or parenteral (including subcutaneous) route, in an effective amount.

Examples of pharmaceutically acceptable acid addition salts for use in the present inventive pharmaceutical composition include those derived from mineral acids, such as hydrochloric, hydrobromic, phosphoric, metaphosphoric, nitric and sulfuric acids, and organic acids, such as tartaric, acetic, citric, malic, lactic, fumaric, benzoic, glycolic, gluconic, succinic, p-toluenesulphonic acids, and arylsulphonic, for example.

In one embodiment the pharmaceutical composition as desfined herein above is formulated for administration by injection, suppository, oral administration, sublingual tablet or spray, cutaneous administration, inhalation or for local administration using an implantable biocompatible capsule.

In a further embodiment the injection is intravenous, intramuscular, intraspinal, intraperitoneal, subcutaneous, a bolus or a continuous administration.

In one embodiment the pharmaceutical composition according to the present invention is administered at intervals of 30 minutes to 24 hours.

In a further embodiment the pharmaceutical composition according to the present invention is administered at intervals of 1 to 6 hours.

In a further embodiment the pharmaceutical composition according to the present invention is administered at intervals of 6 to 72 hours.

In another embodiment the pharmaceutical composition comprising the antagonist/inhibitor to the Vps10p-domain receptor according to the present invention is administered at a dosage of between 10 μg to 500 mg per kg body mass.

### BRIEF DESCRIPTION OF THE SEVERAL VIEWS OF THE DRAWINGS

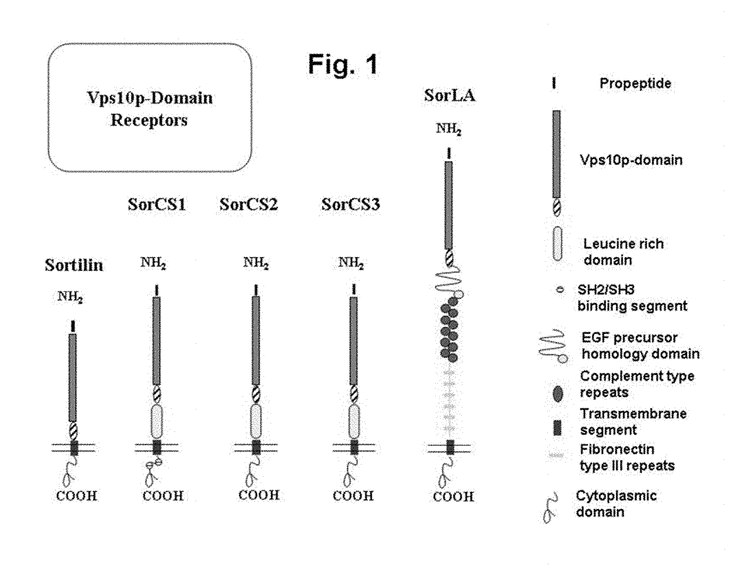

FIG. 1: The Vps10p-domain receptor family. Their structural organization is indicated.

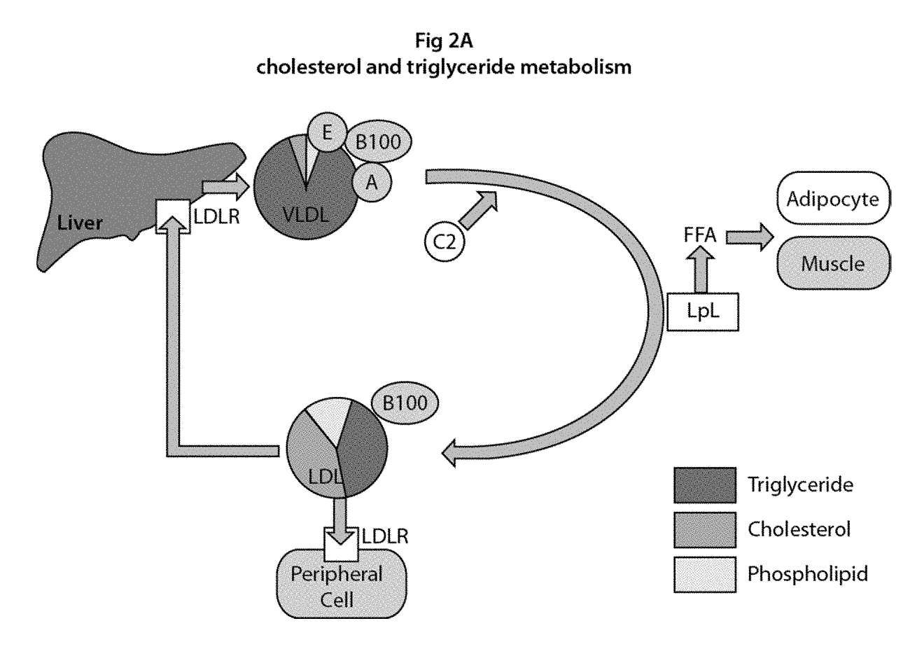

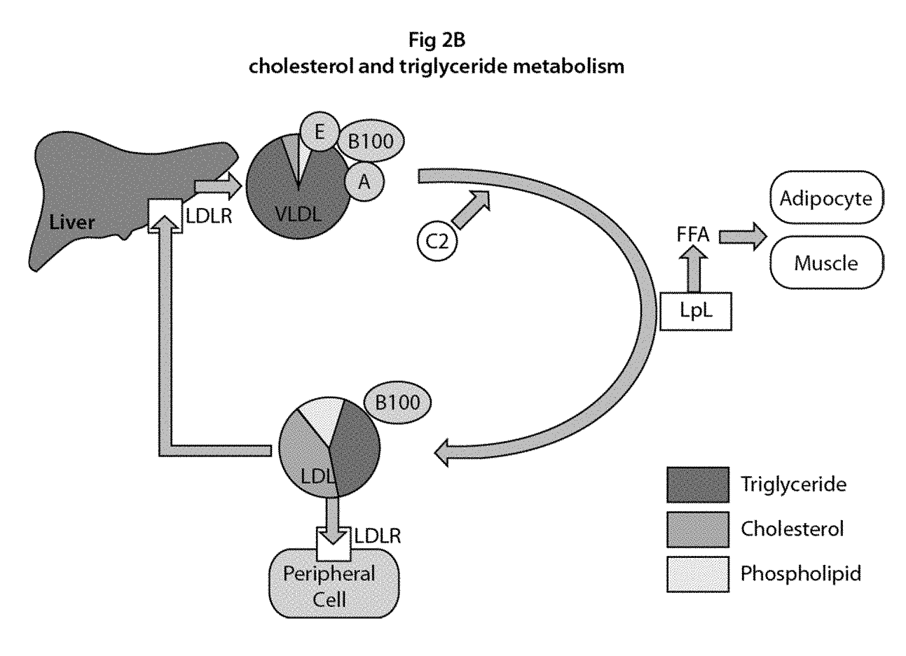

FIG. 2A: Cholesterol and triglyceride metabolism. Chylomicrons (CM) transport dietary triglycerides to tissues where they are removed by the action of lipoprotein lipase (Lpl). Apolipoprotein C2 (C2) activates Lpl. The resultant remnant particles (CMR) are removed by the liver. They bind to remnant receptors which recognize apo E (E), are internalized and catabolized. Apolipoproteins A (A) and B48 (B48) are synthesized in intetinal cells, whereas apoE is acquired from high-density lipoprotein particles (HDL) together with cholesterol. As triglycerides are removed from chylomicrons, apo A, apo C, cholesterol and phopholipids are relased from their surfaces and transferred to HDL where the cholesterol is esterified. Cholesteryl ester is transferred back to the remnant particle in exchange for triglycerides by cholesteryl ester transport protein.

FIG. 2B: Cholesterol and triglyceride metabolism. Very low density lipoprotein particles (VLDL) are synthesized in the liver and transport endogenous triglyceride from the liver to other tissues where it is removed by the action of lipoprotein lipase (Lpl). At the same time, cholesterol, phospholipids and apo C (C2) and apo E (E) are released and transferred to high-density lipoprotein particles (HDL). By this process VLDL are converted IDL (not shown). Some IDL is removed by the liver but most has more triglyceride removed by hepatic lipase and is thereby converted into low-density lipoprotein particles (LDL) (not shown). Thus the triglyceride-rich VLDL particles are precursors of LDL, which comprise mainly cholesterol (cholesteryl esters) and apo B 100. LDL is ultimately removed from the circulation by LDL receptors present in the liver but also in peripheral tissues.

FIG. 3: Plasma cholesterol levels in Sortilin knockout mice. Cholesterol levels were measured in wild-type mice (LDLRxSort; +/+, +/+), mice lacking Sortilin expression (LDLRxSort; +/+, −/−), mice devoid in the low-density liprotein receptor LDLR (LDLRxSort; −/−, +/+), and double knockout mice lacking expression of both receptors (LDLRxSort; −/−,−/−). The animals were fed a western-type diet rich in lipids for 4-6 weeks, fasted overnight and plasma samples were analysed for cholesterol. Sortilin knockout mice exhibit a border significant reduction in plasma cholesterol as compared to control littermates (wild-type) (p=0.06). In LDL receptor deficient mice, a mouse model of familiar hypercholesterolemia, the elevated cholesterol levels were diminished in the absence of Sortilin (LDLRxSort; −/−,−/−) (p=0.02).

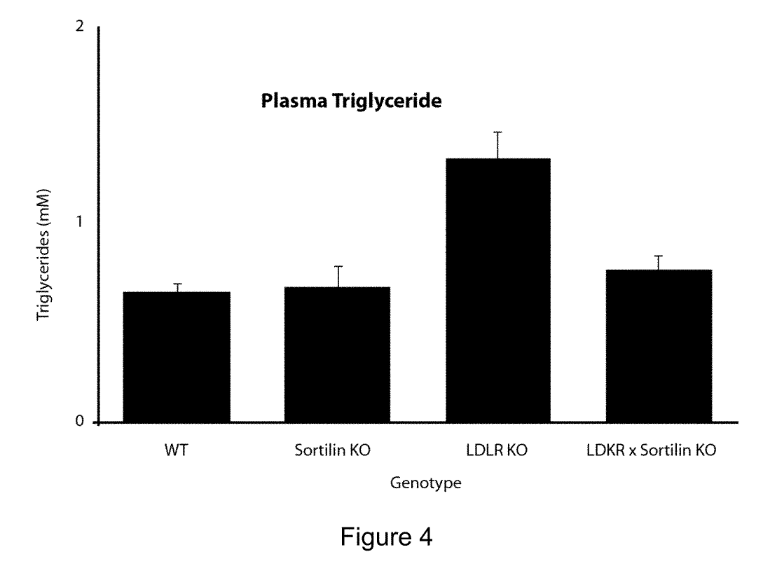

FIG. 4: Plasma triglyceride levels in Sorttilin knockout mice. Triglycerides were measured in wild-type mice (LDLRxSort; +/+, +/+), mice lacking Sortilin expression (LDLRxSort; +/+,−/−), mice devoid in the low-densityl liprotein receptor, LDLR, (LDLRxSort; −/−, +/+), and double knockout mice lacking expression of both receptors (LDLRxSort; −/−, −/−). The animals were fed a western-type diet rich in lipids for 4-6 weeks, fasted overnight and plasma samples were analysed for cholesterol. Sortilin knockout mice showed a moderate increase in plasma triglycerides as compared to control littermates (wild-type). In LDL receptor Sortilin double knockout mice (LDLRxSort; −/−,−/−), triglyceride levels were considerably elevated as compared to mice lacking only LDLR.

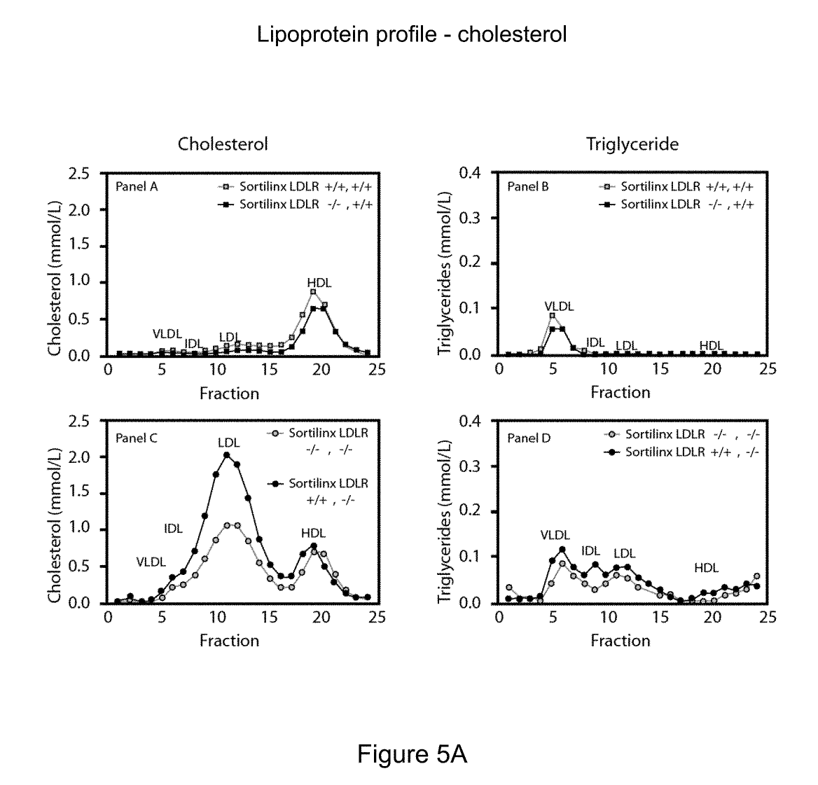

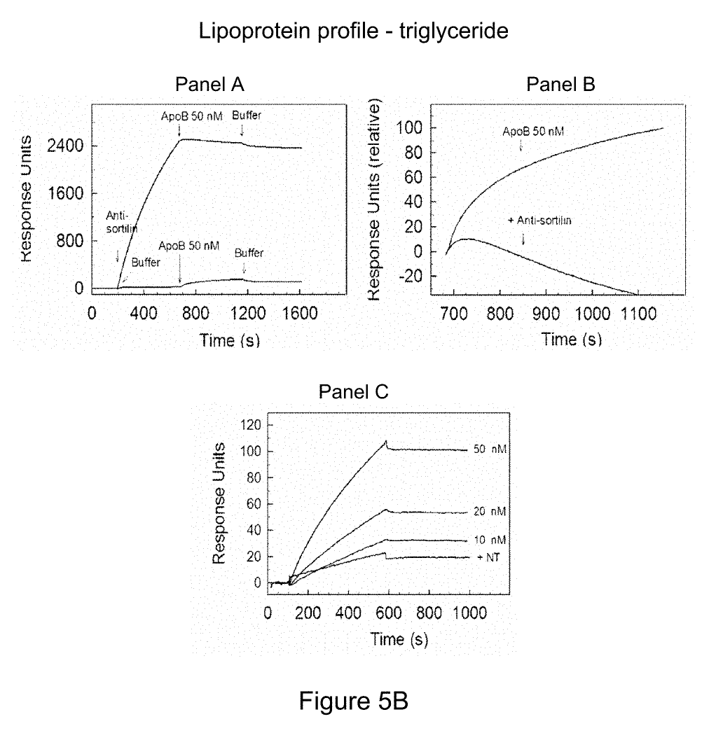

FIG. 5A: Lipoprotein profile—cholesterol (left, Panels A and C) and triglyceride (right, Panels B and D). FPLC profiles of mouse plasma lipoproteins from wild-type mice (LDLRxSort; +/+,+/+) (Panels A and B), and mice lacking Sortilin expression (LDLRxSort; +/+,−/−) (Panels C and D), mice devoid in the low-density liprotein receptor, LDLR, (LDLRxSort; −/−, +/+) (Panels A and B), and double knockout mice lacking expression of both receptors (LDLRxSort; −/−,−/−) (Panels C and D). Mice with the indicated genotypes were fed a Western-type diet for 4-6 weeks and plasma samples were collected from each animal and subjected to gel filtration on FPLC. The cholesterol and triglyceride content in each fraction was subsequently measured. The retention time of the various lipoprotein particles are indicated.

FIG. 5B: Characterization of ApoB binding to recombinant human sortilin (30). Sortilin was immobilized on a BIAcore CM5 sensorchip at a density of 0.078 pmol/mm². Panel A) After baseline calibration in running buffer (10 mM Hepes, 150 mM NaCl, 1 mM EGTA, 1.5 mM CaCl₂, 0.005% P20, pH 7.4) 10 μg/ml rabbit anti-sortilin IgG (12) or running buffer alone was applied to the chip. At t=700 sec the response units obtained in the presence of anti-sortilin IgG was arbitrarily set at 100 and 50 nM ApoB was applied to the flow cell pre-incubated with antibody or with buffer alone. Association of ApoB binding was measured until 1200 sec, after which the solute was changed to buffer to allow dissociation. Panel B) Data extracted from panel A. Binding of ApoB at t=1200 sec to the flow cell following pre-incubation with running buffer alone (=maximum ApoB binding) was set at 100 relative response units. When pre-incubated with the inhibitory anti-sortilin antibody, no ApoB binding was observed. Panel C) Surface plasmon resonance analysis of ApoB (1 0, 20, 50 nM) binding to immobilized sortilin. The on and off rates were recorded, and the Kd value was 0.4 nM for binding to sortilin in the displayed experiment.

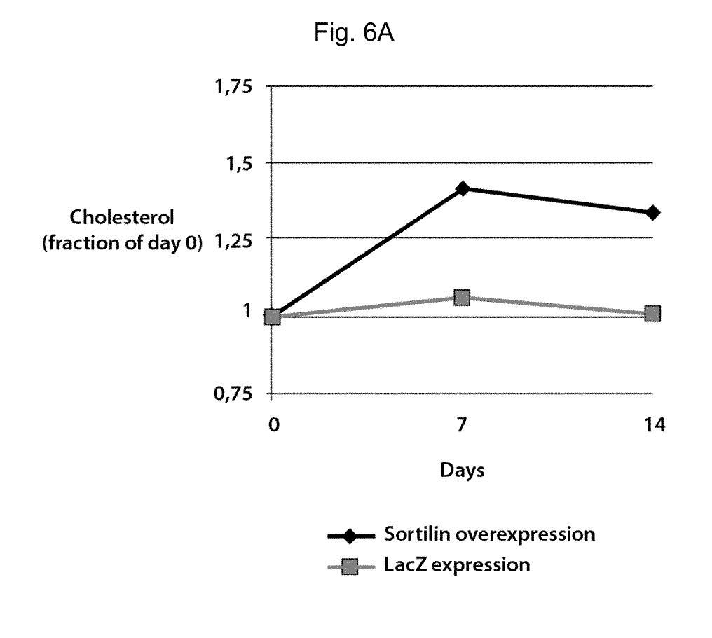

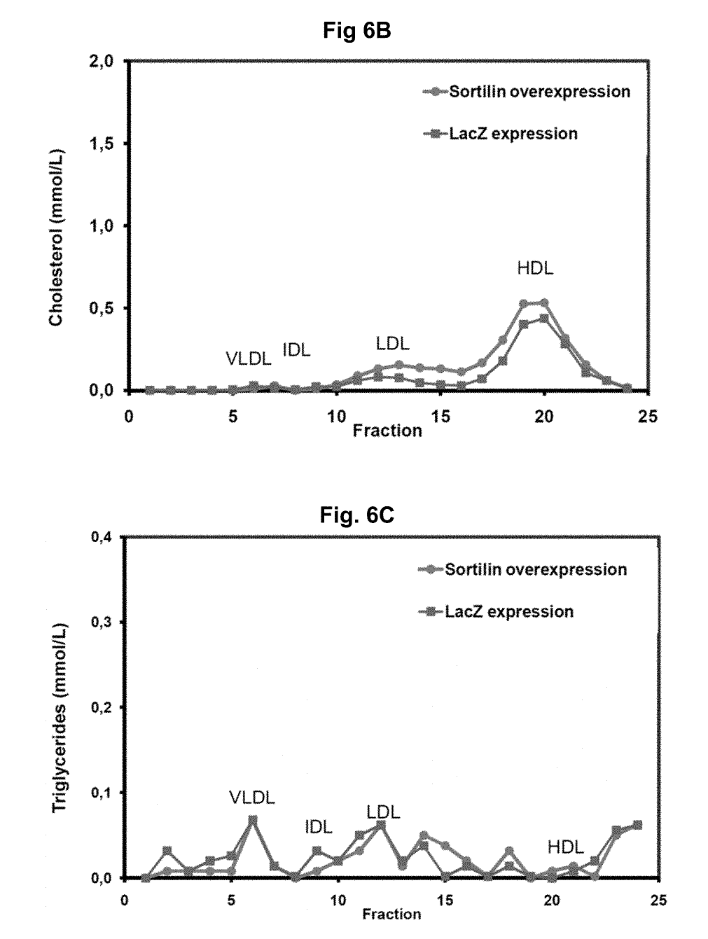

FIG. 6A-6C: Time-course for increase in cholesterol levels and FPLC profile in mice that over-express Sortilin. Data normalized to 100% at Day 0 (t=O) (FIG. 6A). There is an increase in plasma cholesterol selectively in mice that received adenovirus with sortilin (round marker) and not in mice that received adenovirus with LacZ (square marker). FIG. 6B-6C is a FPLC of plasma. Mice were subjected to WTD from day −14 to day 14 (28 days).

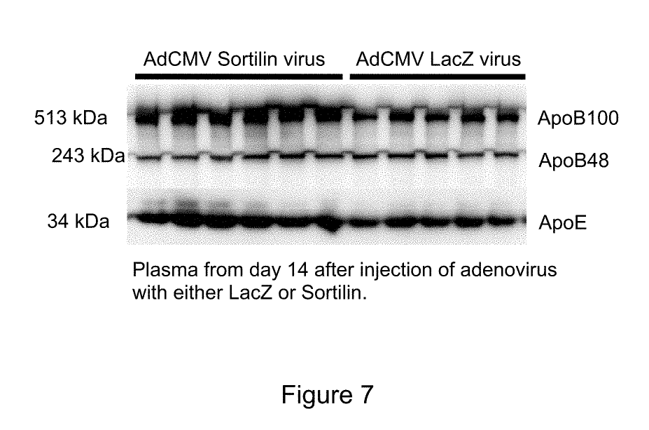

FIG. 7: Western Blot for apoproteins in mice that over-express Sortilin. Plasma 35 was sampled 14 days after injection of either Adenovirus with Sortilin or LacZ (tail vein injection), and subsequently immunoblotted for ApoB and ApoE. There is a higher concentration of ApoB100 and, to a lesser extent, a higher concentration of ApoE in mice that received adenovirus with sortilin compared to adenovirus with ApoE. Mice were subjected to WTD from day −14 to day 14 (28 days).

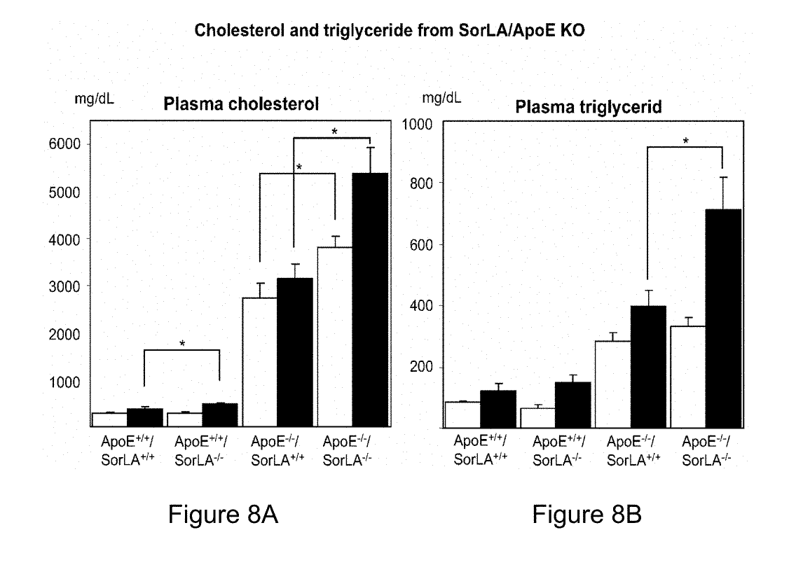

FIG. 8A-8B: Cholesterol (FIG. 8A) and triglyceride (FIG. 8B) levels in SorLA/ApoE double knockout mice. Lipids (cholesterol and triglycerides) were measured in wild-type mice (ApoExSorLA; +/+,+/+), mice lacking SorLA expression (ApoExSorLA; +/+,−/−), mice devoid in apolipoprotein E (ApoExSorLA; −/−,+I+), and double knockout mice lacking expression of both proteins (ApoExSorLA; −/−,−/−). The male mice were fed a western-type diet rich in lipids for 4-6 weeks, fasted overnight and plasma samples were analysed for cholesterol and triglycerides. SortLA knockout mice exhibit a significant increase in plasma cholesterol as compared to control littermates (wild-type) (p<0.05). In apoE deficient mice, cholesterol and triglycerides were increased in the absence of SorLA (ApoExSorLA; −/−,−/−) (p<0.001).

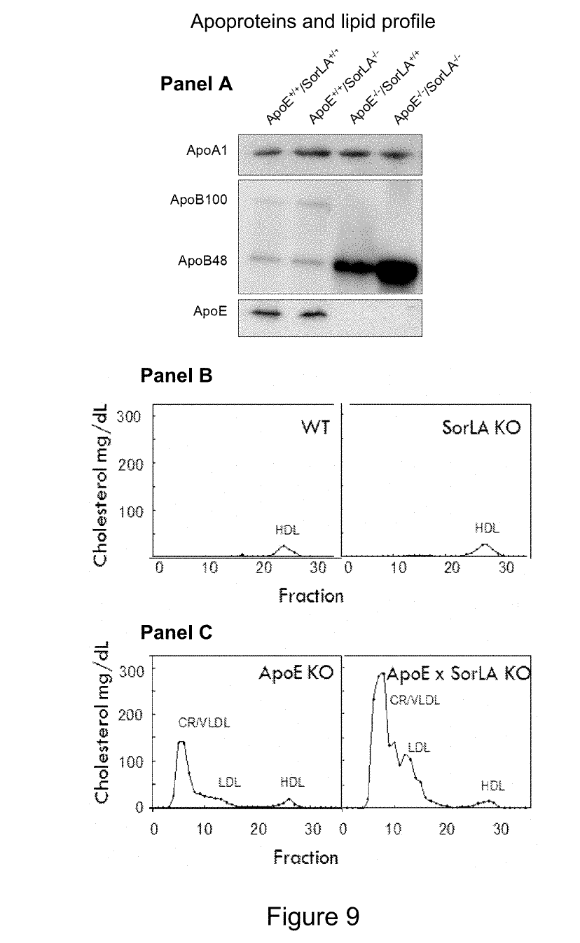

Figure. 9: Apolipoproteins and liproprotein profiles SorLA/ApoE double knockout mice. Panel A) Serum from transgenic mice with the indicated genotypes fed a Western-type diet were allpied to reducing SDS-PAGE followed by Western blotting using antibodies against ApoA1, ApoB and ApoE. Panels B-C) Lipoprotein profiles—cholesterol. FPLC profiles of mouse plasma lipoproteins from wild-type mice (ApoExSorLA; +/+,+/+; Panel B, Left), mice lacking SorLAn expression ApoExSorLA; +/+,−/−; Panel B, Right), mice devoid in the apolipoprotein ApoE, (ApoExSorLA; −/−,+/+; Panel C, Left), and double knockout mice lacking expression of both proteins (ApoExSorLA; −/−,−/−; Panel C, Right). Mice with the indicated genotypes were fed a Western-type diet for 4-6 weeks and plasma samples were collected from each animal and subjected to gel filtration on FPLC. The cholesterol content in each fraction was subsequently measured. The retention time of the various lipoprotein particles are indicated.

FIG. 10A-10L: Competition of peptides with GST C-terminally tagged with Tyr-Ile-Leu (YIL). Binding to immobilized sSortilin was measured by surface plasmon resonance. 100% corresponds to the measured response units obtained for 100 nM GST-YIL in the absence of competing peptide. The EC50 values is the concentration of peptide at which the GST-YIL binding is reduced to 50%. Sequences are given for the peptides and for peptides that contain non-natural amino acids the structure is also shown.

### OVERVIEW OF SEQUENCES

SEQ ID NO 1: Sortilin

SEQ ID NO 2: SorLA

SEQ ID NO 3: SorCS1

SEQ ID NO 4: SorCS2

SEQ ID NO 5: SorCS3

SEQ ID NO 6: pre-pro-NGF

SEQ ID NO 7: pre-pro-BONF

SEQ ID NO 8: Neurotrophin-3

SEQ ID NO 9: Neurotrophin-4/5

SEQ ID NO 10: Neurotensin (1-13)

SEQ ID NO 11: PYIL (C-term of Neurotensin)

SEQ ID NO 12: NT69L

SEQ ID NO 13: Receptor associated peptide (RAP)

SEQ ID NO 14: Apolipoprotein E (ApoE)

SEQ ID NO 15: Lipoprotein lipase (LpL)

SEQ ID NO 16: C-term of Neurotensin

SEQ ID NO 17: C-term of Neurotensin

SEQ ID NO 18: C-term of Neurotensin

SEQ ID NO 19: C-Terminal N-Methyl-Leucine derivative of SEQ ID NO:18

SEQ ID NO 20: C-term of Neurotensin

SEQ ID NO 21: C-term of Neurotensin

SEQ ID NO 22: C-term of Neurotensin

SEQ ID NO 23: C-term of Neurotensin

SEQ ID NO 24: C-term of Neurotensin

SEQ ID NO 25: C-term of Neurotensin

SEQ ID NO 26: C-term of Neurotensin

### EXAMPLES

### Example 1: Determination of Plasma Concentration of Cholesterol and Cholesterol-Containing Lipoproteins

8-12 weeks old mice were during 4-6 weeks fed a Western-type diet whereafter measurements and determination of cholesterol and lipoprotein particles was made. The following strains were used: Wild-type mice and mice lacking Sortilin expression (Jansen et al, Nat. Neurosci. (2007) 10:1449-,), LOL receptor (LOLR) deficient mice (Ishibashi et al (1993) J. Clin. Invest. 92:883-), SorLA knockout mice (Andersen et al, PNAS (2005) 102:13461-) and mice with disrupted ApoE expression (Zhang et al, Science (1992) 258:468-). The mice were intercrossed to generate a line lacking Sortilin and LOLR expression and a line devoid in both ApoE and SorLA. Blood samples were taken in the morning after fasting 12 hours by retroorbital bleeding of ether-anesthetized animals. Blood was transferred to heparin coated tubes on ice. Following centrifugation at 5400 rpm (3000 g) for 15 minutes at 4° C., total cholesterol was determined using a cholesterol CHOO-PAP″ kit from Roche/Hitachi. In brief, 35 cholesterol was measured by mixing the samples with Cholesterol CHOO-PAP reagents.

After incubation the optical density (0.0.) was measured at 492 nm. A calibration curve of a cholesterol standard was be made in the same experiment. FIG. 3 depicts decreased cholesterol levels in Sortilin knockout mice as compared to control littermates. Moreover, Sortilin/LDLR double deficient mice are protected against the increase in cholesterol levels observed in the LDLR knockouts. In contrast, mice lacking SorLA have increased plasma cholesterol levels and deficiency of both SorLA and ApoE results in higher cholesterol levels than deficiency for ApoE alone (FIG. 8).

Measurement of lipoprotein profiles by FPLC analysis were performed using an ÅKTA apparatus. Lipoproteins were separated on a Superose™ 6 PC3.2/30 column with an AKTATMpurifier10 using the TimeSuperose6 method in the Unicorn 5.11 program (GE Health care). In short: Plasma was diluted to <5 mmol/L cholesterol before injection. 50 μl of the diluted sample was injected onto the column. Analysis was performed in freshly prepared samples. Cholesterol was subsequently measured in the fractions (see above). FIG. 5A, Panels A-D shows such an experiment. It is evident that Sortilin −/− mice are characterized by reduced LDL levels as compared to control mice. Likewise, mice lacking both Sortilin and LDLR have reduced LDL concentrations when compared to mice only lacking LDLR expression. Of note, SorLNApoE double knockouts are characterized by VLDL concentrations dramatically higher than that observed for mice lacking only ApoE −/− expression (FIG. 9, Panels A-C). The data demonstrate that Sortilin and SorLA are capable of modifying cholesterol levels and LDL (for Sortilin) and VLDL (for SorLA) concentrations in vivo.

### Example 2: Determination of Plasma Concentration of Triglycerides and Triglyceride-Containing Lipoproteins

8-12 weeks old mice were fed 4-6 weeks a Western-type diet and used cholesterol measurements and determination of lipoprotein particles. The following strains were used: Wild-type mice. Mice lacking Sortilin expression (Jansen et al, (2007) Nat. Neurosci. 10:1449-), LDL receptor (LDLR) deficient mice (Ishibashi et al (1993) J. Clin. Invest. 92:883-), SorLA knockout mice (Andersen et al, PNAS (2005) 102:13461-) and mice with disrupted ApoE expression (Zhang et al, Science (1992) 258:468-). The mice were intercrossed to generate a line lacking Sortilin and LDLR expression and a line devoid in both ApoE and SorLA. Blood samples were taken in the morning after fasting 12 hours by retroorbital bleeding of ether-anesthetized animals. Blood was transferred to heparin coated tubes on ice. Following centrifugation at 5400 rpm (3000 g) for 15 minutes at 4° C., triglycerides were determined using a commercially available kit “Triglycerides GPO-PAP” kit (Roche/Hitachi). Total triglycerides were determined by mixing the samples with Triglycerides GPO-PAP reagents from Roche/Hitachi. After incubation the O.D. was measured at 492 nm. A calibration curve of a glycerol standard was made in the same experiment. FIG. 4 shows slightly increased triglyceride levels in LDLR−/− mice when compared to control littermates. Likewise, mice devoid in both ApoE and SorLA are characterized by higher triglyceride levels than animals lacking only ApoE contrast, mice lacking SorLA have increased plasma cholesterol levels and deficiency of both SorLA and ApoE results in higher cholesterol levels than deficiency for ApoE alone (FIG. 8). Measurement of triglyceride lipoproteins were performed using FPLC on an AKTA apparatus. Lipoproteins were separated on a Superose™ 6 PC3.2/30 column with an ÄKTA purifier10 using the TimeSuperose6 method in the Unicorn 5.11 program (GE Healthcare). In short: Plasma was diluted to <5 mmol/L cholesterol before injection. 50 μl of the diluted sample was injected onto the column. Analysis was performed in freshly prepared samples. Triglycerides was subsequently measured in the fractions (see above). FIG. 5A, Panels A-D shows such an experiment.

### Example 3: Evaluating Effect of Over-Expression of Sortilin Using Adenoviral Vectors

8 weeks old mice were during 4 weeks (day −14 to day 14) fed a Western-type diet whereafter measurements and determination of cholesterol (and triglyceride and ALAT) and lipoprotein particles was made (day 0, 7 and 14). Wild-type mice were used. Blood samples were taken in the morning after fasting 12 hours by retroorbital bleeding of ether-anesthetized animals. Blood was transferred to heparin coated tubes on ice. Following centrifugation at 5400 rpm (3000 g) for 15 minutes at 4° C., total cholesteroll was determined using a cholesterol CHOD-PAP″ kit from Roche/Hitachi. On day 0, mice were injected in the tail vein with either an adenoviral vector with sortilin or LacZ. Measurements of cholesterol were made on day 7 and 14 to evaluate the effect of the protein. In FIG. 6 the effect is illustrated. Mice with overexpression of sortilin exhibited a marked increase in cholesterol compared to day 0. This increase was not seen in mice that received LacZ. WB of livers were applied to verify the increased amount of sortilin, and staining for LacZ to check the mice that received the viral vector with LacZ. A WB of apoproteins B and E (FIG. 7) shows a marked increase in ApoB100 in mice that received the adenovirus with sortilin.

### Example 4: In Vitro Screening Method for Identifying Vps10p-Domain Receptor Antagonists and Ligands

Determination of direct binding of ligand to immobilized protein can be performed by e.g. surface plasmon resonance analysis (Biacore, Sweden) using CaHBS as standard running buffer (10 mM HEPES, pH 7.4, 140 mM NaCl, 2 mM CaCl2, 1 mM EGTA, and 0.005% Tween-20). A biosensor chip from Biacore (CM5, cat. no. BR-1000-14) is activated using the NHS/EDC method as described by supplier followed by coating with a receptor belonging to the Vps10p-domain receptor family. Several different approaches can be applied: Candidate receptor antagonist can be identified by comparing the binding signal (response units) to a chip immobilized with one of the receptors and comparing this signal to an empty flow cell. In another approach, inhibition of an established ligand can be monitered in the absence or presence of putative inhibitors. The difference in the signal depicts the inhibitory potential of the antagonist. The data collected are analysed by fitting of sensorgrams for affinity estimations and inhibitory potential using the Biaevaluation version 3.1 program. We evaluated the binding properties of ApoB to sortilin (FIG. 5B). FIG. 5B, Panel A) After baseline calibration in running buffer (10 mM Hepes, 150 mM NaCl, 1 mM EGTA, 1.5 mM CaCl2, 0.005% P20, pH 7.4) 10 μg/ml rabbit anti-sortilin IgG (Nykjaer et al, Nature (2004) 427:843-848) or running buffer alone was applied to the chip. At t=700 sec the response units obtained in the presence of anti-sortilin IgG was arbitrarily set at 100 and 50 nM ApoB was applied to the flow cell pre-incubated with antibody or with buffer alone. Association of ApoB binding was measured until 1200 sec, after which the solute was changed to buffer to allow dissociation. FIG. 5B, Panel B) Data extracted from panel A. Binding of ApoB at t=1200 sec to the flow cell following preincubation with running buffer alone (=maximum ApoB binding) was set at 100 relative response units. When pre-incubated with the inhibitory anti-sortilin antibody, no ApoB binding was observed. FIG. 5B, Panel C) Surface plasmon resonance analysis of ApoB (10, 20, 50 nM) binding to immobilized sortilin. The on and off rates were recorded, and the K_{d} value was 0.4 nM for binding to sortilin in the displayed experiment. So ApoB can bind with high affinity to Sortilin and this binding can be inhibited using either antibodies or neurotensin (NT).

The surface Plasmon resonance assay can easily be transformed into other assays in which the Vps10p-domain receptor, the ligand or the putative inhibitor is immobilized on a solid phase. For instance, receptors can be immobilized in e.g. Maxisorp microtiter wells from Nunc (cat. no. 439454) by incubation for 16 h at 4° C. in 50 mM NaHCO₃, pH 9.6. After blocking using 5% bovine serum albumin (Sigma, cat. no. A9647) for 2 h at room temperature, the wells are washed three times with MB buffer (10 mM HEPES, pH 7.4, 140 mM NaCl, 2 mM CaCl₂, and 1 mM MgCl₂) before incubation with a labelled ligand (e.g. iodinated) in the absence or presence of a various concentrations of a candidate inhibitor. Following incubation (e.g. overnight at 4° C.) and washing with MB buffer, bound radioactivity is released by adding 10% SDS. Nonspecific binding of tracer to wells coated only with bovine serum albumin is determined and subtracted from the values determined in the binding experiments. The binding data point can be fitted to binding equations using the Prism software from GraphPad, version 4. Likewise, the antagonist can be labelled and binding to the immobilized receptor directly measured. In yet another setup, the receptor, ligand or antagonist can be immobilized on scintillation beads and binding measured in a scintillation proximity assay in which the receptor-binding molecule has been labelled using radioactivity.

### Example 5: A Cell Based Screening Method for Identifying Vps10p-Domain Receptor Antagonists

Determination of binding, internalization or signaling by members of the Vps10p-domain receptor family can be performed in cellular systems. Cells expressing one of the receptors, either endogenously or following e.g. transfection with a plasmid containing the cDNA of the receptor are incubated with a radio-labeled ligand, in the absence and the presence respectively, of a candidate inhibitor/antagonist compound. After incubation, the cells are washed to remove unspecific binding and subsequently harvested. The degree of binding of the candidate antagonist/linhibitor to the receptor is determined by using a conventional radioligand assay well known to those skilled in the art. See e.g. Bylund and Toews (1993) Am J Physiol. 265(5 Pt 1):L421-9 entitled “Radioligand binding methods: practical guide and tips”. Likewise, endocytosis/internalization may be determined as described in Nykjr et al (1992) FEBS 300:13- and Nielsen et al (2001) EMBO J., 20:2180-.

### Example 6: An In Vivo Based Screening Method for Identifying Vps10p-Domain Receptor Antagonists

Identification of candidate antagonists capable of inhibiting binding and/or internalization and/or signaling of a Vps10p-domain receptor is performed in wild type mice or another animal suitable for the purpose.

The animals are fed a western-type diet rich in lipids during a period of 4-6 weeks, during which period candidate antagonists potentially capable of inhibiting binding to, internalisation by and signalling through a Vps10p-domain receptor (selected from the group consisting of SEQ ID NO. 1 to 5), are administered to said animal. Control animals are fed a normal chow of a western-type diet rich in lipids during a period of 4-6 weeks in the absence of candidate antagonist compounds.

At the end of the period the animals are fasted over-night and plasma samples are taken and analysed for the level of cholesterol in the two groups of animals. The difference between the group to which the candidate antagonist has been administered and the control group indicate the degree of inhibition

### Example 7: An In Vivo Based Screening Method for Identifying Vps10p-Domain Receptor Antagonists

Identification of candidate antagonists capable of inhibiting binding and/or internalization and/or signaling of a Vps10p-domain receptor is performed in wild type mice or another animal suitable for the purpose.

The animals are fed a western-type diet rich in lipids during a period of 4-6 weeks, during which period radiolabelled candidate antagonists potentially capable of inhibiting binding to, internalisation by and signalling through a Vps10p-domain receptor, are administered to said animal. Control animals are fed a western-type diet rich in lipids during a period of 4-6 weeks in the absence of said radiolabelled candidate antagonist compounds. At the end of the period the animals are fasted over-night and sacrificed whereafter representative tissues are dissected and determination of the amount of bound and/or accumulated radiolabelled ligand is determined using a conventional scintillation assay.

### Example 8: An In Vivo Based Evaluation of the Potency of the Vps10p-Domain Receptor Antagonist

A hypercholesterolemic patient is treated with a conventional (e.g. a statin) or dietary regime whereby the serum cholestrol level is determined. Subsequently, the patient replaces his statin treatment during one month by the Vps10p-domain receptor antagonist for up to 4-6 weeks with a preparation according to the present invention, whereby the cholesterol level is again determined and compared to the level obtained with or without the conventional treatment (e.g. a statin) or dietary regime.

### Example 9: Method of Treatment

A 55-year-old man is diagnosed with severe hyperlipidemia. The physician in charge decides that the patient shall receive Vps10p-domain receptor antagonists to reduce the abnormal plasma lipid levels. A subcutaneous or intravenous bolus injection of a compound of this invention is administered. The dose is in the interval 0.5 mg/kg to 50 mg/kg. At the hospital, the plasma lipid levels as well as the general condition of the patient is continuously monitored until a stable normal level of the plasma lipid level is obtained. The patient is prescribed injection or an orally available equivalent of the compound of the invention injected at the hospital. The oral dose is in the interval 0.5 mg/kg to 50 mg/kg body weight.

### Example 10: Method of Treatment

A 55-year-old man is diagnosed with hypercholesterolemia through a longer period. Conventional intervention has not lowered plasma cholesterol sufficiently. A measurement of sortilin in the liver shows high levels. It is decided at the department to lower the sortilin concentration in the liver using siRNA targeted to the liver. At the hospital, the plasma lipid levels as well as the general condition of the patient is continuously monitored until a stable normal level of the plasma lipid level is obtained. The patient is prescribed injection or an orally available equivalent of the compound of the invention injected at the hospital.

### REFERENCES

1. Goldstein, J. L., Hobbs, H. H. and Brown, M. S. (2001). Familial Hypercholesteremia. In: Metabolic and Molecular Bases of Inherited Disease Eight edition, New York: McGraw-Hill, 2863-2913.
2. Tannock L R. Advances in the management of hyperlipidemia-induced atherosclerosis. Expert Rev Cardiovasc Ther. 2008 March; 6(3):369-83.
3. Charlton-Menys V, Durrington P N. Human cholesterol metabolism and therapeutic molecules. Exp Physiol. 2008 January; 93(1):27-42.
4. Baker S K, Samjoo I A. A neuromuscular approach to statin-related myotoxicity. Can J Neurol Sci. 2008 March; 35(1):8-21.
5. Radcliffe K A, Campbell W W. Statin myopathy. Curr Neurol Neurosci Rep. 2008 January; 8(1):66-72.
6. Petersen et al., J. Biol. Chem., 272:3599-3605 (1997)
7. Herman-Borgmeyer et al., Mol. Brain Res., 65:216-219 (1999)
8. Jacobsen et al., J. Biol. Chem., 271:31379-31383 (1996)
9. Marcusson, E. G., et al., Cell, 77:579-586 (1994)
10. J. Mazella et al., J Biol Chem 273, 26273 (1998).
11. C. Munck Petersen et al., Embo J 18, 595 (1999).
12. A. Nykjaer et al., Nature 427, 843 (2004).
13. H. K. Teng et al., J Neurosci 25, 5455 (2005).
14. U. B. Westergaard et al., J Biol Chem 279, 50221 (2004).
15. S. Maeda et al., J Cell Physiol 193, 73 (2002).
16. M. S. Nielsen, C. Jacobsen, G. Olivecrona, J. Gliemann, C. M. Petersen, J Biol Chem 274, 8832 (1999).
17. M. S. Nielsen et al., Embo J 20, 2180 (2001).
18. K. Nakamura, K. Namekata, C. Harada, T. Harada, Cell Death Differ 14, 1552 (2007).
19. P. Jansen et al., Nat Neurosci 10, 1449 (2007).
20. P. Chalon et al., FEBS Lett 386, 91 (1996).
21. L. Jacobsen et al., J Biol Chem 276, 22788 (2001).
22. K. Tanaka, M. Masu, S. Nakanishi, Neuron 4, 847 (1990).
23. J. P. Vincent, J. Mazella, P. Kitabgi, Trends Pharmacal Sci 20, 302 (1999).
24. Willer et al. (2008) Nature Genetics 40(2): 161-169
25. Kathiresan et al. (2008) Nature Genetics 40(2): 189-97
26. U. B. Westergaard, K. Kirkegaard, E. S. Sorensen, C. Jacobsen, M. S. Nielsen, C. M. Petersen, P. Madsen, (2005) FEBS Letters 579:1172-1176
27. Clee S M, Yandell B S, Schueler K M, Rabaglia O C, Richards O C, Raines S M, Kabara E A, Klass D M, Mui E T, Stapleton D S, Gray-Keller M P, Young M B, Stoehr J P, Lan H, Boronenkov I et al. Positional cloning of SorCS1, a type 2 diabetes quantitative trait locus. (2006) Nature Genetics 38:688-693
28. Goodarzi M O, Lehman D M, Taylor K D, Guo X, Cui J, Quinones M J, Clee S M, Blangero J, Hsueh W A, Attie A D, Stern M P, Rotter J I. SorCS1: a novel human type 2 diabetes susceptibility gene suggested by the mouse. (2007) Diabetes 56:1922-1929.
29. Granhall, C., Rosengren, A. H., Renstrom, E., Luthman, H. (2006) Diabetes 55: 3494-3500.
30. Quistgaard et al, Nat. Struc. Mol. Biol. (2009) 16: 96-98

What is claimed is:

1. A pharmaceutical composition that comprises an antibody, or binding portion thereof, capable of binding to a Vps10p-domain receptor molecule present on cells of an animal exhibiting hyperlipoproteinemia, and a carrier, wherein:
(A) said binding inhibits the ability of said Vps10p-domain receptor molecule to bind to a natural ligand thereof, and
(B) wherein said composition contains an amount of said antibody, or said binding portion thereof, sufficient to decrease abnormal plasma lipid concentrations in a hyperlipoproteinemia-exhibiting animal.

2. The pharmaceutical composition of claim 1, wherein the hyperlipoproteinemia is selected from the group consisting of Buerger-Gruetz syndrome, Primary hyperlipoproteinaemia, Familial hyperchylomicronemia, polygenic hypercholesterolemia, combined hyperlipidemia, familial Dysbetalipoproteinemia, endogenous Hyperlipemia, familial Hypertriglyceridemia, Aneurysm, Angina pectoris, Atherosclerosis, Cerebrovascular Accident, Cerebrovascular disease, Congenital Heart Disease, Congestive Heart Failure, Coronary Artery Disease, Dilated cardiomyopathy, Diastolic dysfunction, Endocarditis, Hypercholesterolemia, Hypertension, Hyperlipidemia, Hypertrophic cardiomyopathy, Mitral valve prolapse, Myocardial infarction and Venous Thromboembolism.

3. The pharmaceutical composition according to claim 1, wherein said antibody is capable of inhibiting binding of an agonist selected from the group consisting of ApoB, proNGF, proBDNF, proNT3, pro-NT4/5, ApoE or LpL, to said Sortilin receptor.

4. The pharmaceutical composition according to claim 1, wherein the animal is a human being.

5. The pharmaceutical composition according to claim 1, wherein said composition comprises an antibody, and said antibody is selected from the group consisting of: a polyclonal antibody, a monoclonal antibody, a humanized antibody, a single chain antibody, and a recombinant antibody.

6. The pharmaceutical composition according to claim 5, wherein the antibody is directed against the extracellular part of Sortilin.

7. The pharmaceutical composition according to claim 1, wherein said composition comprises a binding portion of an antibody selected from the group consisting of: a polyclonal antibody, a monoclonal antibody, a humanized antibody, a single chain antibody, and a recombinant antibody.

8. The pharmaceutical composition according to claim 7, wherein the binding portion is directed against the extracellular part of Sortilin.

9. The pharmaceutical composition according to claim 1, wherein the antagonist binds at least one amino acid residue of a binding site that comprises amino acid residues: R325, S316, Y351, I353, K260, I327, F314, F350 to M363, S305, F306, T398 to G400, I303-G309, Q349-A356, Y395 and T402 of SEQ ID NO:1.

10. The pharmaceutical composition according to claim 1, wherein the antagonist binds at least one amino acid residue of a binding site that comprises amino acid residues: L572, L114, V112, R109 to S111, S115 to G118, T570, G571, W586, W597, T168-I174, L572, A573 and S584 to F588 of SEQ ID NO:1.


SEQUENCE LISTING (26 sequences)

SEQ ID NO: 1 - protein, 831 aa, Homo sapiens
  SIGNAL (1)..(33): Sortilin signal peptide
  PROPEP (34)..(77): Sortilin propeptide
  MISC_FEATURE (78)..(755): Extracellular part of Sortilin (sSortilin)
  TRANSMEM (756)..(778): Membrane spanning part of Sortilin
  MISC_FEATURE (779)..(831): Intracellular (cytoplasmic) domain of Sortilin
MERPWGAADGLSRWPHGLGLLLLLQLLPPSTLSQDRLDAPPPPAAPLPRWSGPIGVSWGLRAAAAGGAFPRGGRWRRSAPGEDEECGRVRDFVAKLANNTHQHVFDDLRGSVSLSWVGDSTGVILVLTTFHVPLVIMTFGQSKLYRSEDYGKNFKDITDLINNTFIRTEFGMAIGPENSGKVVLTAEVSGGSRGGRIFRSSDFAKNFVQTDLPFHPLTQMMYSPQNSDYLLALSTENGLWVSKNFGGKWEEIHKAVCLAKWGSDNTIFFTTYANGSCKADLGALELWRTSDLGKSFKTIGVKIYSFGLGGRFLFASVMADKDTTRRIHVSTDQGDTWSMAQLPSVGQEQFYSILAANDDMVFMHVDEPGDTGFGTIFTSDDRGIVYSKSLDRHLYTTTGGETDFTNVTSLRGVYITSVLSEDNSIQTMITFDQGGRWTHLRKPENSECDATAKNKNECSLHIHASYSISQKLNVPMAPLSEPNAVGIVIAHGSVGDAISVMVPDVYISDDGGYSWTKMLEGPHYYTILDSGGIIVAIEHSSRPINVIKFSTDEGQCWQTYTFTRDPIYFTGLASEPGARSMNISIWGFTESFLTSQWVSYTIDFKDILERNCEEKDYTIWLAHSTDPEDYEDGCILGYKEQFLRLRKSSVCQNGRDYVVTKQPSICLCSLEDFLCDFGYYRPENDSKCVEQPELKGHDLEFCLYGREEHLTTNGYRKIPGDKCQGGVNPVREVKDLKKKCTSNFLSPEKQNSKSNSVPIILAIVGLMLVTVVAGVLIVKKYVCGGRFLVHRYSVLQQHAEANGVDGVDALDTASHTNKSGYHDDSDEDLLE

SEQ ID NO: 2 - protein, 2214 aa, Homo sapiens
  SIGNAL (1)..(28): Signal peptide of SorLA
  PROPEP (29)..(81): Propeptide of SorLA
MATRSSRRESRLPFLFTLVALLPPGALCEVWTQRLHGGSAPLPQDRGFLVVQGDPRELRLWARGDARGASRADEKPLRRKRSAALQPEPIKVYGQVSLNDSHNQMVVHWAGEKSNVIVALARDSLALARPKSSDVYVSYDYGKSFKKISDKLNFGLGNRSEAVIAQFYHSPADNKRYIFADAYAQYLWITFDFCNTLQGFSIPFRAADLLLHSKASNLLLGFDRSHPNKQLWKSDDFGQTWIMIQEHVKSFSWGIDPYDKPNTIYIERHEPSGYSTVFRSTDFFQSRENQEVILEEVRDFQLRDKYMFATKVVHLLGSEQQSSVQLWVSFGRKPMRAAQFVTRHPINEYYIADASEDQVFVCVSHSNNRTNLYISEAEGLKFSLSLENVLYYSPGGAGSDTLVRYFANEPFADFHRVEGLQGVYIATLINGSMNEENMRSVITFDKGGTWEFLQAPAFTGYGEKINCELSQGCSLHLAQRLSQLLNLQLRRMPILSKESAPGLIIATGSVGKNLASKTNVYISSSAGARWREALPGPHYYTWGDHGGIITAIAQGMETNELKYSTNEGETWKTFIFSEKPVFVYGLLTEPGEKSTVFTIFGSNKENVHSWLILQVNATDALGVPCTENDYKLWSPSDERGNECLLGHKTVFKRRTPHATCFNGEDFDRPVVVSNCSCTREDYECDFGFKMSEDLSLEVCVPDPEFSGKSYSPPVPCPVGSTYRRTRGYRKISGDTCSGGDVEARLEGELVPCPLAEENEFILYAVRKSIYRYDLASGATEQLPLTGLRAAVALDFDYEHNCLYWSDLALDVIQRLCLNGSTGQEVIINSGLETVEALAFEPLSQLLYWVDAGFKKIEVANPDGDFRLTIVNSSVLDRPRALVLVPQEGVMFWTDWGDLKPGIYRSNMDGSAAYHLVSEDVKWPNGISVDDQWIYWTDAYLECIERITFSGQQRSVILDNLPHPYAIAVFKNEIYWDDWSQLSIFRASKYSGSQMEILANQLTGLMDMKIFYKGKNTGSNACVPRPCSLLCLPKANNSRSCRCPEDVSSSVLPSGDLMCDCPQGYQLKNNTCVKEENTCLRNQYRCSNGNCINSIWWCDFDNDCGDMSDERNCPTTICDLDTQFRCQESGTCIPLSYKCDLEDDCGDNSDESHCEMHQCRSDEYNCSSGMCIRSSWVCDGDNDCRDWSDEANCTAIYHTCEASNFQCRNGHCIPQRWACDGDTDCQDGSDEDPVNCEKKCNGFRCPNGTCIPSSKHCDGLRDCSDGSDEQHCEPLCTHFMDFVCKNRQQCLFHSMVCDGIIQCRDGSDEDAAFAGCSQDPEFHKVCDEFGFQCQNGVCISLIWKCDGMDDCGDYSDEANCENPTEAPNCSRYFQFRCENGHCIPNRWKCDRENDCGDWSDEKDCGDSHILPFSTPGPSTCLPNYYRCSSGTCVMDTWVCDGYRDCADGSDEEACPLLANVTAASTPTQLGRCDRFEFECHQPKTCIPNWKRCDGHQDCQDGRDEANCPTHSTLTCMSREFQCEDGEACIVLSERCDGFLDCSDESDEKACSDELTVYKVQNLQWTADFSGDVTLTWMRPKKMPSASCVYNVYYRVVGESIWKTLETHSNKTNTVLKVLKPDTTYQVKVQVQCLSKAHNTNDFVTLRTPEGLPDAPRNLQLSLPREAEGVIVGHWAPPIHTHGLIREYIVEYSRSGSKMWASQRAASNFTEIKNLLVNTLYTVRVAAVTSRGIGNWSDSKSITTIKGKVIPPPDIHIDSYGENYLSFTLTMESDIKVNGYVVNLFWAFDTHKQERRTLNFRGSILSHKVGNLTAHTSYEISAWAKTDLGDSPLAFEHVMTRGVRPPAPSLKAKAINQTAVECTWTGPRNVVYGIFYATSFLDLYRNPKSLTTSLHNKTVIVSKDEQYLFLVRVVVPYQGPSSDYVVVKMIPDSRLPPRHLHVVHTGKTSVVIKWESPYDSPDQDLLYAIAVKDLIRKTDRSYKVKSRNSTVEYTLNKLEPGGKYHIIVQLGNMSKDSSIKITTVSLSAPDALKIITENDHVLLFWKSLALKEKHFNESRGYEIHMFDSAMNITAYLGNTTDNFFKISNLKMGHNYTFTVQARCLFGNQICGEPAILLYDELGSGADASATQAARSTDVAAVVVPILFLILLSLGVGFAILYTKHRRLQSSFTAFANSHYSSRLGSAIFSSGDDLGEDDEDAPMITGFSDDVPMVIA

SEQ ID NO: 3 - protein, 1168 aa, Homo Sapiens [sequence omitted]

SEQ ID NO: 4 - protein, 907 aa, Homo Sapiens
LIFHPKEEDKVLAYTKESKLYVSSDLGKKWTLLQERVTKDHVFWSVSGVDADPDLVHVEAQDLGGDFRYVTCAIHNCSEKMLTAPFAGPIDHGSLTVQDDYIFFKATSANQTKYYVSYRRNEFVLMKLPKYALPKDLQIISTDESQVFVAVQEWYQMDTYNLYQSDPRGVRYALVLQDVRSSRQAEESVLIDILEVRGVKGVFLANQKIDGKVMTLITYNKGRDWDYLRPPSMDMNGKPTNCKPPDCHLHLHLRWADNPYVSGTVHTKDTAPGLIMGAGNLGSQLVEYKEEMYITSDCGHTWRQVFEEEHHILYLDHGGVIVAIKDTSIPLKILKFSVDEGLTWSTHNFTSTSVFVDGLLSEPGDETLVMTVFGHISFRSDWELVKVDFRPSFSRQCGEEDYSSWELSNLQGDRCIMGQQRSFRKRKSTSWCIKGRSFTSALTSRVCECRDSDFLCDYGFERSPSSESSTNKCSANFWFNPLSPPDDCALGQTYTSSLGYRKVVSNVCEGGVDMQQSQVQLQCPLTPPRGLQVSIQGEAVAVRPGEDVLFVVRQEQGDVLTTKYQVDLGDGFKAMYVNLTLTGEPIRHRYESPGIYRVSVRAENTAGHDEAVLFVQVNSPLQALYLEVVPVIGLNQEVNLTAVLLPLNPNLTVFYWWIGHSLQPLLSLDNSVTTRFSDTGDVRVTVQAACGNSVLQDSRVLRVLDQFQVMPLQFSKELDAYNPNTPEWREDVGLVVTRLLSKETSVPQELLVTVVKPGLPTLADLYVLLPPPRPTRKRSLSSDKRLAAIQQVLNAQKISFLLRGGVRVLVALRDTGTGAEQLGGGGGYWAVVVLFVIGLFAAGAFILYKFKRKRPGRTVYAQMHNEKEQEMTSPVSHSEDVQGAVQGNHSGVVLSINSREMHSYLVS

SEQ ID NO: 5 - protein, 1222 aa, Homo Sapiens
MEAARTERPAGRPGAPLVRTGLLLLSTWVLAGAEITWDATGGPGRPAAPASRPPALSPLSPRAVASQWPEELASARRAAVLGRRAGPELLPQQGGGRGGEMQVEAGGTSPAGERRGRGIPAPAKLGGARRSRRAQPPITQERGDAWATAPADGSRGSRPLAKGSREEVKAPRAGGSAAEDLRLPSTSFALTGDSAHNQAMVHWSGHNSSVILILTKLYDFNLGSVTESSLWRSTDYGTTYEKLNDKVGLKTVLSYLYVNPTNKRKIMLLSDPEMESSILISSDEGATYQKYRLTFYIQSLLFHPKQEDWVLAYSLDQKLYSSMDFGRRWQLMHERITPNRFYWSVAGLDKEADLVHMEVRTTDGYAHYLTCRIQECAETTRSGPFARSIDISSLVVQDEYIFIQVTTSGRASYYVSYRREAFAQIKLPKYSLPKDMHIISTDENQVFAAVQEWNQNDTYNLYISDTRGIYFTLAMENIKSSRGLMGNIIIELYEVAGIKGIFLANKKVDDQVKTYITYNKGRDWRLLQAPDVDLRGSPVHCLLPFCSLHLHLQLSENPYSSGRISSKETAPGLVVATGNIGPELSYTDIGVFISSDGGNTWRQIFDEEYNVWFLDWGGALVAMKHTPLPVRHLWVSFDEGHSWDKYGFTSVPLFVDGALVEAGMETHIMTVFGHFSLRSEWQLVKVDYKSIFSRHCTKEDYQTWHLLNQGEPCVMGERKIFKKRKPGAQCALGRDHSGSVVSEPCVCANWDFECDYGYERHGESQCVPAFWYNPASPSKDCSLGQSYLNSTGYRRIVSNNCTDGLREKYTAKAQMCPGKAPRGLHVVTTDGRLVAEQGHNATFIILMEEGDLQRTNIQLDFGDGIAVSYANFSPIEDGIKHVYKSAGIFQVTAYAENNLGSDTAVLFLHVVCPVEHVHLRVPFVAIRNKEVNISAVVWPSQLGTLTYFWWFGNSTKPLITLDSSISFTFLAEGTDTITVQVAAGNALIQDTKEIAVHEYFQSQLLSFSPNLDYHNPDIPEWRKDIGNVIKRALVKVTSVPEDQILIAVFPGLPTSAELFILPPKNLTERRKGNEGDLEQIVETLFNALNQNLVQFELKPGVQVIVYVTQLTLAPLVDSSAGHSSSAMLMLLSVVFVGLAVFLIYKFKRKIPWINIYAQVQHDKEQEMIGSVSQSENAPKITLSDFTEPEELLDKELDTRVIGGIATIANSESTKEIPNCTSV

SEQ ID NO: 6 - protein, 241 aa, Homo sapiens
  SIGNAL (1)..(18): Signal peptide of NGF
  PROPEP (19)..(121): Propeptide of NGF (NGFpro)
  MISC_FEATURE (19)..(241): proNGF
  MISC_FEATURE (122)..(241): Mature NGF
MSMLFYTLITAFLIGIQAEPHSESNVPAGHTIPQVHWTKLQHSLDTALRRARSAPAAAIAARVAGQTRNITVDPRLFKKRRLRSPRVLFSTQPPREAADTQDLDFEVGGAAPFNRTHRSKRSSSHPIFHRGEFSVCDSVSVWVGDKTTATDIKGKEVMVLGEVNINNSVFKQYFFETKCRDPNPVDSGCRGIDSKHWNSYCTTTHTFVKALTMDGKQAAWRFIRIDTACVCVLSRKAVRRA

SEQ ID NO: 7 - protein, 246 aa, Homo sapiens
  SIGNAL (1)..(18): Signal peptide of BDNF
  PROPEP (19)..(127): Propeptide of BDNF (BDNFpro)
  MISC_FEATURE (19)..(246): proBDNF
  MISC_FEATURE (128)..(246): Mature peptide of BDNF
MTILFLTMVISYFGCMKAAPMKEANIRGQGGLAYPGVRTHGTLESVNGPKAGSGLTSLADTFEHVIEELLDEDQKVRPNEENNKDADLYTSRVMLSSQVPLEPPLLFLLEEYKNYLDAANMSMRVRRHSDPARRGELSVCDSISEWVTAADKKTAVDMSGGTVTVLEKVPVSKGQLKQYFYETKCNPMGYTKEGCRGIDKRHWNSQCRTTQSYVRALTMDSKKRIGWRFIRIDTSCVCTLTIKRGR

SEQ ID NO: 8 - protein, 257 aa, Homo sapiens
  SIGNAL (1)..(16): Signal peptide of NT3
  PROPEP (17)..(140): Propeptide of NT3 (NT3pro)
  MISC_FEATURE (17)..(257): proNT3
  MISC_FEATURE (141)..(257): Mature peptide of NT3
MSILFYVIFLAYLRGIQGNNMDQRSLPEDSLNSLIIKLIQADILKNKLSKQMVDVKENYQSTLPKAEAPREPERGGPAKSAFQPVIAMDTELLRQQRRYNSPRVLLSDSTPLEPPPLYLMEDYVGSPVVANRTSRRKRYAEHKSHRGEYSVCDSESLWVTDKSSAIDIRGHQVTVLGEIKTGNSPVKQYFYETRCKEARPVKNGCRGIDDKHWNSQCKTSQTYVRALTSENNKLVGWRWIRIDTSCVCALSRKIGRT

SEQ ID NO: 9 - protein, 210 aa, Homo sapiens
  SIGNAL (1)..(24): Signal peptide of NT4/5
  PROPEP (25)..(80): Propeptide of NT4/5
  MISC_FEATURE (25)..(210): proNT4/5
  MISC_FEATURE (81)..(210): Mature peptide of NT4/5
MLPLPSCSLPILLLFLLPSVPIESQPPPSTLPPFLAPEWDLLSPRVVLSRGAPAGPPLLFLLEAGAFRESAGAPANRSRRGVSETAPASRRGELAVCDAVSGWVTDRRTAVDLRGREVEVLGEVPAAGGSPLRQYFFETRCKADNAEEGGPGAGGGGCRGVDRRHWVSECKAKQSYVRALTADAQGRVGWRWIRIDTACVCTLLSRTGRA

SEQ ID NO: 10 - protein, 13 aa, Homo Sapiens
  MISC_FEATURE (1)..(13): Neurotensin
QLYENKPRRPYIL

SEQ ID NO: 11 - protein, 4 aa, Homo Sapiens
  MISC_FEATURE (1)..(4): Four C-terminal amino acids of Neurotensin
PYIL

SEQ ID NO: 12 - protein, 6 aa, Artificial Sequence
  Synthetically generated peptide
  VARIANT (1)..(1): Xaa = N-methyl-Arg
  MISC_FEATURE (1)..(6): NT69L
  VARIANT (4)..(4): Xaa = L-neo-Trp
  VARIANT (5)..(5): Xaa = tert-Leu
XKPXXL

SEQ ID NO: 13 - protein, 357 aa, Homo Sapiens
  MISC_FEATURE (1)..(357): RAP
MAPRRVRSFLRGLPALLLLLLFLGPWPAASHGGKYSREKNQPKPSPKRESGEEFRMEKLNQLWEKAQRLHLPPVRLAELHADLKIQERDELAWKKLKLDGLDEDGEKEARLIRNLNVILAKYGLDGKKDARQVTSNSLSGTQEDGLDDPRLEKLWHKAKTSGKFSGEELDKLWREFLHHKEKVHEYNVLLETLSRTEEIHENVISPSDLSDIKGSVLHSRHTELKEKLRSINQGLDRLRRVSHQGYSTEAEFEEPRVIDLWDLAQSANLTDKELEAFREELKHFEAKIEKHNHYQKQLEIAHEKLRHAESVGDGERVSRSREKHALLEGRTKELGYTVKKHLQDLSGRISRARHNEL

SEQ ID NO: 14 - protein, 475 aa, Homo sapiens
  MISC_FEATURE (1)..(475): LPL
MESKALLVLTLAVWLQSLTASRGGVAAADQRRDFIDIESKFALRTPEDTAEDTCHLIPGVAESVATCHFNHSSKTFMVIHGWTVTGMYESWVPKLVAALYKREPDSNVIVVDWLSRAQEHYPVSAGYTKLVGQDVARFINWMEEEFNYPLDNVHLLGYSLGAHAAGIAGSLTNKKVNRITGLDPAGPNFEYAEAPSRLSPDDADFVDVLHTFTRGSPGRSIGIQKPVGHVDIYPNGGTFQPGCNIGEAIRVIAERGLGDVDQLVKCSHERSIHLFIDSLLNEENPSKAYRCSSKEAFEKGLCLSCRKNRCNNLGYEINKVRAKRSSKMYLKTRSQMPYKVFHYQVKIHFSGTESETHTNQAFEISLYGTVAESENIPFTLPEVSTNKTYSFLIYTEVDIGELLMLKLKWKSDSYFSWSDWWSSPGFAIQKIRVKAGETQKKVIFCSREKVSHLQKGKAPAVFVKCHDKSLNKKSG

SEQ ID NO: 15 - protein, 317 aa, Homo sapiens [sequence omitted]

SEQ ID NO: 16 - protein, 13 aa, Homo sapiens
  MISC_FEATURE (1)..(1): Pyro-Glutamyl residue
ELYENKPRRPYIL

SEQ ID NO: 17 - protein, 6 aa, Homo sapiens
RRPYIL

SEQ ID NO: 18 - protein, 5 aa, Homo sapiens
RRPYI

SEQ ID NO: 19 - protein, 6 aa, Artificial Sequence
  C-Terminal N-Methyl-Leucine derivative of SEQ ID NO18
  MISC_FEATURE (6)..(6): N-Methyl-Leucine
RRPYIL

SEQ ID NO: 20 - protein, 12 aa, Homo sapiens
  MISC_FEATURE (1)..(12): Neurotensin C-Terminal Residues
LYENKPRRPYIL

SEQ ID NO: 21 - protein, 11 aa, Homo sapiens
  MISC_FEATURE (1)..(11): Neurotensin C-Terminal Residues
YENKPRRPYIL

SEQ ID NO: 22 - protein, 10 aa, Homo sapiens
  MISC_FEATURE (1)..(10): Neurotensin C-Terminal Residues
ENKPRRPYIL

SEQ ID NO: 23 - protein, 9 aa, Homo sapiens
  MISC_FEATURE (1)..(9): Neurotensin C-Terminal Residues
NKPRRPYIL

SEQ ID NO: 24 - protein, 8 aa, Homo sapiens
  MISC_FEATURE (1)..(8): Neurotensin C-Terminal Residues
KPRRPYIL

SEQ ID NO: 25 - protein, 7 aa, Homo sapiens
  MISC_FEATURE (1)..(7): Neurotensin C-Terminal Residues
PRRPYIL

SEQ ID NO: 26 - protein, 5 aa, Homo sapiens
  MISC_FEATURE (1)..(5): Neurotensin C-Terminal Residues
RPYIL